(19) United States
(12) Patent Application Publication
(10) Pub. No.: US 2010/0205014 A1
(43) Pub. Date: Aug. 12, 2010

(54) METHOD AND SYSTEM FOR PROVIDING RESPONSE SERVICES

(76) Inventors: Cary Sholer, Danville, CA (US); Neil Sholer, Sacramento, CA (US)

Correspondence Address: WEST & ASSOCIATES, A PC, 1255 Treat Blvd., 3rd Floor, WALNUT CREEK, CA, 94597, US

(21) Appl. No.: 12/701,461

(22) Filed: Feb. 5, 2010

Related U.S. Application Data
(60) Provisional application No. 61/150,715, filed on Feb. 6, 2009.

(51) Int. Cl. G06Q 50/00; G06Q 40/00; G06Q 10/00

(52) U.S. Cl. 705/4

(57) ABSTRACT

Pertaining to information security services, embodiments consistent with the present invention comprise an outsourced bundle of services for the purpose of responding to a compromise of information asset(s). Many of these services and processes have never before been combined into one integrated bundle, and these novel combinations represent an improvement in efficiency and comprehensiveness over the state of the art. Methods and systems consistent with the present invention comprise several main steps and processes, some of which are optional or discretionary. These main steps are: receiving a request, obtaining preliminary information about the compromise, dispatching one or more teams to respond, creating and updating a case file, advising the customer with response decisions, notifying relevant parties about the compromise, acquiring forensics data, referring an insurance professional, implementing a training program, isolating the compromised information asset(s), neutralizing the compromise, creating a risk assessment report, implementing security technologies, and implementing security processes.

### BACKGROUND

1. Field of the Invention

The present invention relates generally to a method for providing incident response services, and more particularly to an outsourced process for providing information security incident response services to a customer who has experienced a real or probable compromise of information asset(s). The method includes multiple steps, the cumulative purpose of which is to resolve some or all negative effects of the compromise of information asset(s), and in certain embodiments, to correct the risk vulnerability to prevent similar incidents from occurring in the future.

2. Background

Every year, compromises of information assets (i.e. information security incidents) are becoming increasingly frequent, increasingly diverse, increasingly sophisticated, increasingly severe, and increasingly technical. In short, compromises pose an ever-increasing threat to companies, organizations, agencies, and individuals.

FIG. 1 is a flow diagram showing the ISO 27001 process for preventing and/or responding to a compromise. A detailed analysis or description of FIG. 1 is outside the scope of this disclosure. Rather, FIG. 1 has been included in the drawings in order to reveal how complicated, time-consuming, expensive, impractical, and/or intimidating it might appear to some readers.

FIG. 2 is a flow diagram showing the COBIT 5.1 process for preventing and/or responding to a compromise. A detailed analysis or description of FIG. 2 is outside the scope of this disclosure. Rather, FIG. 2 has been included in the drawings in order to reveal how complicated, time-consuming, expensive, impractical, and/or intimidating it might appear to some readers.

FIG. 3 is a flow diagram showing an NIST process for preventing and/or responding to a compromise. A detailed analysis or description of FIG. 3 is outside the scope of this disclosure. Rather, FIG. 3 has been included in the drawings in order to reveal how complicated, time-consuming, expensive, impractical, and/or intimidating it might appear to some readers.

As is well known in the art, some compromises are so severe that they can literally make a company go out of business, such as when a compromise causes irreparable damage to the goodwill, reputation, or trust of a company, or when a compromise causes massive notification costs, infeasible repair fees, or staggering regulatory penalties.

When a company experiences a compromise of information assets, it is generally a “hair on fire” experience for everyone involved. All too often, the potential risks are high, the available information is limited, the scrutiny level is enormous, the in-house staff is under-trained, and the compromise complexity is daunting. In this environment, it is common for executives to go days without sleeping and make multi-million dollar blunders.

Compromise of information assets involving data security breaches can lead to reputational harm to individuals, such as with medical records being compromised and affecting an individual's reputation and employability. An individual may also experience financial losses due to a data security compromise, such as when a person's credit card data is stolen and used for fraudulent purposes. Companies can suffer reputational harm and financial losses also.

New breach notification laws by states and federal regulatory agencies require companies to notify affected individuals within a specific time frame. Failure to meet breach notification laws and notification deadlines may result in regulatory sanctions of up to $1.5 million per year for cumulative offenses.

When the compromise of an information asset occurs at a company's business partner's place of business, the responsibility for the breach is imputed back to the company per the HITECH Act. This raises third party issues that have not been considered by the various methods recommended by industry standards groups. Common methods to respond and manage breaches come up short. Most are too narrow, too inflexible and too laborious to be useful in real world scenarios.

Most corporate leaders, information technology (IT) professionals, and individuals can all agree that compromises are a major threat and that good information security is important. However, which method is most effective to prevent, respond, and manage compromises is not generally agreed upon. There are several competing prevention and response methods or models, such as those published by COBIT, ISO, and NIST. Many other companies, agencies, and organizations have invented their own in-house prevention and response methods or models. Unfortunately, each of these methods and models has drawbacks, failings, and limitations.

Some of the prevention and response methods or models can take between six months and two years to institute, greatly frustrating the project leaders and motivating them to cut corners or even quit their job. Other prevention and response methods or models can require a small army of highly trained IT security specialists, all of whom command a high salary but are generally under-utilized except when a compromise occurs. Still other prevention and response models or methods can call for a rigid and overly elaborate series of steps and sub-steps, engendering an inflexible “one size fits all” approach that is impractical and far too slow. Yet other prevention and response methods or models can require many rounds and/or levels of bureaucratic approval, thereby slowing down the response process with red-tape.

The current common prevention and response methods do not assume that a breach can occur at a business partner's or business associate's place of business. Nor are the common prevention and response methods designed to have quick risk assessment reports and timely breach notifications to meet state and federal requirements. Thus using the common prevention and response methods may lead to additional fines and penalties for companies sharing customer records electronically with their business partners and business associates. What is needed is an outsourced response service which specializes in compromises of information assets, wherein the response service is capable of: advising a customer with decisions pertaining to a compromise; assigning a crisis captain to lead the response efforts and be a liason to the customer; activating pre-existing teams of highly skilled response specialists; acquiring forensics data pertaining to the compromise; identifying the underlying cause of the compromise; resolving and/or lessening the effects of the compromise; repairing the compromised or damaged assets; preventing future compromises of the same or similar type by implementing appropriate technology and policies; referring an insurance professional to the customer; and notifying various parties who were affected by the compromise in a way that is Public Relations-savvy while following all relevant notification laws.

### SUMMARY

Methods and systems consistent with the present invention comprise multiple steps, some of which are optional and/or discretionary. One possible exemplary embodiment is described below.

A compromise 404 can occur, and can affect a breached entity 502. Once a compromise 404 is detected, a breached entity 502 can require help, intercession, guidance, and/or emergency services. The breached entity 502 and/or a proxy entity 904 can send 902 and/or forward 906 an alquest 406. Subsequently, an alquest 406 can be received 908 by a receiving entity and/or responding entity. “Prelim compromise dimi” 1268 (defined below) can be obtained 1304, a case file 1258 can be created 1308, and one or more teams 1216 can be dispatched 1312. Forensics data 1252 can be acquired 1314, the breached entity 502 can be advised 1316 with at least one compromise response decision 1274, at least one relevant party 2124 can be notified 1318, an insurance professional can be referred 1320 to the breached entity 502, a risk officer 1210 can be assigned 1322 to the breached entity 502, and/or a training program 1266 can be implemented 1324. Compromised information asset(s) 508 can be isolated 1326, a risk assessment report 1256 can be created 1328, the compromise 404 can be neutralized 1330, security technologies 1270 can be implemented 1332, and/or security processes 1272 can be implemented 1334. Finally, a case file 1258 can be updated 1336. A digital file 2010 comprising data from a single risk assessment report or from a set of risk assessment reports may be queried, formatted and transmitted electronically, or can be a printed report 1259 that can be mailed, to one or more government agency to meet federal and state breach notification requirements.

Some of these steps can be omitted, performed more than once, performed remotely or locally, performed by any number of actors and/or by various actors, performed over any length of time or for a specific range of time, and/or performed in various orders. Reference is made to the detailed description and the accompanying drawings, in which embodiments of the present invention are more thoroughly described.

### BRIEF DESCRIPTION OF THE DRAWINGS

The accompanying drawings are incorporated into and constitute a part of this specification. To better understand embodiments of the present invention and their objectives, advantages, features and implementations, reference is made to the drawings and the detailed description.

FIG. 1 is a flow diagram showing the ISO 27001 process for preventing and/or responding to a compromise.

FIG. 2 is a flow diagram showing the COBIT 5.1 process for preventing and/or responding to a compromise.

FIG. 3 is a flow diagram showing an NIST process for preventing and/or responding to a compromise.

FIG. 4A is a flowchart showing a process in which a compromise can occur and a response can be performed.

FIG. 4B is a flowchart showing a process in which a compromise can occur, an alquest can be sent, and a response can be performed.

FIG. 4C is a flowchart showing a process in which a contract can be commenced, a compromise can occur, an alquest can be sent, and a response can be performed.

FIG. 4D is a flowchart showing a process in which a compromise can occur, an alquest can be sent, a contract can be commenced, and a response can be performed.

FIG. 5A is a flowchart which conceptually illustrates how a compromise can occur, wherein the compromiser is outside of the breached entity.

FIG. 5B is a flowchart which conceptually illustrates how a compromise can occur, wherein the compromiser is inside of the breached entity.

FIG. 5C is a flowchart that illustrates how a compromise can occur, wherein a compromiser accesses a business partner's network to reach a breached entity's protected healthcare information.

FIG. 6 is a flowchart showing a generalized process loop for sending and/or receiving contracts between a service entity and a served entity.

FIG. 7A is a pictorial flowchart showing a process for commencing a contract, wherein a service entity begins the process by sending a contract.

FIG. 7B is a pictorial flowchart showing a process for commencing a contract, wherein a served entity begins the process by requesting a contract.

FIG. 7C is a pictorial flowchart showing a process for commencing a contract, wherein a served entity begins the process by creating a contract.

FIG. 8 is a block diagram showing several exemplary contract types.

FIG. 9A is a flowchart showing a process for receiving an alquest which was sent by a breached entity, wherein the receiving occurs at a command center.

FIG. 9B is a flowchart showing a process for receiving an alquest which was sent by a breached entity, wherein the receiving occurs through a communications network.

FIG. 9C is a flowchart showing a process for receiving an alquest which was forwarded by a proxy entity, wherein the receiving occurs at a command center.

FIG. 9D is a flowchart showing a process for receiving an alquest which was forwarded by a proxy entity, wherein the receiving occurs through a communications network.

FIG. 10 is a block diagram illustrating a conceptual model of a command center which comprises several exemplary locations.

FIG. 11A is a tabular illustration of an alquest email comprised of exemplary fields.

FIG. 11B is a tabular illustration of a structured alquest comprised of exemplary fields.

FIG. 12A is a block diagram showing various exemplary system components.

FIG. 12B is a block diagram showing various exemplary system artifacts.

FIG. 13A is a flowchart showing a process for responding to a compromise.

FIG. 13B is an alternate and simplified embodiment of the process shown in FIG. 13A.

FIG. 14 is a flowchart showing a process for obtaining prelim compromise dimi.

FIG. 15A is a tabular illustration providing exemplary data fields and exemplary data values that can be used to represent prelim compromise dimi.

FIG. 15B is a tabular illustration providing exemplary data fields and exemplary data sub-fields that can be used to represent prelim compromise dimi.

FIG. 16 is a flowchart showing a process for determining if insurance covers a given compromise.

FIG. 17 is a flowchart showing a process for creating a case file from several exemplary source dimis.

FIG. 18 is a flowchart showing a process for determining when it is necessary to respond to a compromise in an expedited or simplified manner.

FIG. 19A is a block diagram showing a team comprised of multiple sub-teams.

FIG. 19B is a block diagram showing a team comprised of one sub-team having the same size and membership as the team itself.

FIG. 19C is a block diagram showing a league comprised of a risk officer and multiple exemplary teams, wherein each team is comprised of multiple exemplary sub-teams.

FIG. 20 is a flowchart showing a forensics acquisition and analysis process, wherein the forensics data can be acquired from at least one exemplary forensics investigation area.

FIG. 21 is a flowchart showing a process for notifying at least one entity about a compromise.

FIG. 22 is a flowchart showing a process for advising a breached entity with at least one compromise response decision.

FIG. 23 is a flowchart detailing a process for reducing the number of members on a given notification list.

FIG. 24A is a flowchart showing a process for implementing a training program, wherein the training program is created.

FIG. 24B is a flowchart showing a process for implementing a training program, wherein the training program is modified.

FIG. 24C is a flowchart showing a process for implementing a training program, wherein the training program is re-used.

FIG. 25 is a flowchart showing a process for isolating compromised information asset(s) by taking at least one exemplary action.

FIG. 26 is a flowchart showing a process for neutralizing a compromise of information asset(s) while working within the exemplary constraints of a breached entity's existing security processes and security technologies.

FIG. 27A is a flowchart detailing a process for obtaining permission prior to isolating at least one compromised information asset.

FIG. 27B is a flowchart detailing a process for obtaining permission prior to neutralizing a compromise.

FIG. 28 is a flowchart showing a process for implementing at least one security technology.

FIG. 29 is a flowchart showing a process for implementing at least one security process.

FIG. 30 is a flowchart showing a process for creating a risk assessment report.

FIG. 31 is a process diagram detailing a process for updating a case file and then storing and/or sending the same.

FIG. 32 depicts a flowchart of a signal change that can trigger the initiation of the processes described herein.

### DETAILED DESCRIPTION

### Definitions of Terms

For convenience and by convention, the following terms are listed alphabetically. The ordering of the terms is not intended to imply causality, directionality, precedence, consequence, structure, flow, order, requirements, sets, groupings, categories, associations, or any other relationship. Therefore, the order of the terms is not intended to be limiting or restrictive in any way.

As used herein, the term “ACEI technique” refers to a technique, process, means, action, and/or method for analyzing, calculating, estimating, identifying, and/or consolidating dimis. An ACEI technique can utilize a rubric, a template, a checklist, a formula, an algorithm, a computer, a computing device, a calculator, a database, an almanac, an encyclopedia, a reference book, a reference document, hardware, a device, an apparatus, a machine, a website, a search engine, a table, a matrix, a chart, a graph, a ledger, a cube (i.e. a data structure which has at least two dimensions, and is suitable for viewing data at various levels of granularity or aggregation), a stochastic model, a statistical model, a simulation, an experiment, a poll, a survey, an interview, a questionnaire, a software application, a word processor, a spreadsheet, a page maker application (such as Adobe Acrobat®), a presentation maker application (such as Microsoft PowerPoint®), a mental process, a “pen-and-paper” process (i.e. a process utilizing a human-usable writing instrument and a tangible medium capable of being written on by said instrument), a verbal process (i.e. a process utilizing spoken words), any combination thereof, and/or any known and/or convenient technique having the same or similar function.

As used herein, the term “activity log” refers to a log, book, database, application, system, file, folder, and/or file folder which is suitable for storing, capturing, recording, retrieving, and/or presenting dimis, wherein the dimis relate to user activity.

As used herein, the term “activity logging” refers to recording, notating, and/or capturing events and/or activity in an activity log.

As used herein, the term “actor” can refer to a person, individual, job, job function or role, team, sub-team, machine, device, apparatus, system, computer, computer application, computer algorithm, artificial intelligence, and/or any combination thereof, capable of performing, at least in part, a steponent (defined below) and/or action. As used herein, the term “actors” refers to at least one actor.

As used herein, the term “actor-flexible” refers to a steponent that can be performed by one or more than one actor. Generally although not always, an actor-flexible steponent can be performed by any given actor, provided that the actor has the necessary skills and/or knowledge to at least in part perform the steponent in question.

As used herein, the term “asset” refers to something of value which is owned by, leased by, rented by, used by, utilized by, claimed by, depended on by, part of, and/or dependent on, at least one entity.

As used herein, the term “chatroom” can include, but is not limited to: an internet chatroom, a local area network chatroom, a wide area network chatroom, an encrypted chatroom, a telephone chatroom, a digital forum, a weblog (“blog”), a chatroom hosted by an internet service provider such as AOL, and/or any combination thereof. One skilled in the art will be able to conceive of additional and/or alternate chatting technologies, and thus it should be understood that all such additional and/or alternate chatting technologies are intended to fall within the scope and spirit of “chatroom”.

As used herein, the term “CIFS technique” refers to a technique, process, means, action, and/or method for structuring, incorporating, formatting, combining, packaging, collating, creating, processing, modifying, and/or translating dimis. A CIFS technique can utilize a rubric, a template, a checklist, a formula, an algorithm, a computer, a computing device, a calculator, a database, hardware, a device, an apparatus, a machine, a website, a search engine, a table, a matrix, a chart, a graph, a ledger, a cube (i.e. a data structure which has at least two dimensions, and is suitable for viewing data at various levels of granularity or aggregation), a software application, a word processor, a spreadsheet, a page maker application (such as Adobe Acrobat®), a presentation maker application (such as Microsoft PowerPoint®), a mental process, a “pen-and-paper” process (i.e. a process utilizing a human-usable writing instrument and a tangible medium capable of being written on by said instrument), a verbal process (i.e. a process utilizing spoken words), any combination thereof, and/or any known and/or convenient technique having the same or similar function.

As used herein, the term “communicator” refers to a person, individual, job, job function or role, team, sub-team, machine, device, apparatus, system, computer, computer application, computer algorithm, artificial intelligence, and/or any combination thereof, capable of communicating. The communicating can be unidirectional or bidirectional. As used herein, the term “communicators” refers to at least one communicator.

As used herein, the terms “dimi” and “dimis” refer to data, information, media, and/or instructions. By way of non-limiting example, dimi can include: a document; a file; a number; a value; a name; data and/or information representable in a digital, binary, electrical, acoustical, optical, and/or magnetic form; a set of files; a contract; a digital or electronic message; a database record; a database; a spreadsheet; a password; a sound recording; a video recording; a photograph; a transcript; an interview; and/or any combination thereof. By way of explanation, dimi is pronounced as “dim-ee”.

As used herein, the term “duration-flexible” refers to a steponent that can be performed gradually, quickly, all at once, “in one shot”, in one pass, in stages, in phases, and/or piecemeal; and furthermore, a duration-flexible steponent can be performed over any length of time.

As used herein, the term “entity” refers to a person, individual, group, company, corporation, syndicate, agency, partnership, computer algorithm, artificial intelligence, job function, publication, organization, family, club, team, sub-team, or any combination thereof.

As used herein, the term “human-writable medium” refers to any medium capable of being written on and/or read by a human. A human-writable medium can include, but is not limited to: paper, a notecard, wax paper, a memo, a file, cardboard, plaster, clay, a napkin, papyrus, wax, wood, a whiteboard, a chalkboard, and/or any combination thereof, and/or any other known and/or convenient mechanism.

As used herein, the term “onset-flexible” refers to a steponent that can be performed at any time before, during, and/or after a compromise. Furthermore, an onset-flexible steponent can be performed immediately, right away, in a while, at a later time, much later, and/or at any time.

As used herein, the term “order-flexible” refers to a steponent or set of steponents that can be performed serially, together, separately, in any order, in alternation, in parallel, and/or any combination thereof.

As used herein, the term “permission-flexible” refers to a steponent that can be performed with or without permission from a breached entity, proxy entity, risk officer, league, team, sub-team, responding entity, public authority, and/or any combination thereof, and/or any other known and/or convenient entity.

As used herein, the term “proximity-flexible” refers to a steponent that can be performed, executed, situated, and/or arranged close to, next to, adjacent to, nearby, in the proximity of, in the same room as, on the same floor as, within the same building as, on the same computer as, within the same computer network as, within the same communications network as, inside of, not close to, not next to, not adjacent to, not nearby, not in the proximity of, not in the same room as, not on the same floor as, not within the same building as, not on the same computer as, not within the same computer network as, not within the same communications network as, and/or not inside of, the breached entity and/or the compromise. In some embodiments, although not always, a proximity-flexible steponent can imply, require, include, suggest using, and/or make use of, a remote access technique.

As used herein, the term “real or probable” can mean: real, genuine, probable, potential, likely, actual, definite, and/or certain.

As used herein, the term “remote access technique” refers to a technique, process, method, machine, technology, software application, device, apparatus, and/or any combination thereof, suitable for remotely accessing, reading, viewing, displaying, presenting, modifying, editing, updating, copying, processing, analyzing, and/or executing a dimi. By way of non-limiting example, a remote access technique could be: a virtual private network (VPN), a connection over a computer network or a communications network, a file server, a share drive, a web conference, a virtual machine (VM), or any combination thereof.

As used herein, the term “repetition-flexible” refers to a steponent that can be performed once and/or more than once. Generally although not always, each performance of the repetition-flexible steponent can vary slightly or substantially in terms of the: process, technique, style, method, mode, approach, results, outcome, product, output, and/or any combination thereof.

As used herein, the term “secrecy-flexible” refers to a steponent that can be performed with or without awareness of a breached entity, proxy entity, public authority, relevant party, risk officer, league, team, sub-team, responding entity, case file consumer, the general public, and/or any combination thereof.

As used herein, the term “steponent” refers to a step, sub-step, action, component, sub-component, element, division, portion, part, phase, and/or stage of an embodiment, method, system, process, procedure, technique, algorithm, device, and/or apparatus.

As used herein, the term “telephone” is meant to include, but is not limited to: a telephone, a cellular phone, a portable phone, a wireless phone, a mobile phone, a satellite phone, a smartphone, a walkie-talkie, a pager, and/or any other known and/or convenient device having the same or similar function. One skilled in the art will be able to conceive of additional and/or alternate phone technologies, and thus it should be understood that all such additional and/or alternate phone technologies are intended to fall within the scope and spirit of “telephone”.

### Detailed Description

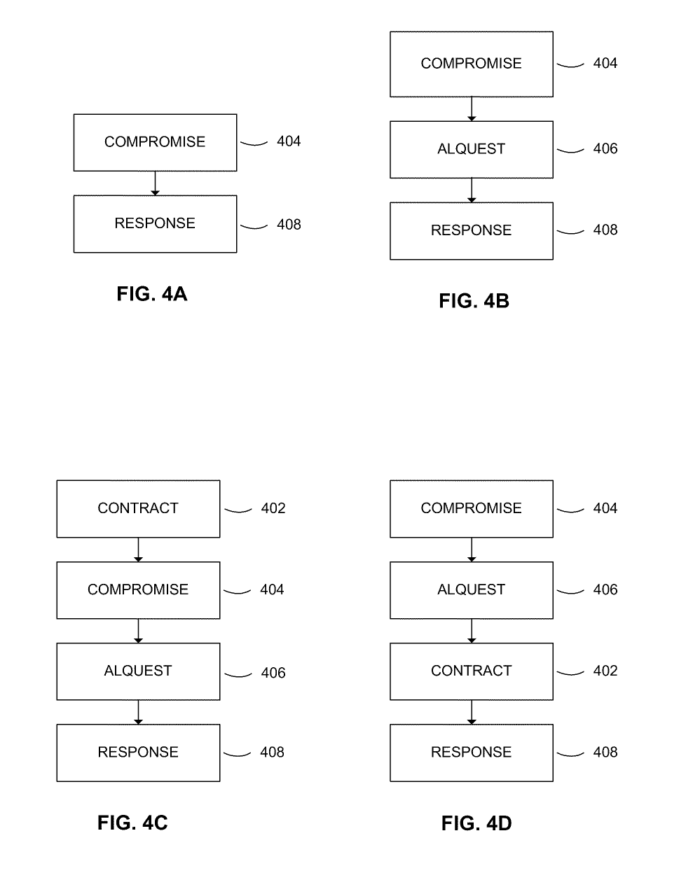

FIGS. 4A, 4B, 4C, 4D illustrate various scenarios in which a compromise 404 occurs and a response 408 is performed. When a real or probable compromise 404 occurs, an entity affected by that compromise 404 can want and/or require help, services, and/or intercession. Consequently, the entity can seek, purchase, and/or ask for response services from a responding entity. The responding entity can then perform a response 408.

As used herein, the term “compromise” 404 refers to at least one event and/or incident in which an asset has been, at least in part, lost, stolen, corrupted, destroyed, misplaced, misrepresented, broken, hacked, leaked, accessed without authorization, copied without authorization, read without authorization, executed without authorization, listened to without authorization, turned on without authorization, turned off without authorization, deleted without authorization, moved without authorization, any combination thereof, and/or any known and/or convenient action having the same or similar function. Generally although not always, throughout this disclosure, “compromise” can refer to incident(s) and/or event(s) affecting at least one asset comprised of at least one computer, hardware, software, dimi, telephone, network, system(s) thereof, and/or any combination thereof. Generally although not always, a compromise is a single event and/or incident, or a plurality of related events and/or incidents. However, a compromise can span any length of time, can occur in any number of distinct physical and/or virtual locations, can affect any number of assets 506, can occur at a business partner's location, and/or can be caused by any number of actors. Furthermore, a given compromise can be grouped, aggregated, or viewed differently by different people, and as such, deciding which event(s) are grouped into a given compromise can be at least partially subjective.

An exemplary list of some, but not all, possible compromises 404 is given below:
Releasing a virus onto a computer network.
Logging onto a system using a stolen or cracked password.
Deleting a file without permission.
Forging an email.
Reading another user's email without authorization.
Eavesdropping on a chief executive officer's cell phone calls and using personal information to blackmail him.
Forgetting to re-encrypt a classified file after reading it.
Sniffing network traffic.
Recording keystrokes in order to obtain passwords or other sensitive data.
Storing pornography on company computers.
Transmitting files containing personal identifiable information without authorization.
Installing pirated software.
Physically vandalizing or destroying a computer.

Although the list given above lists some common and/or exemplary compromises, one skilled in the art will be able to conceive of additional and/or alternate compromises, and thus it should be understood that all such additional and/or alternate compromises are intended to fall within the scope and spirit of “compromise” 404.

As used herein, the term “response service” refers to: a service rendered while and/or after responding to a compromise; a service rendered because of a compromise; a service rendered in order to respond to a compromise; any combination thereof; and/or any known and/or convenient service having the same or similar function. Response services can also include, but are not limited to: preventing, understanding, publicizing, investigating, handling, advising in regards to, and/or any combination thereof, the compromise. Response services can include, but are not limited to: handling, investigating, restoring, fixing, moving, advising in regards to, and/or any combination thereof, the compromised information asset(s).

As used herein, the term “responding entity” can refer to an entity that, at least in part, can respond to a compromise, can offer services pertaining to responding to a compromise, can receive an alquest, can communicate with an entity affected by a compromise, can communicate with an entity which is aware of a compromise, any combination thereof, and/or any known and/or convenient role having the same or similar function.

As used herein, the term “response” 408 can refer to a response to a compromise and/or a reaction to a compromise. A response 408 can have many purposes and/or results, including but not limited to: stopping a compromise; fixing assets damaged by a compromise; lessening the negative effects of a compromise; guiding or advising an entity through a compromise; obtaining information about a compromise; determining why and/or how a compromise occurred; preventing future compromises of the same or similar type by implementing various preventive measures; informing affected entities about a compromise; any combination thereof; and the like.

In some embodiments, a response 408 can be performed while and/or after a compromise 404 occurs. However, in other embodiments, it can be desirable, beneficial, and/or necessary to commence a contract 402 prior to the occurrence of the compromise 404. In still other embodiments, it can be desirable, beneficial, and/or necessary to commence a contract 402 during and/or after the occurrence of the compromise 404.

As used herein, the term “contract” 402 refers to a document containing and/or expressing at least one agreement, promise, pact, intention, term, condition, limitation, expectation, any combination thereof, and/or any known and/or convenient content-type having the same or similar function, between two or more parties. The term “contract” is not meant to imply a legally binding or enforceable document, nor is “contract” meant to imply a document that must be signed by one or more party. Instead, the word “contract” is used informally and conveniently, to mean a document with a generally legal flavor and/or purpose, which may or may not be signed, and may or may not be legally binding or enforceable.

In some embodiments, a response 408 can be performed without receiving a request and/or alert from an entity which is affected by, or aware of, the compromise 404. However, in other embodiments, it can be desirable, beneficial, and/or necessary for an alquest to be sent and/or received, thereby notifying the responding entity that a compromise 404 has occurred and allowing the response 408 to begin.

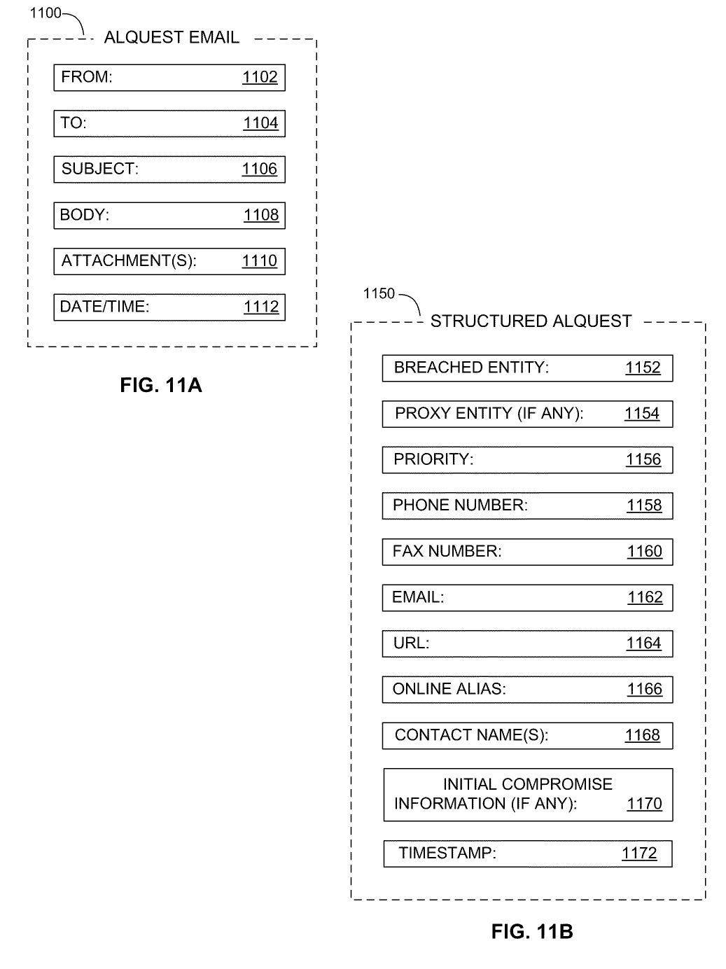

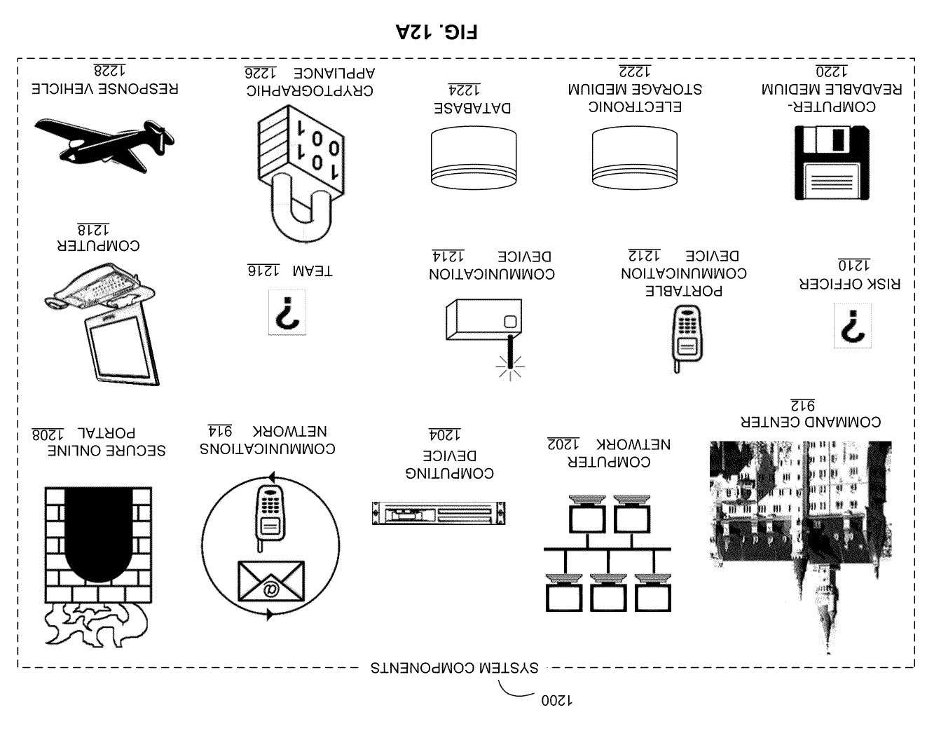

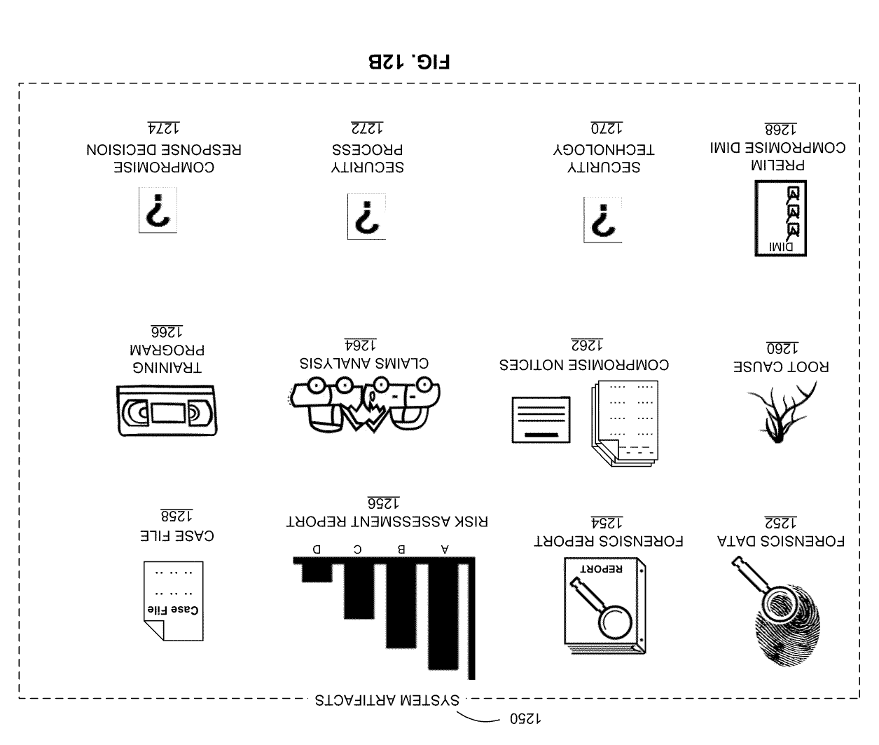

As used herein, the term “alquest” 406 refers to an alert and/or a request for response, which pertains to a real or probable compromise. The alquest indicates a desire and/or need for help, services, solutions, assistance, support, guidance, and/or intercession. In various embodiments, an alquest can also contain at least some other data fields. Reference is made to FIGS. 11A and 11B, in which various possible data fields are described in greater detail.

In some embodiments, as shown in FIG. 4A, a compromise 404 can occur, and then a response 408 can be performed.

In other embodiments, as shown in FIG. 4B, a compromise 404 can occur, then an alquest 406 can be sent, and then a response 408 can be performed.

In still other embodiments, as shown in FIG. 4C, a contract 402 can be commenced, then a compromise 404 can occur, then an alquest 406 can be sent, and then a response 408 can be performed.

In yet other embodiments, as shown in FIG. 4D, a compromise 404 can occur, then an alquest 406 can be sent, then a contract 402 can be commenced, and then a response 408 can be performed.

Although FIGS. 4A, 4B, 4C, and 4D illustrate common and/or exemplary scenarios involving compromise and response, one skilled in the art will be able to conceive of additional and/or alternate scenarios, and thus it should be understood that all such additional and/or alternate scenarios are intended to fall within the scope and spirit of FIGS. 4A, 4B, 4C, and 4D.

The steponents shown in 402, 404, 406, and 408 can be order-flexible in relation to each other.

The steponents shown in 402, 404, 406, and 408 can be actor-flexible, duration-flexible, onset-flexible, proximity-flexible, repetition-flexible, and/or secrecy-flexible.

The steponents shown in 402, 404, 406, and 408 can be optional and/or discretionary, and thus, can occur in some embodiments but not in others.

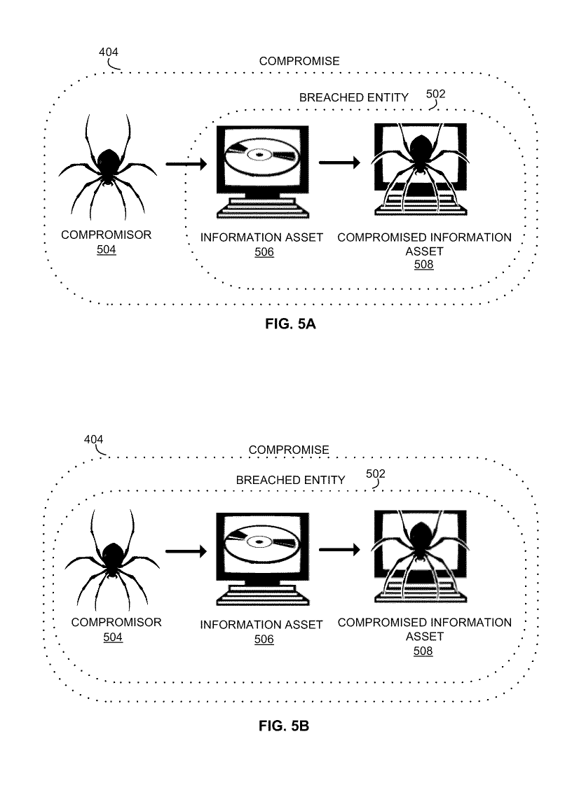

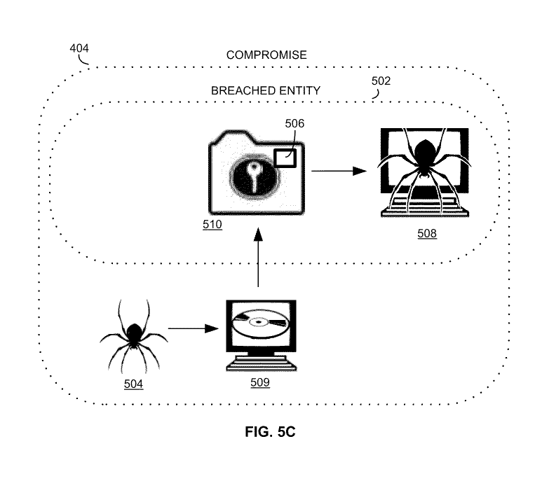

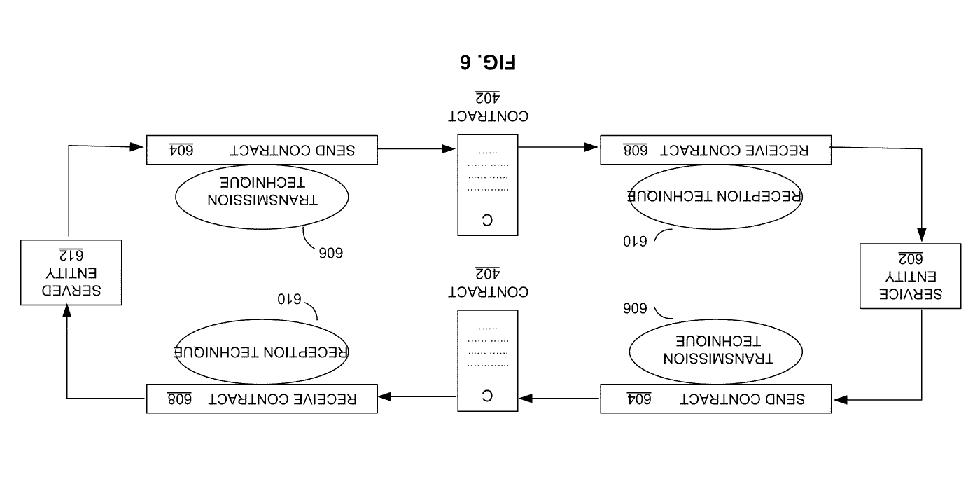

FIG. 5A is a flowchart which conceptually illustrates how a compromise can occur, wherein a compromiser is outside of a breached entity. FIG. 5B is a flowchart which conceptually illustrates how a compromise can occur, wherein a compromiser is inside of a breached entity.

In some embodiments, in order for a compromise 404 to occur, there can be an actor which can cause a compromise 404, at least one asset which becomes compromised, and an entity negatively affected by the compromise 404 (typically because the entity owns and/or uses the asset).

As indicated by the dotted outer box, a compromise 404 can be more fully understood when considered as a set of entities, actors, and assets (502, 504, 506, 508).

A compromise 404 can occur when at least one compromiser 504 compromises at least one information asset 506. Generally although not always, a breached entity 502 can own and/or use the at least one information asset 506. As a result of the compromise 404, the at least one information asset 506 can become at least one compromised information asset 508.

As used herein, the term “breached entity” 502 refers to an entity that has experienced, is experiencing, was affected by and/or is affected by, a real or probable compromise.

As used herein, the term “compromiser” 504 refers to at least one person, entity, team, group, agency, company, organization, computer program, data element, hardware device, computer algorithm, artificial intelligence, and/or any combination thereof, which is at least in part responsible for causing a compromise. Despite being at least in part responsible for the compromise, a compromiser can be aware or unaware of that responsibility. Furthermore, a compromiser can be malicious or benign, and can act intentionally, unintentionally, or accidentally, and/or any combination thereof.

As used herein, the term “information asset” 506 refers to an asset comprised at least in part of at least one computer, hardware, software, dimi, telephone, network, system(s) thereof, and/or any combination thereof. In some cases, an information asset can be, at least in part, owned by, leased by, rented by, used by, utilized by, claimed by, depended on by, part of, and/or dependent on a breached entity. By way of non-limiting example, an information asset can include: a computer, a computer network, a server, a database, a digital file, an account, a login, a password, a communication device, a portable communication device, a computing device, dimis capable of being stored in a digital or electrical format, a computer-readable medium, a computing system comprising hardware and/or software and/or data, and/or any combination thereof, and/or any known and/or convenient asset having the same or similar function.

As used herein, the term “compromised information asset” 508 refers to at least one information asset that has been affected by the compromise. Generally although not always, compromised information asset(s) can be grouped together because they relate to a given compromise, and/or because they relate to a plurality of similar and/or related compromises.

In some embodiments, a compromiser 504 can be “outside of” a breached entity 502. As used in regards to FIGS. 5A and 5B, “outside of” can mean: outside, not within, not part of, independent of, apart from, away from, any combination thereof, and/or any known and/or convenient state having the same or similar function. For example, a compromiser 504 can be a phone phreak (i.e. telephone hacker) with a cellular phone scanner who sits outside of an office building eavesdropping on conversations of the breached entity's 502 employees, and therefore the phone phreak can be outside of the breached entity 502. In another example, a compromiser 504 can be a network of hijacked computers which launches a distributed denial of service (DDOS) attack against the breached entity's 502 corporate network, wherein the network of hijacked computers is outside of the breached entity's 502 corporate network, and hence outside of the breached entity 502.

In other embodiments, the compromiser 504 can be “inside of” the breached entity 502. As used in regards to FIGS. 5A and 5B, “inside of” can mean: inside, within, part of, dependent on, not away from, not apart from, subsidiary to, any combination thereof, and/or any known and/or convenient state having the same or similar function. For example, a compromiser can be a disgruntled employee of the breached entity 502 who reads other employees' email without authorization, and therefore can be inside of the breached entity 502. In another example, a compromiser 504 can be a server within the breached entity's 502 network, wherein the server is infected with a virus which causes it to send millions of spam emails, and therefore the compromiser 504 is inside of the breached entity 502.

In still other embodiments, a compromiser 504 can be both inside of and outside of the breached entity 502. For example, the compromiser 504 could be a two person team, wherein the first person works for the breached entity 502, and is therefore inside of the breached entity 502, and wherein the second man is a hacker who does not work for the breached entity 502, and is therefore outside of the breached entity 502. In another example, the compromiser 504 could be a two entity team, wherein the first entity is a hacker who does not work for the breached entity 502 and is located outside of their network, and is therefore outside of the breached entity 502, and wherein the second entity is a malware application installed on thousands of computers within the breached entity's 502 network, and is therefore inside of the breached entity 502.

Referring to FIG. 5C, in another example, a compromiser 504 can be an employee or entity using a business partner's computer on the business partner's network 509 which is connected to the breached entity's healthcare database 510. The compromiser 504 can be an unauthorized user who chooses to view or steal protected healthcare information 506 for patients belonging to the breached entity 502, resulting in a compromised information asset 508.

In yet other embodiments, whether the compromiser 504 is inside of or outside of the breached entity 502 can be indeterminate, uncertain, unknowable, fluctuating, and/or irrelevant.

FIGS. 5A-5C illustrate embodiments of models depicting how a compromise can occur. One skilled in the art will be able to conceive of additional and/or alternate conceptual models, and thus it should be understood that all such additional and/or alternate conceptual models are intended to fall within the scope and spirit of FIGS. 5A-5C.

FIG. 6 is a flowchart showing a generalized process loop for sending and/or receiving contracts between a service entity 602 and a served entity 612.

In some embodiments, a service entity can offer services as part of its business plan, and therefore can expect to get paid for those services. Furthermore, a service entity may want to define and agree to the terms of service (such as pricing, response times, deductible payments, service levels, and the like) prior to offering those services. Therefore, it can be desirable, beneficial, and/or necessary to send and/or receive at least one contract 402 prior to beginning to offer response services.

As used herein, the term “service entity” 602 refers to an entity which offers, gives, sells, practices, executes, manages, and/or advertises at least one service. Generally although not always, these services can be, at least in part, response services. In some embodiments, a service entity 602 can also be a responding entity.

As used herein, the term “served entity” 612 refers to an entity which requests, receives, is interested in, pays for, asks for, consumes, and/or benefits from at least one service. Generally although not always, these services can be, at least in part, response services. In some embodiments, a served entity 612 can also be a breached entity 502.

At step 604, at least one contract 402 can be sent. As used in regards to step 604, “send” (and all of its verb forms) can mean: send, transmit, deliver, hand off, convey, upload, give, dispatch, make available, present, any combination thereof, and/or any known and/or convenient action having the same or similar function.

The sending 604 can be accomplished using any transmission technique 606. As used herein, the term “transmission technique” 606 refers to a technique, channel, venue, process, technology, and/or method for transmitting, sending, broadcasting, giving, handing off, dispatching, making available, uploading, and/or delivering dimis between two or more communicators. Furthermore, any other known and/or convenient technique having the same or similar function is meant to be included in the definition of “transmission technique”. By way of non-limiting example, a transmission technique can be: email, instant message, text message, telephone, computer, chatroom, uploading to a website, entering into a website, downloading from a website, FTP site, HTTP transmission, sound recording, video recording, portable communication device, face-to-face conversation, teleconference, web conference, face-to-face presentation, face-to-face delivery, radio signal, online presentation, paper, electronic or digital document, paper or analog document, or any combination thereof.

At step 608, at least one contract 402 can be received. As used in regards to step 608, “receive” (and all of its verb forms) can mean: receive, get, obtain, capture, download, grab, fetch, acquire, become aware of, collect, read, any combination thereof, and/or any known and/or convenient action having the same or similar function.

The receiving 608 can be accomplished using any reception technique 610. As used herein, the term “reception technique” 610 refers to a technique, channel, venue, process, technology, and/or method for receiving, getting, obtaining, acquiring, tuning in to, discovering, taking, downloading, gaining access to, and/or capturing dimis between two or more communicators. Furthermore, any other known and/or convenient technique having the same or similar function is meant to be included in the definition of “reception technique”. By way of non-limiting example, a reception technique can be: email, instant message, text message, telephone, computer, chatroom, website, FTP site, HTTP transmission, downloading from a website, access from a website, portable communication device, face-to-face conversation, sound recording, video recording, teleconference, web conference, face-to-face presentation, face-to-face reception or taking, radio signal, online presentation, paper, electronic or digital document, paper or analog document, or any combination thereof.

The flowchart shown in FIG. 6 can be interpreted and/or read in many different ways. The process shown in FIG. 6 can begin at any point and/or end at any point. Furthermore, the process can “loop” or repeat any number of times.

In one possible interpretation of FIG. 6, the process can start when a service entity 602 can send 604 a contract 402 using a transmission technique 606. Then, the process can end when a served entity 612 can receive 608 a contract 402 using a reception technique 610.

In another possible interpretation of FIG. 6, the process can start when a service entity 602 can send 604 a contract 402 using any transmission technique 606. Then, a served entity 612 can receive 608 that contract 402 using any reception technique 610. Then, the served entity 612 can send the contract 402 using any transmission technique 606. Finally, the process can end when the service entity 602 can receive the contract 402 using any reception technique 610.

In yet another possible interpretation of FIG. 6, the process can start when a served entity 612 can receive 608 a contract 402 using any reception technique 610. Then, the served entity 612 can send the contract 402 using any transmission technique 606. Then, a service entity 602 can receive that contract 402 using any reception technique 610. Then, the service entity 602 can send 604 that contract 402 using any transmission technique 606. Then, the process has looped one time, and the served entity 612 can again receive 608 the contract 402 using any reception technique 610. Finally, the process can end when the served entity 612 can send 604 the contract 402 using any transmission technique 606.

At any send 604 step in the generalized process shown in FIG. 6, one or more contracts 402 can be sent. Additionally, at any receive 608 step in the generalized process shown in FIG. 6, one or more contracts 402 can be received.

Steps 604 and 608 can be order-flexible in relation to each other.

Steps 604 and 608 can be actor-flexible, duration-flexible, onset-flexible, proximity-flexible, repetition-flexible, and/or secrecy-flexible.

Steps 604 and 608 can be optional and/or discretionary, and thus, can occur in some embodiments but not in others.

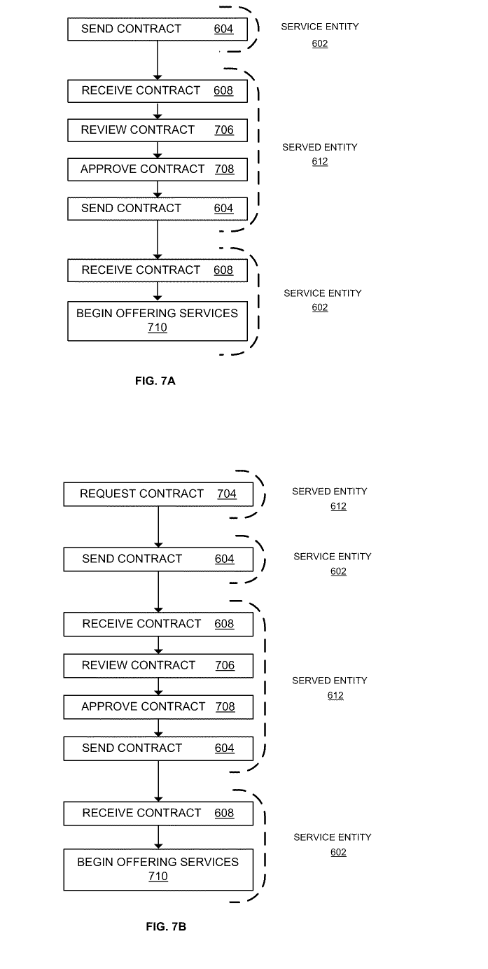

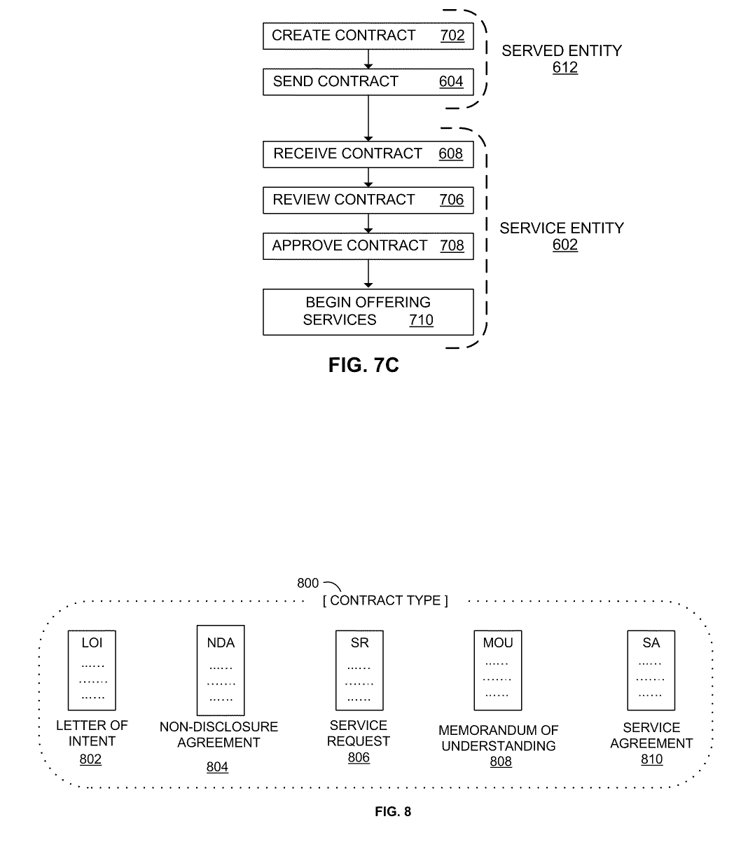

FIG. 7A is a pictorial flowchart showing a process for commencing a contract, wherein a service entity begins the process by sending a contract 604. FIG. 7B is a pictorial flowchart showing a process for commencing a contract, wherein a served entity begins the process by requesting a contract 704. FIG. 7C is a pictorial flowchart showing a process for commencing a contract, wherein a served entity begins the process by creating a contract 702.

Prior to beginning to offer response services, there are many ways in which a contract can be commenced (i.e. executed and/or agreed to). Although FIG. 6 presents a generalized process loop for sending and receiving contracts, it can be helpful to show several exemplary processes in which a contract is commenced. In some embodiments, a service entity 602 can begin the process by sending and/or offering a contract 604. In other embodiments, a served entity 612 can begin the process by requesting a contract 704. In still other embodiments, a served entity 612 can begin the process by creating and/or writing a contract 702.

At step 702, at least one contract can be created. As used in regards to step 702, “create” (and all of its verb forms) can mean: create, write, produce, describe, design, build, draw, draft, envision, fabricate, make, any combination thereof, and/or any known and/or convenient action having the same or similar function.

At least one contract can be created 702 using any ACEI technique. In some embodiments, a contract 402 can be created 702 by a service entity 602. In other embodiments, a contract 402 can be created 702 by a served entity 612. In still other embodiments, a contract 402 can be created 702 by both a service entity 602 and served entity 612.

At step 704, at least one contract can be requested. As used in regards to step 704, “request” (and all of its verb forms) can mean: request, ask for, ask about, send for, any combination thereof, and/or any known and/or convenient action having the same or similar function.

At least one contract 402 can be requested 704 using any transmission technique 606. In some embodiments, a contract 402 can be requested 704 by a service entity 602. In other embodiments, a contract 402 can be requested 704 by a served entity 612. In still other embodiments, a contract 402 can be requested 704 by both a service entity 602 and served entity 612.

At step 604, at least one contract 402 can be sent. At least one contract 402 can be sent 604 using any transmission technique 606, such as but not limited to converting a physical document into an electronic file format and sending the document over the internet or a network. Reference is made to the discussion above regarding FIG. 6, in which sending 604 a contract 402 is described in greater detail.

At step 608, at least one contract 402 can be received. At least one contract 402 can be received 608 using any reception technique 610. Reference is made to FIG. 6, in which receiving 608 a contract 402 is described in greater detail.

At step 706, at least one contract can be reviewed. As used in regards to step 706, “review” (and all of its verb forms) can mean: review, look at, read, be exposed to, open, scan, listen to, study, analyze, any combination thereof, and/or any known and/or convenient action having the same or similar function.

The reviewing 706 can be accomplished by: reading, viewing, studying, analyzing, listening to, comprehending, being exposed to, looking at, opening, scanning, and/or any combination thereof, a document capable of being represented in a manner that is physical, electronic, digital, analog, magnetic, acoustic, chemical, human-writable, human-readable, computer-readable, and/or any combination thereof.

At step 708, at least one contract can be approved. As used in regards to step 708, “approve” (and all of its verb forms) can mean: approve, agree to, give permission, sign, any combination thereof, and/or any known and/or convenient action having the same or similar function. Approval can be achieved by written and/or electronic signature of a contract 402.

The approving 708 can be accomplished by: expressing verbal approval, such as saying “I agree”, or grunting “uh huh”, vocalizing “yes”; expressing non-verbal approval, such as a handshake, thumbs up, high-five, or head nod; expressing virtual approval, such as typing “yes” in an instant message, clicking “proceed” on a website, or communicating “I approve” in an email; expressing written approval, such as signing a document, checking a checkbox, writing initials on a line; any combination thereof, and

At step 710, services can begin being offered. Generally but not always, these services can be response services.

In some embodiments, the services begin being offered 710 by a service entity 602. In other embodiments, the services begin being offered 710 by a responding entity. In still other embodiments, the services begin being offered 710 by both a responding entity and a service entity 602.

As illustrated in FIG. 7A, in some embodiments, the process of commencing a contract 402 can begin when a service entity 602 can send 604 at least one contract 402. The at least one contract 402 can be received 608 by a served entity 612. Then, served entity 612 can review 706 and approve 708 the at least one contract 402. Then, the served 612 entity can send 604 the at least one contract 402. The service entity 602 can then receive 608 the at least one contract 402. At this point, the service entity 602 and/or a responding entity can begin offering services 710.

As illustrated in FIG. 7B, in some embodiments, the process of commencing a contract 402 can begin when a served entity 612 can request 704 at least one contract 402. Then, the service entity 602 can send 604 the at least one contract 402. The at least one contract 402 can be received 608 by a served entity 612. Then, served entity 612 can review 706 and approve 708 the at least one contract 402. Then, the served 612 entity can send 604 the at least one contract 402. The service entity 602 can then receive 608 the at least one contract 402. At this point, the service entity 602 and/or a responding entity can begin offering services 710.

As illustrated in FIG. 7C, in some embodiments, the process of commencing a contract 402 can begin when a served entity 612 can create 702 at least one contract 402. The served entity 612 can then send 604 the at least one contract 402. The at least one contract 402 can be received 608 by a service entity 602. Then, service entity 602 can review 706 and approve 708 the at least one contract 402. At this point, the service entity 602 and/or a responding entity can begin offering services 710.

FIGS. 7A, 7B, and 7C illustrate some common and/or exemplary processes for commencing a contract 402. One skilled in the art will be able to conceive of additional and/or alternate processes, and thus it should be understood that all such additional and/or alternate processes are intended to fall within the scope and spirit of FIGS. 7A, 7B, and 7C.

In some embodiments, response services can be offered pro bono (i.e. for free, and/or for the public good), and in such cases, it can be unnecessary to commence a contract prior to offering services. Therefore, in such embodiments, steps 604, 608, 702, 704, 706, 708, and/or 710 can be omitted, skipped, abbreviated, and/or done at a later time.

Steps 604, 608, 702, 704, 706, 708 and 710 can be order-flexible in relation to each other.

Steps 604, 608, 702, 704, 706, 708 and 710 can be actor-flexible, duration-flexible, onset-flexible, proximity-flexible, repetition-flexible, and/or secrecy-flexible.

Steps 604, 608, 702, 704, 706, 708 and 710 can be optional and/or discretionary, and thus, can occur in some embodiments but not in others.

FIG. 8 is a block diagram showing several exemplary contract 402 types. When requesting, agreeing to, asking for, asking about, deciding upon, learning about, negotiating, talking about, discussing, purchasing, paying for, and/or choosing response services, certain types 800 of contracts can be particularly useful, relevant, and/or convenient. Such contract types 800 are illustrated in FIG. 8, and described below.

An exemplary list of some, but not all, contract types 800 is given below:

Letter of intent (LOI) 802

Non-disclosure agreement (NDA) 804

Service request (SR) 806

Memorandum of understanding (MOU) 808

Service agreement (SA) 810

The contracts and/or documents listed above, and shown in FIG. 8, are provided by way of example only, and are not intended to be restrictive or limiting in any way. One skilled in the art will be able to conceive of additional and/or alternate contracts and/or documents which could be used with the same or similar results, and thus it should be understood that all such additional and/or alternate contracts and/or documents are intended to fall within the scope and spirit of FIG. 8.

As used herein, the term “letter of intent” (LOI) 802 refers to a document which outlines an agreement between two or more parties before the agreement is finalized, wherein the document may or may not be legally binding. A letter of intent is well known in the art, and thus, the commonly understood definition is also meant to be included in the term herein defined as “letter of intent” 802.

As used herein, the term “non-disclosure agreement” (NDA) 804 refers to a contract signed by two or more parties which outlines one or more secret or confidential items or subjects, and wherein the parties agree not to disclose or reveal any of the secret or confidential items or subjects. A non-disclosure agreement (NDA) is well known in the art, and thus, the commonly understood definition is also meant to be included in the term herein defined as “non-disclosure agreement” 804.

As used herein, the term “service request” (SR) 806 refers to a document in which a customer requests one or more services from a service provider, wherein the document may or may not be legally binding. A service request is well known in the art, and thus, the commonly understood definition is also meant to be included in the term herein defined as “service request” 806.

As used herein, the term “memorandum of understanding” (MOU) 808 refers to a document expressing a bilateral or multi-lateral agreement between two or more parties, wherein the agreement pertains to a convergence of wills or an intended common line of action, and wherein the document may or may not be legally binding. A memorandum of understanding is well known in the art, and thus, the commonly understood definition is also meant to be included in the term herein defined as “memorandum of understanding” 808.

As used herein, the term “service agreement” (SA) 810 refers to a contract that defines, explains, limits, describes, provides for, establishes, commences, and/or allows for service between a service provider and a customer. A service agreement is well known in the art, and thus, the commonly understood definition is also meant to be included in the term herein defined as “service agreement” 810.

Contracts and/or documents 802, 804, 806, 808, and 810 can be optional and/or discretionary, and thus, can occur in some embodiments but not in others.

In some embodiments, one of the contract types (802, 804, 806, 808, and 810) can be used. In other embodiments, all of the contract types (802, 804, 806, 808, and 810) can be used. In still other embodiments, none of the contract types (802, 804, 806, 808, and 810) can be used. In yet other embodiments, multiple contract types (802, 804, 806, 808, and 810) can be used.

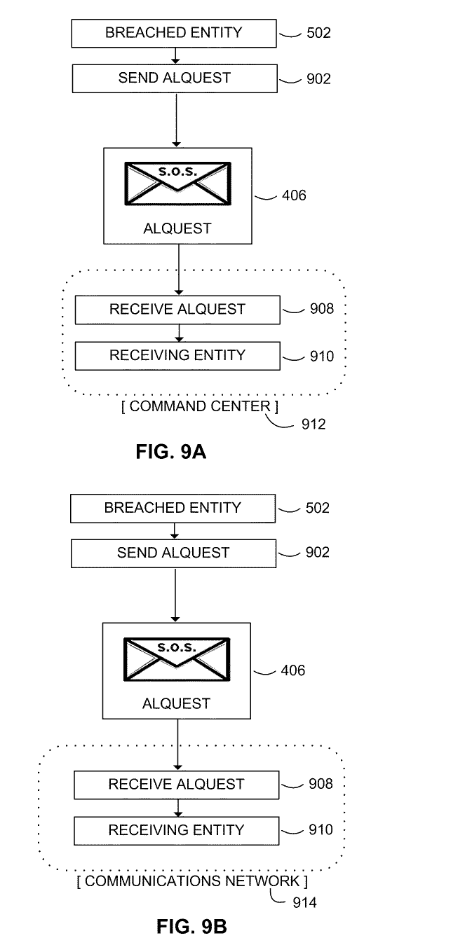

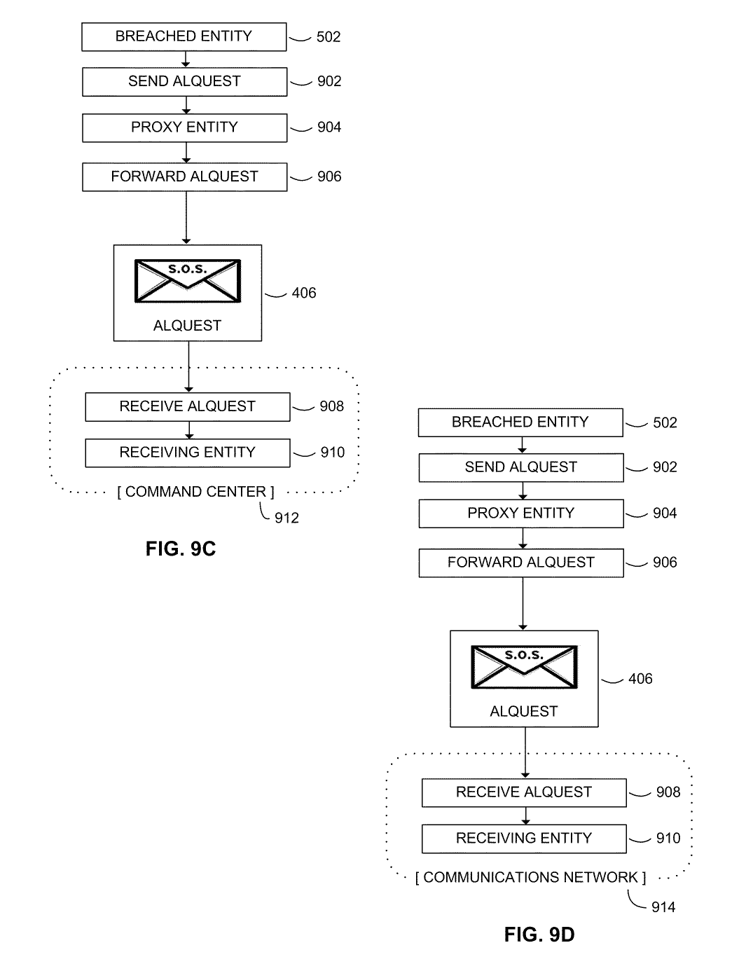

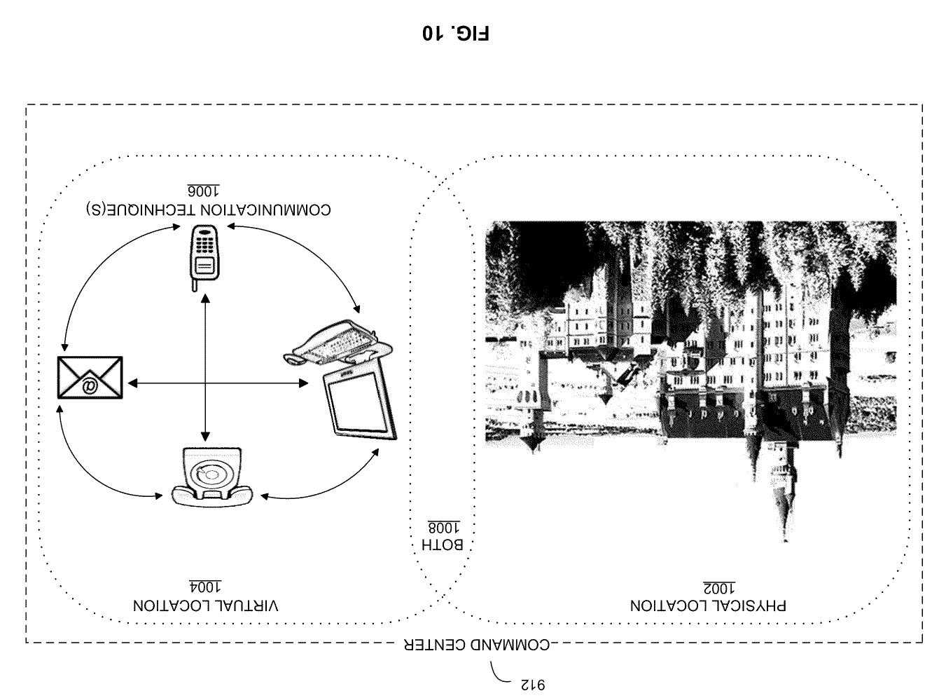

FIG. 9A is a flowchart showing a process for receiving an alquest which was sent by a breached entity 502, wherein receipt occurs at a command center 912. FIG. 9B is a flowchart showing a process for receiving an alquest 406 which was sent by a breached entity 502, wherein receipt occurs through a communications network 914. FIG. 9C is a flowchart showing a process for receiving an alquest 406 which was forwarded by a proxy entity 904, wherein receipt occurs at a command center 912. FIG. 9D is a flowchart showing a process for receiving an alquest 406 which was forwarded by a proxy entity 904, wherein receipt occurs through a communications network 914.

When a given compromise 404 occurs, a responding entity must become aware of the compromise 404 before response services can be rendered. In some embodiments, a responding entity can become aware of the compromise 404 through an alquest 406. Therefore, sending and receiving at least one alquest 406 can be a crucial and/or important step leading up to the response 408 process.

At step 902, at least one alquest 406 can be sent by a breached entity 502. As used in regards to step 906, “send” (and all of its verb forms) can mean: send, transmit, deliver, hand off, convey, upload, give, dispatch, make available, present, any combination thereof, and/or any known and/or convenient action having the same or similar function.

An alquest 406 can be sent 902 using any transmission technique 606. By way of non-limiting example, an alquest 406 can be sent 902 via: telephone, computer, email, text message, instant message, page on a pager, internet, computer network, communications network, postal mail, and the like. The alquest 406 can be sent 902 with or without awareness of the breached entity 502.

At step 906, at least one alquest 406 can be forwarded by at least one proxy entity 904. As used in regards to step 906, “forward” (and all of its verb forms) can mean: forward, pass along, relay, refer, send, dispatch, convey, transmit, respond, any combination thereof, and/or any known and/or convenient action having the same or similar function.

As used herein, the term “proxy entity” 904 refers to an entity that is, at least in part, representing or acting on behalf of, a breached entity. A proxy entity can forward and/or send an alquest in order to obtain help, services, intercession, and/or assistance for at least one breached entity. In one example, a proxy entity can be a law enforcement agency that, upon receiving an alert or emergency notification from a breached entity, sends an alquest to a command center. In another example, a proxy entity can be third-party law firm employed by the breached entity, and when a compromise occurs, the breached entity sends an alquest to the third-party lawn firm, which in turn forwards an alquest to a receiving entity.

An alquest 406 can be forwarded 906 using any transmission technique 606. By way of non-limiting example, an alquest 406 can be forwarded 906 via: telephone, computer, email, text message, instant message, pager, internet, computer network, communications network, postal mail, and the like. The alquest 406 can be forwarded 906 with or without awareness of the breached entity 502 and/or the proxy entity 904.

In some embodiments, a proxy entity 904 can forward 902 the same alquest 406 which was sent 902 to the proxy entity 904.

In other embodiments, a proxy entity 904 can edit, modify, change, censor, revise, abbreviate, and/or alter the alquest 406 prior to forwarding 902 it, and in that case, the proxy entity 904 forwards 902 an alquest 406 which is similar to, related to, and/or derived from the alquest 406 which was sent 902 to the proxy entity 904.

In still other embodiments, a proxy entity 904 can create, invent, write, design, draw, fabricate, build, and/or rewrite a second alquest 406, and then forward 902 the second alquest 406, and in that case, the proxy entity 904 forwards 902 an alquest 406 which is dissimilar to, unrelated to, and/or different from the alquest 406 which was sent 902 to the proxy entity 904.

At step 908, at least one alquest 406 can be received by a receiving entity 910. As used in regards to step 908, “receive” (and all of its verb forms) can mean: receive, get, obtain, capture, grab, download, fetch, acquire, become aware of, collect, read, any combination thereof, and/or any known and/or convenient action having the same or similar function.

As used herein, the term “receiving entity” 910 refers to an entity which can receive an alquest. In some embodiments, a receiving entity can also be a responding entity. In other embodiments, a receiving entity can also be a service entity. In still other embodiments, a receiving entity can be both a responding entity and a service entity. By way of non-limiting example, a receiving entity could be: a human with a communication device who is located at a command center; a human with a portable communication device who is not located at a command center; a computer algorithm running at a command center; a computer algorithm running at somewhere other than a command center; any combination thereof; and/or any known and/or convenient entity arrangement having the same or similar function.

The alquest 406 can be received 908 using any reception technique 610. By way of non-limiting example, an alquest 406 can be received 908 via: telephone, computer, email, text message, instant message, page on a pager, internet, computer network, communications network, postal mail, and the like. The alquest 406 can be forwarded 908 with or without awareness of the breached entity 502 and/or the proxy entity 904.

In some embodiments, the alquest 406 can be received 908 at, by, and/or through a command center 912. In other embodiments, the alquest 406 can be received 908 at, by, and/or through a communications network 914.

As used herein, the term “command center” 912 refers to a center, facility, division, technology, location, application, and/or site, at which, by which, or through which alquests can be received. In various embodiments, a command center can also perform other functions, which are described throughout the detailed description of this disclosure.

As used herein, the term “communications network” 914 refers to a public and/or private network on which at least one communicator is able to communicate with at least one other communicator. By way of non-limiting example, a communications network could be a computer network, a telephone network, a telecom network, a social network, a network of portable communication devices, and/or any combination thereof. A communications network can be unidirectional (such as a radio broadcast), bidirectional (such as a telephone call), or multi-directional (such as a chatroom with more than two entities communicating therein).

FIGS. 9A, 9B, 9C, and 9D illustrate some common and/or exemplary situations in which an alquest 406 can be sent 902 and received 908. One skilled in the art will be able to conceive of additional and/or alternate situations, and thus it should be understood that all such additional and/or alternate situations are intended to fall within the scope and spirit of FIGS. 9A, 9B, 9C, and 9D.

Steps 902, 906, and 908 can be order-flexible in relation to each other.

Steps 902, 906, and 908 can be actor-flexible, duration-flexible, onset-flexible, proximity-flexible, repetition-flexible, and/or secrecy-flexible.

Steps 902, 906, and 908 can be optional and/or discretionary, and thus, can occur in some embodiments but not in others.

FIG. 10 is a block diagram illustrating a conceptual model of a command center which comprises several exemplary locations.

A command center 912 can be located in the physical world and/or a virtual world. Each type of location can have its own advantages, limitations, attributes, and traits. Because a command center 912 can exist in many possible locations, configurations, arrangements, localities, modes, styles, environments, domains, and the like, it should be understood that a command center 912 can be defined and/or identified by its role(s), responsibility(ies), behavior(s), function(s), and/or purpose(s).

In some embodiments, a command center 912 can exist in at least one physical location 1002. As used herein, the term “physical location” 1002 refers to any location, space, zone, site, building, coordinates, edifice, construction, region, geography, address, and/or place that, at least in part, exists in a physical, material, tangible, analog, and/or “real” world, and/or occupies physical, material, tangible, analog, and/or “real” space. By way of non-limiting example, a physical location could be: an office, a house, a campsite, a street, a city, a building, a country, a room, a floor in a building, a cubicle, a location identifiable by GPS coordinates and/or latitude and/or longitude coordinates, any combination thereof, and/or any known and/or convenient location having the same or similar function.

An exemplary list of some, but not all, possible physical locations 1002 at which a command center 912 could exist is given below:

A room

An office

A building

A house

A call-center

An offshore platform

A tent

A vehicle, such as an airplane, helicopter, ship, boat, van, car, and the like

One skilled in the art will be able to conceive of additional and/or alternate physical locations at which a command center could exist, and thus it should be understood that all such additional and/or alternate physical locations are intended to fall within the scope and spirit of a command center's 912 physical location 1002.

In other embodiments, a command center 912 can exist in at least one virtual location 1004. As used herein, the term “virtual location” 1004 refers to any location, space, zone, site, address, coordinates, arrangement, level, stage, and/or place that, at least in part, exists in a virtual, conceptual, logical, electronic, cerebral, imaginary, non-physical, intangible, and/or immaterial domain, and/or occupies virtual, conceptual, logical, electronic, cerebral, imaginary, non-physical, intangible, and/or immaterial space. By way of non-limiting example, a virtual location could be: a chatroom, an instant message, an IP address or range, a subnet IP address or range, a telephone connection, a satellite connection, a website, a virtual domain, a virtual reality, an electronic or digital bulletin board, a telephone conversation, a telephone number, an email address, an email exchange, an email server, a telephone switch, a videogame, any combination thereof, and/or any known and/or convenient location having the same or similar function.

An exemplary list of some, but not all, possible virtual locations 1004 at which a command center 912 could exist is given below:

A chatroom

A text message exchange

An instant message exchange

An email exchange

A telephone call

A website

A videogame

An electronic or digital bulletin board, such as a BBS or an online forum

One skilled in the art will be able to conceive of additional and/or alternate virtual locations at which a command center could exist, and thus it should be understood that all such additional and/or alternate virtual locations are intended to fall within the scope and spirit a command center's 912 virtual location 1004.

Because a command center 912 which exists at least in part in a virtual location 1004 occupies a virtual domain, it can be desirable, beneficial, and/or necessary for that command center 912 to utilize at least one communication technique 1006. A communication technique 1006 can allow a responding entity to communicate with a breached entity 502, a proxy entity 904, an entity, and/or another responding entity.

As used herein, the term “communication technique” 1006 refers to a technique, channel, venue, technology, and/or method for communicating between two or more communicators. A communication technique can be unidirectional (such as a radio broadcast), bidirectional (such as a telephone call), or multi-directional (such as a chatroom with more than two entities communicating therein). By way of non-limiting example, a communication technique could be: email, instant message, text message, telephone, computer, chatroom, website, FTP site, portable communication device, face-to-face conversation, teleconference, sound recording, video recording, web conference, radio signal, face-to-face presentation, sign language, verbal communication, online presentation, paper, physical mail, electronic or digital document, paper or analog document, any combination thereof, and/or any known and/or convenient method of communicating having the same or similar function.

In still other embodiments, a command center 912 can exist both 1008 in at least one virtual location 1004 and in at least one physical location 1002. By way of non-limiting example, a command center which exists both 1008 in a virtual location 1004 and a physical location 1002 could be: a command center comprised of a call-center inside of a cave, staffed by several people, wherein the people utilize computers connected to alquest-receiving chatrooms and alquest-receiving websites.

In some embodiments, a command center 912 which exists in a physical location 1002 can utilize one or more communication techniques 1006. For example, in a command center 912 which occupies several floors of a building, it could be useful and/or necessary for a responding entity to communicate via telephone, smartphone, text message, bulletin board, interoffice mail, and the like. In another example involving a command center 912 which occupies one room in an office, it could be useful and/or necessary for a responding entity to communicate via face-to-face conversation, telephone, sign language, verbal communication, and the like.

In some embodiments, the command center's 912 location can be “secret”, wherein “secret” can mean: secret, private, confidential, classified, hard to obtain, frequently changing, mobile, dynamic, and/or obscure. In other embodiments, the command center's 912 location can be “public”, wherein “public” can mean: public, known, non-confidential, unclassified, easy to obtain, infrequently or seldom changing, stationary, static, and/or obvious.

In some embodiments, there can be more than one command center 912, and in such embodiments, each command center 912 can be secret or public, and can exist in a virtual location 1004, a physical location 1002, or both 1008 a virtual and a physical location.

FIG. 11A is a tabular illustration of an alquest email comprised of exemplary fields. FIG. 11B is a tabular illustration of a structured alquest comprised of exemplary fields.

An alquest 406 can be represented by many fields, formats, and/or structures. By way of non-limiting example, an alquest can be represented by: a telephone call, a facsimile, a voice message, a page on a pager, an email, an instant message, a text message, information exchanged in a chatroom, a physical note passed from one person to another, writing on a chalkboard or whiteboard, a radio transmission, and the like. One skilled in the art will be able to conceive of many other potential fields, formats, and/or structures.

However, in some cases, the variety, variability, inconsistency, and/or ambiguity inherent in so many potential representations can be problematic and/or disadvantageous. For example, when sending and/or receiving an alquest 406 pertaining to a stressful, dangerous, sensitive, expensive, and/or technical compromise 404, any variety, variability, inconsistency, and/or ambiguity in the representation could result in increased costs, danger, and/or severity. Therefore, it can be desirable, beneficial, and/or necessary to use one or more predetermined fields, formats, and/or structures to represent an alquest 406. FIGS. 11A and 11B illustrate two such predetermined fields, formats, and/or structures.

In some embodiments, an alquest 406 can be represented and/or communicated by an alquest email 1100. The types, formats, and purposes of email are well known in the art. However, for purposes of illustration and not limitation, an exemplary alquest email is depicted in FIG. 11A.

An exemplary list of some, but not all, fields that could comprise an alquest email 1110 is given below:
from 1102 (i.e. one or more senders.)
to 1104 (i.e. one or more recipients.)
subject 1106 (i.e. a brief subject line or title.)
body 1108 (i.e. the body, or main message, of the email.)
attachments(s) 1110 (i.e. one or more attachments, such as files, images, graphics, text, recordings, music files, links, hyperlinks, transcripts, data, information, and the like.)
date/time 1112 (i.e. one or more fields representing a day and/or time of when the compromise occurred and/or when the email was sent.)

In some embodiments, an alquest 406 can be represented and/or communicated by a structured alquest 1150. As used herein, a “structured alquest” 1150 can refer to a data structure, data format, form, file format, any combination thereof, and/or any known and/or convenient structure having the same or similar function, which can represent an alquest. For example, a structured alquest could utilize XML, HTML, a binary file, a spreadsheet, a database record, and/or a database table.

An exemplary list of some, but not all, fields that could comprise a structured alquest 1150 is given below:
breached entity 1152 (i.e. a field which identifies at least one breached entity.)
proxy entity (if any) 1154 (i.e. an optional field which identifies at least one proxy entity, if there is one.)
priority 1156 (i.e. a field which identifies at least one priority level, such as high, medium, or low.)
phone number 1158 (i.e. a field which identifies at least one telephone number at which to contact at least one sender, proxy entity, breached entity, and/or contact person.)
fax number 1160 (i.e. a field which identifies at least one fax number at which to contact at least one sender, proxy entity, breached entity, and/or contact person.)
email 1162 (i.e. a field which identifies at least one email address at which to contact at least one sender, proxy entity, breached entity, and/or contact person.)
url 1164 (i.e. a field which identifies at least one uniform resource locator (URL) address pertaining to at least one sender, proxy entity, breached entity, and/or contact person.)
online alias 1166 (i.e. a field which identifies at least one online alias, name, and/or handle by which to contact at least one sender, proxy entity, breached entity, and/or contact person.)
contact name 1168 (i.e. a field which identifies at least one contact person and/or contact entity.)
initial compromise info (if any) 1170 (i.e. a field which can be used to store and/or represent at least one dimi pertaining the compromise, such as: when the compromise occurred, where the compromise occurred, who or what is affected by the compromise, traits of the compromise, estimated cost of damages done thus far by the compromise, and the like.)
timestamp 1172 (i.e. one or more fields representing a day and/or time of when the compromise occurred and/or when the structured alquest was created and/or sent.)

An alquest email 1100 and/or a structured alquest 1150 can be represented and/or expressed in: extensible markup language (XML); hypertext markup language (HTML); a database record, column, table, and/or file (such as Oracle or SQL Server); binary large object (BLOB); a flat file; a portable document file (PDF); a spreadsheet; a presentation; an email; any markup language; any compressed file format (such as .ZIP, .RAR, .GZIP, .TAR, .CAB, and the like); any scripting language; a proprietary file format; a text-based file format; a binary file format; any combination thereof; and/or any known and/or convenient representation having the same or similar function.

The fields, formats, and structures of FIGS. 11A and 11B are provided by way of example only, and are not intended to be restrictive or limiting in any way. One skilled in the art will be able to conceive of additional and/or alternate fields, formats, and structures which could be used with the same or similar results, and thus it should be understood that all such additional and/or alternate fields, formats, and/or structures are intended to fall within the scope and spirit of FIGS. 11A and 11B.

FIG. 12A is a block diagram showing various exemplary system components.

In the process of responding 408 to a compromise 404, various system components 1200 can be used, employed, activated, installed, implemented, arranged, executed, delegated, utilized, exploited, and/or deployed. It can be useful to think of system components 1200 as the ingredients, tools, or resources of the response 408 process. System components 1200 can be used, consumed, deployed, viewed, stored, executed, and/or implemented by and/or on at least one breached entity 502, responding entity, served entity 612, service entity 602, proxy entity 904, entity, individual, and/or government agency 613.

As used in regards to FIG. 12A, the term “system components” 1200 refers to components, pieces, parts, elements, sub-components, nodes, portions, and/or divisions of a system, method, process, technique, and/or procedure, wherein the system, method, process, technique, and/or procedure is at least in part suitable for responding 408 to a compromise 404.

Furthermore, system components 1200 can be used, employed, activated, installed, implemented, arranged, executed, delegated, utilized, exploited, and/or deployed at any time before, during, and/or after the compromise 404, and/or at any time before, during, and/or after the response 408.

System components can comprise, but are not limited to: command center 912, computer network 1202, computing device 1204, communications network 914, secure online portal 1208, risk officer 1210, portable communication device 1212, communication device 1214, team 1216, computer 1218, computer-readable medium 1220, electronic storage medium 1222, database 1224, cryptographic appliance 1226, response vehicle 1228, any quantity and/or combination thereof, and/or any known and/or convenient component having the same or similar function.

As used herein, the term “computer network” 1202 refers to a public and/or private network on which at least one computer is able to communicate with at least one other computer. By way of non-limiting example, a computer network could be a local area network (LAN), a wide area network (WAN), a wireless network, an interoffice network, an intraoffice network, a corporate network, a virtual network, a virtual private network (VPN), the internet, an intranet, and/or any combination thereof. A computer network can be unidirectional, bidirectional, or multi-directional.

As used herein, the term “computing device” 1204 refers to any device, apparatus, machine, hardware, software, and/or combination thereof, having at least some of the capabilities of a computer. By way of non-limiting example, a computing device could be: a computer, a television, a toaster, a microwave, an automobile, a calculator, a cellular phone, a smartphone, an intercom, a firewall, a stereo, a portable music player, a digital camera, a video gaming console or system, a videogame, and the like.

As used herein, the term “secure online portal” 1208 refers to an application, appliance, and/or service operating at least in part on a computer network and at least in part in a secure manner, wherein the application, appliance, and/or service can be a portal, a share drive, a forum, a post, a website, a weblog, an FTP site, a web conference, and/or a chatroom. The secure manner includes, but is not limited to: encryption, digital fingerprinting, secure signatures, rights management, access management, identity management, biometric management, biometric protection, password protection, activity logging, and/or role-based access.

As used herein, the term “risk officer” 1210 refers to an entity whose job entails, at least in part, acting as a leader, decision-maker, and/or advisor before, during, and/or after a compromise. Generally, a risk officer has at least one of the following skills: technical skills, public relations skills, legal skills, or forensics skills. In some cases, the risk officer can have all of the aforementioned skills. In other cases, the risk officer can have none of the aforementioned skills. Although the name “risk officer” is used herein for clarity and suggestiveness, any entity or entities with the roles, functions, and/or responsibilities of a risk officer is effectively a risk officer for the purposes of this disclosure. A risk officer can be part of a team, a team leader, and/or have no team affiliation. Furthermore, a risk officer can be on one, or more than one, team.

As used herein, the term “portable communication device” 1212 refers to a communication device that is, at least in part, at least sometimes, portable.

As used herein, the term “communication device” 1214 refers to a device, apparatus, system, machine, hardware device, and/or software application suitable for communicating between two or more communicators. A communication device can include, but is not limited to: a telephone, a transponder, a receiver, a transmitter, a radio, a computer capable of communicating over a network, a portable communication device, software capable of communicating over a network, hardware capable of communicating over a network, any combination thereof, and/or any known and/or convenient technology having the same or similar function.

As used herein, the term “team” 1216 refers to at least one person working together or independently to achieve at least one goal. The members of a team can work together or independently, with or without knowledge of one another, and can be paid by any number of employers. Furthermore, various teams can work together or independently, with or without knowledge of one another, and can be paid by any number of employers. Two different teams can perform different, complementary, or overlapping functions. The membership and/or size of a team can be changed at any time. A team can exist for any duration of time. Various embodiments can use various numbers and/or configurations of teams. Furthermore, the number and/or configuration of teams can change over time. A given person can be on one or more teams. If a given person is on more than one team, that person can perform essentially the same role on each team, or that person can perform different roles on each team. In one example, a given person can act in legal capacity on two different teams. In another example, a given person can act in a technical capacity on a first team, and act in a forensics acquiring capacity on a second team. A given team can perform various roles and tasks which are not suggested by the name of that team. Thus, it should be understood that teams are named for convenience and/or to generally express their function. Accordingly, the name of a team is not intended to be limiting, restrictive, or prescriptive in any way.

As used herein, the term “computer” 1218 is intended to include, but is not limited to: a general-purpose computer, a personal computer, a digital computer, a laptop computer, a notebook computer, a desktop computer, a network computer, a server, a mainframe, a personal digital assistant (PDA), a computing device, a telephone with computing functions, any combination thereof, and/or any known and/or convenient technology having the same or similar function.

As used herein, the term “computer-readable medium” 1220 refers to any medium capable of being read by a computer. By way of non-limiting example, a computer-readable medium could be: a signal, a digital file, a harddrive, a floppy disk, a compact disc (CD), a digital video disc (DVD), a digital versatile disc (DVD), a thumbdrive, a memory stick, RAM, ROM, a memory card, Flash ROM, Flash RAM, a physical document capable of being scanned, a scantron, a punchcard, any combination thereof, and/or any known and/or convenient technology having the same or similar function.

As used herein, the term “electronic-storage medium” 1222 refers to any medium capable of storing dimis in a digital and/or electrical format.

As used herein, the term “database” 1224 refers to a set, collection, system, group, arrangement, repository, archive, storehouse and/or warehouse of data, information, media, and/or instructions. Generally although not always, a database can support functions and/or commands such as searching, querying, inserting, updating, modifying, adding, deleting, dropping, iterating, and/or the like. Generally although not always, a database can represent its data, information, media, and/or instructions in tables, rows, columns, fields, records, cells, tabs, pages, grids, and/or the like. Various databases are well known in the art, for example: Microsoft SQL Server, MySQL, PeopleSoft, Oracle, Microsoft Access, SAP, flat files, spreadsheets, and the like.

As used herein, the term “cryptographic appliance” 1226 refers to any appliance, device, apparatus, machine, hardware, computer, system, and/or any combination thereof, which at least in part utilizes at least one cryptographic function or property including, but not limited to: encrypting dimis, decrypting dimis, computing a cryptographic hash of dimis, generating a random number, securely signing a dimi, and/or any combination thereof. Furthermore, a cryptographic appliance can utilize, but is not limited to: a block cipher, a stream cipher, a public key encryption function, a hash function, a message digest, a pseudo-random bit generator, a pseudo-random number generator, any combination thereof, and/or any known and/or convenient technology having the same or similar function.

As used herein, the term “response vehicle” 1228 refers to any vehicle capable of transporting at least one person. By way of non-limiting example, a response vehicle could be: an automobile, an airplane, a jet, a helicopter, a boat, a ship, and/or a motorcycle.

In some embodiments, several of the system components 1200 can be present, included, incorporated, and/or used. However, in other embodiments, all of the system components 1200 can be present, included, incorporated, and/or used. In still other embodiments, none of the system components 1200 can be present, included, incorporated, and/or used. In yet other embodiments, one of the system components 1200 can be present, included, incorporated, and/or used.

System components 912, 1202, 1204, 914, 1208, 1210, 1212, 1214, 1216, 1218, 1220, 1222, 1224, 1226, and 1228 can be optional and/or discretionary, and thus, can be present, included, incorporated, and/or used in some embodiments but not in others.

FIG. 12B is a block diagram showing various exemplary system artifacts 1250.

In the process of responding 408 to a compromise 404, various system artifacts 1250 can be created, generated, produced, planned, made, outputted, designed, written, and/or drawn. It can be useful to think of system artifacts 1250 as the outputs or products of the response 408 process. System artifacts 1250 can be used, consumed, viewed, stored, executed, and/or implemented by and/or on at least one breached entity 502, responding entity, served entity 612, service entity 602, proxy entity 904, entity, individual, and/or government agency.

As used in regards to FIG. 12B, the term “system artifacts” 1250 refers to artifacts, dimis, outputs, results, products, files, forms, folders, decisions, records, presentations, reports, and/or contracts which are produced, created, outputted, modified, and/or made by, for, while, during, and/or because of responding 408.

Furthermore, system artifacts 1250 can be created, generated, produced, planned, made, outputted, designed, written, and/or drawn at any time before, during, and/or after the compromise 404, and/or at any time before, during, and/or after the response 408.

System artifacts can comprise, but are not limited to: forensics data 1252, forensics report 1254, risk assessment report 1256, case file 1258, root cause 1260, compromise notice 1262, claims analysis 1264, training program 1266, prelim compromise dimi 1268, security technology 1270, security process 1272, compromise response decision 1274, any quantity and/or combination thereof, and/or any known and/or convenient artifact having the same or similar function.

The various system artifacts 1250 listed above are only intended to represent common and/or exemplary system artifacts 1250, and should not be interpreted as limiting or restrictive in any way. One skilled in the art will be able to conceive of additional and/or alternate system artifacts, and thus it should be understood that all such additional and/or alternate system artifacts are intended to fall within the scope and spirit of system artifacts 1250.

As used herein, the term “forensics data” 1252 refers to dimis which pertain to investigating, prosecuting, and/or responding to at least one compromise. By way of non-limiting example, forensics data can include: papers, testimonies, interviews, signatures, contracts, confessions, sound recordings, voice recordings, video recordings, photographs, screen shots, computers, telephones, computer-readable mediums, communication devices, portable communication devices, financial statements, receipts, spreadsheets, fingerprints, cryptographic hashes, passwords, digital files, digital fingerprints, digital signatures, computer network traffic, activity logs, telephone call logs, telephone transcripts, digital messages, digital message transcripts, physical mail, and/or any quantity or combination thereof.

As used herein, the term “forensics report” 1254 refers to a report, presentation, document, opinion, form, file, and/or any quantity or combination thereof, which contains, analyzes, aggregates, summarizes, compiles, prioritizes, categorizes, filters, condenses, compresses, and/or presents forensics data.

As used herein, the term “risk assessment report” 1256 refers to a report, presentation, document, opinion, form, file, and/or any quantity or combination thereof, which identifies and/or analyzes risks that can potentially compromise an entity's information asset(s), wherein the compromising can occur at any time in the past, present, and/or future. The risk assessment report can narrate, show, depict, assess, analyze, rank, categorize, present, and/or display the risks in many different ways. The risk assessment report can be comprised of text, narrative, examples, pictures, diagrams, numbers, data, charts, graphs, tables, matrices, pie charts, scatter plots, pareto graphs, Venn diagrams, grids, and/or cubes (i.e. a data structure having at least two dimensions, suitable for viewing data at various levels of granularity or aggregation). In some embodiments, a graph, table, chart, graph, matrix, cube, and/or grid can have at least two dimensions (such as an X and Y axis, or such as a time, place, and risk-type dimension). These at least two dimensions can relate to type of risk, and another dimension can relate to severity of the risk, and yet another dimension can relate to the likelihood of the risk, and still another dimension can relate to the cost of the risk. The type of risk is a family, class, group, set, arrangement, and/or any other logical and/or convenient grouping used to identify risks that are related in some predetermined manner. The severity of the risk is an estimate of how severe, extreme, and/or damaging a given risk might be if it were to occur. The likelihood of the risk is an estimate of how likely a given risk is to occur. The cost of the risk is an estimate of how costly, expensive, time-consuming, and/or resource-consuming a given risk might be if it were to occur.

As used herein, the term “case file” 1258 refers to a file, document, folder, data set, record, and/or any quantity or combination thereof, which contains dimis related to at least one compromise. The case file can be represented and/or stored in a digital, analog, electrical, and/or acoustical form, such as a digital file. The contents of a case file can be acquired, obtained, read, stored, searched, compiled, analyzed, or processed at any time before, during, or after the compromise(s).

As used herein, the term “root cause” 1260 refers to at least one reason, action, and/or cause through which, by which, for which, because of which, and/or from which a compromise occurred. The root cause can be singular or a plurality. If the root cause is a plurality, those reasons, actions, and/or causes can be related, unrelated, similar, or dissimilar. In some embodiments, the root cause can be identified such that it is small, simple and verifiable. However, in some cases, the root cause is not verifiable. In other cases, the root cause cannot be made small. In still other cases, the root cause cannot be made simple. Thus, the root cause can be verifiable or not verifiable, small or large, simple or complex. By way of non-limiting example, the root cause could be: leaving the front door unlocked; choosing a weak or obvious password; failing to encrypt a file; being exposed to malware; failing to update an information asset with the recent security patches; falling victim to a distributed denial of service (DDOS) attack, any combination thereof, and/or any number of a vast range of potential root causes that will be known and/or understood to one skilled in the art.

As used herein, the term “compromise notice” 1262 refers to a notice, letter, notification, recording, package, postcard, publication, broadcast, and/or message which can inform an entity that a compromise has occurred. The compromise notice comprises dimis. The compromise notice can be in any format suitable for conveying, transmitting, representing, communicating, and/or expressing dimis. The compromise notice can be intended for a broad, narrow, singular, large, small, private, public, specific, and/or general audience. The contents of the compromise notice can be encrypted, unencrypted, thorough, abbreviated, complete, incomplete, straightforward, misleading, vague, specific, confidential, non-confidential, or any combination thereof.

As used herein, the term “claims analysis” 1264 refers to a report, opinion, analysis, document, file, package, statement, authorization, presentation, form, and/or any combination thereof, which argues for, explains, outlines, describes, asks for, details, and/or discusses a potential and/or desired insurance claim and/or settlement.

As used herein, the term “training program” 1266 refers to a program, package, class, document, presentation, and/or any combination thereof, for the purpose of training, educating, making aware, informing, and/or instructing.

As used herein, the terms “prelim compromise dimi” and “prelim compromise dimis” 1268 refer to one or more dimis pertaining to a particular compromise.

The term “prelim compromise dimi” (and “prelim” in particular) is intended to be convenient and suggestive, but not limiting or restrictive. Thus it should be understood that prelim compromise dimi 1268 does not necessarily have to be preliminary; instead, prelim compromise dimi 1268 can be found, gotten, and/or acquired at any time and any number of times (i.e. duration-flexible, onset-flexible, and repetition-flexible).

As used herein, the term “security technology” 1270 refers to hardware, software, data, machines, apparatuses, devices, computers, and/or any combination or quantity thereof, which pertain, at least in part, to information security. By way of non-limiting example, a security technology could be: a firewall, a router, a switch, a server, a computer, a computer application, computer software, cryptographic hardware, cryptographic software, a password generator, a cryptographic appliance, and/or a software patch.

As used herein, the term “security process” 1272 refers to a process, policy, rule, practice, procedure, technique, standard, guideline, recommendation, and/or any combination or quantity thereof, which pertains, at least in part, to information security. By way of non-limiting example, a security process could be: a policy requiring passwords to be at least 8 characters long; a process for removing access rights from an employee upon termination of the employee; or a standard technique for conducting background checks of an employee prior to hiring the employee.

As used herein, the term “compromise response decision” 1274 refers to a decision made or action taken, wherein the decision and/or action pertains at least in part to a compromise. The compromise response decision can be made at any time before, during, and/or after the compromise, and can be made gradually, in pieces, or all at once. Furthermore, the compromise decision can be made by any quantity or combination of persons and/or computer algorithms.

In some embodiments, several of the system artifacts 1250 can be produced and/or created. However, in other embodiments, all of the system artifacts 1250 can be produced and/or created. In still other embodiments, none of the system artifacts 1250 can be produced and/or created. In yet other embodiments, one of the system artifacts 1250 can be produced and/or created.

System artifacts 1252, 1254, 1256, 1258, 1260, 1262, 1264, 1266, 1268, 1270, 1272, and 1274 can be optional and/or discretionary, and thus, can be produced, created, outputted, modified, and/or made in some embodiments but not in others.

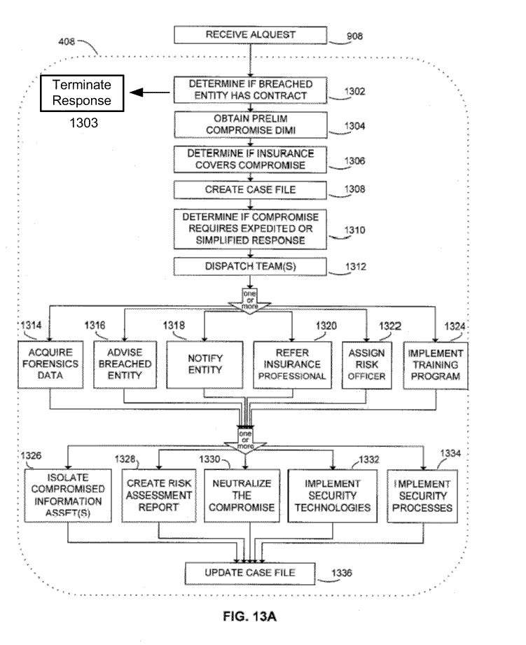

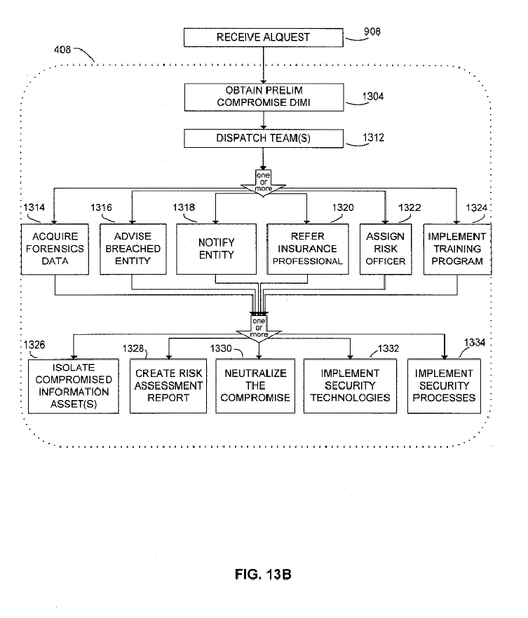

FIG. 13A is a flowchart showing a process for responding to a compromise. FIG. 13B is an alternate embodiment of the process shown in FIG. 13A. After an alquest 406 has been received 908, the compromise 404 can be responded 408 to. The response 408 process can be highly flexible and/or variable. The steps which are performed, as well as the order in which they are performed, can depend on various factors. These factors can include, but are not limited to: prelim compromise dimis 1268; when and/or in what manner an alquest 406 was received 908; whether or not the compromise 404 is a threat to human life, a threat to geo-political security, or a suspected terrorist attack; terms, conditions, limitations, service levels, and the like as defined in at least one contract 402; the root cause 1260 of the compromise 404; and various other possible factors.

As indicated by the dotted outer box, responding 408 to a compromise 404 can be more fully understood when considered as a set of possible sub-steps (1302, 1304, 1306, 1308, 1310, 1312, 1314, 1316, 1318, 1320, 1322, 1324, 1326, 1328, 1330, 1332, 1334, and 1336) as described below.

Not every step (1302, 1304, 1306, 1308, 1310, 1312, 1314, 1316, 1318, 1320, 1322, 1324, 1326, 1328, 1330, 1332, 1334, and 1336) shown in FIG. 13A must be performed in the response 408 process. In various embodiments, various of those aforementioned steps can be omitted, skipped, abbreviated, performed in an alternate order, and/or any combination thereof.

At step 908, at least one alquest 406 can be received. Reference is made to FIGS. 9A, 9B, 9C, and 9D, in which a process for receiving 908 an alquest 406 is described in greater detail.

At step 1302, it can be determined if a breached entity 502 has at least one contract 402 with the service entity 602, wherein the at least one contract 402 was signed, read, and/or agreed to prior to an occurrence of a compromise 404.

In some embodiments, the at least one contract 402 can be stored, archived, recorded, housed, and/or kept by a service entity 602. In other embodiments, the at least one contract 402 can be stored, archived, recorded, housed, and/or kept by a served 612 entity. In still other embodiments, the at least one contract 402 can be stored, archived, recorded, housed, and/or kept by a proxy entity 904.

Because the at least one contract was stored, archived, recorded, housed, and/or kept, the determining 1302 can generally be accomplished by retrieving, finding, verifying, identifying, recovering, and/or viewing the at least one contract. In some embodiments, the retrieving, finding, verifying, identifying, recovering, and/or viewing can be accomplished by querying, pulling up, retrieving from, and/or searching a: database 1224, search engine, record set, data set, file browser, file manager, any combination thereof, and/or any known and/or convenient data repository having the same or similar function. In other embodiments, the retrieving, finding, verifying, identifying, recovering, and/or viewing can be accomplished by reading, viewing, accessing, loading, referring to, and/or making use of a: digital file, electronic file, spreadsheet, checklist, word processor document, text document, physical document (such as paper), any combination thereof, and/or any known and/or convenient document having the same or similar function.

In some embodiments, determining 1302 if a breached entity 502 has a contract 402 can be accomplished from, at, or by a command center 912.

If it is determined 1302 that a breached entity 502 does not have a contract 402 with the service entity 602, then the response 408 process can proceed in several possible ways. In some embodiments, a breached entity 502 without a contract 402 might not be responded 408 to any further, and the process can terminate 1303. In other embodiments, a breached entity 502 without a contract 402 can still be responded 408 to, however the cost can be selectively increased and/or the response time can be longer. In still other embodiments, a breached entity 502 without a contract 402 can be responded 408 to in the same manner as would be a breached entity 502 who had an appropriate contract (i.e. no change is made to the cost and/or response time).

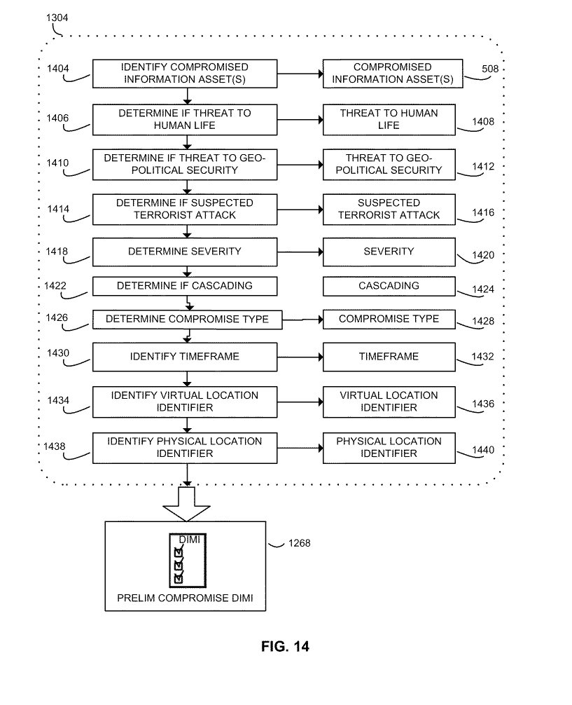

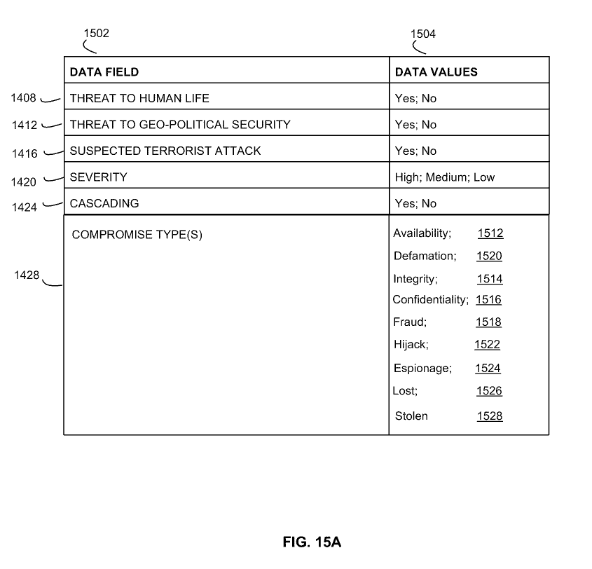

At step 1304, at least some prelim compromise dimi 1268 can be obtained. Reference is made to FIG. 14, in which a process for obtaining 1304 prelim compromise dimi 1268 is described in greater detail.

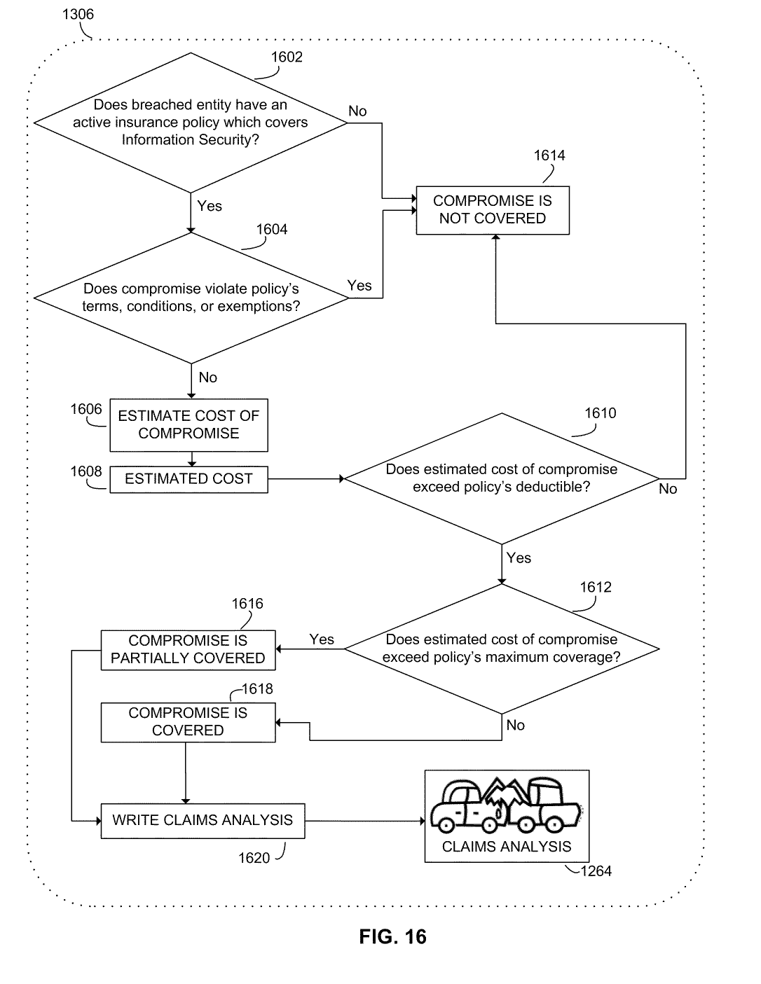

At step 1306, it can be determined if insurance covers part, all, or none of a given compromise 404. Reference is made to FIG. 16, in which a process for determining if a breached entity's 502 insurance covers a given compromise 404 is described in greater detail.

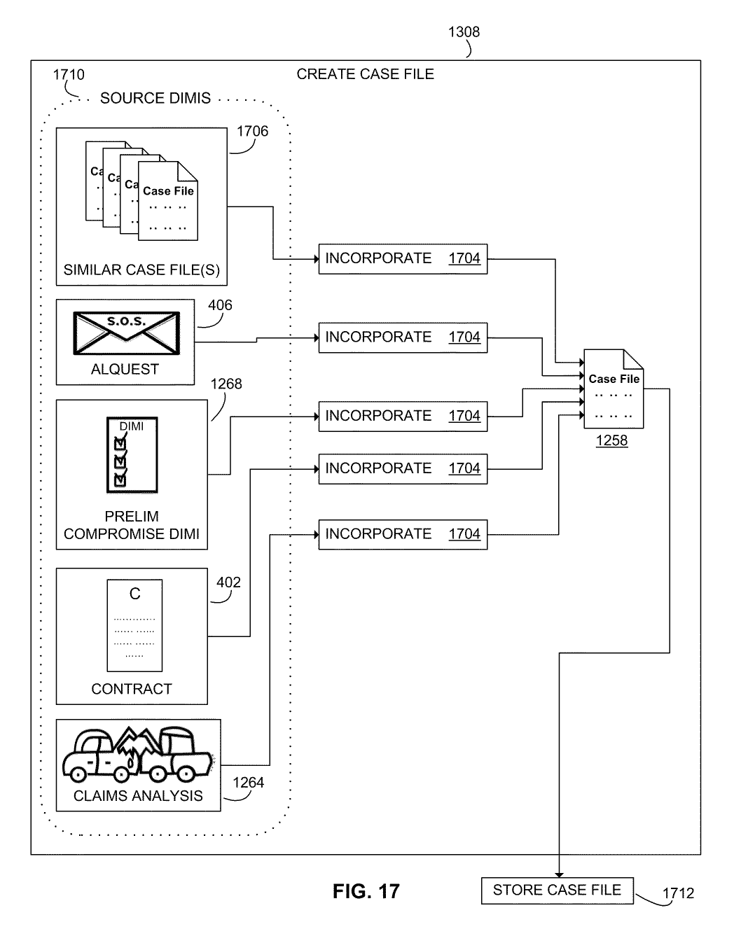

At step 1308, at least one case file 1258 can be created. Reference is made to FIG. 17, in which a process for creating 1308 a case file 1258 is described in greater detail.

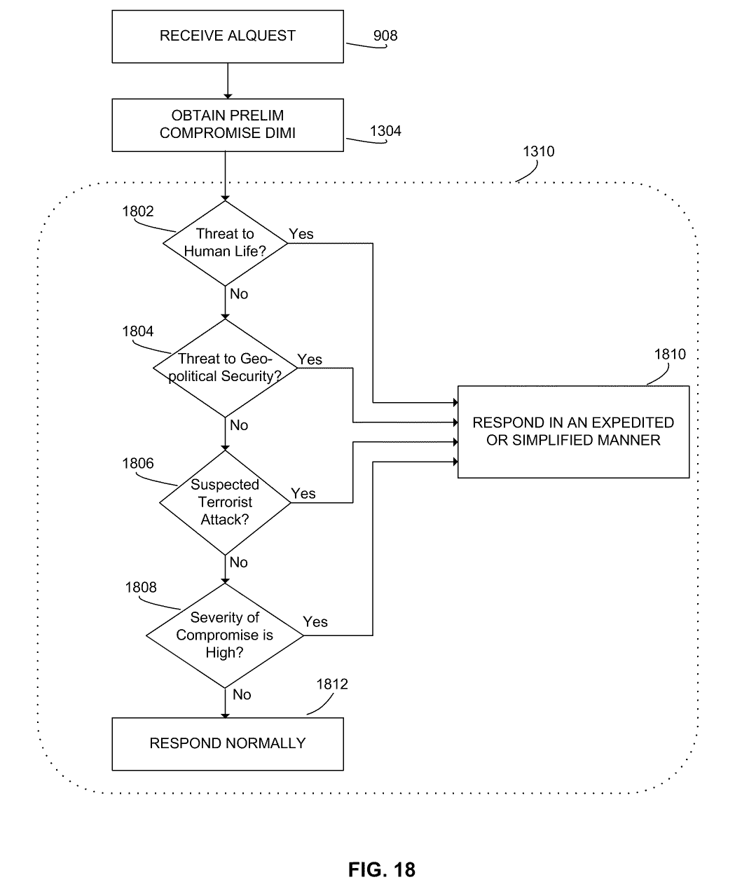

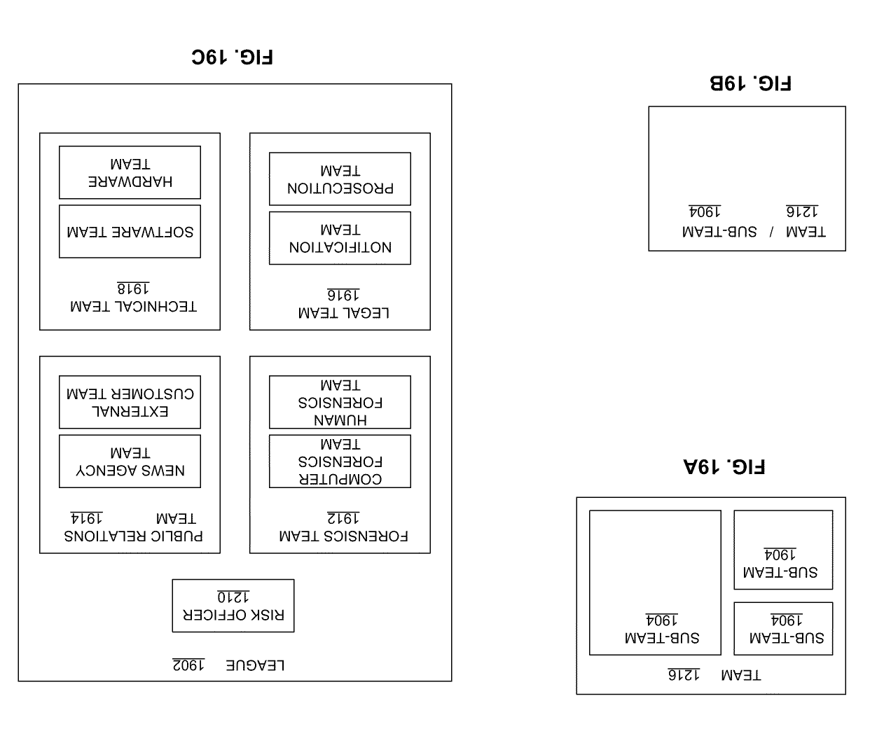

At step 1310, it can be determined if a compromise 404 requires an expedited or simplified response 408. Reference is made to FIG. 18, in which a process for determining if a compromise 404 requires an expedited or simplified response 408 is described in greater detail.

At step 1312, at least one team 1216 can be dispatched. As used in regard to step 1312, “dispatch” can mean: dispatch, send, activate, mobilize, form, organize, allocate, delegate, instruct, move, reorganize, assign, reassign, engage, notify, alert, any combination thereof, and/or any known and/or convenient action having the same or similar function.

Prior to being dispatched 1312, a team 1216 may or may not exist as such. For example, prior to being dispatched 1312, the entities comprising a given team could be: out of town, unavailable, retired, asleep, powered down, hibernating, in jail, responding to other compromises, part of another team, and/or working for another company or agency.

In some embodiments, the dispatching 1312 can be accomplished using any communication technique 1006. In other embodiments, the dispatching 1312 can be accomplished using a communications network 914 and/or over a computer network 1202. In still other embodiments, the dispatching 1312 can be accomplished by sending at least one signal. In yet other embodiments, the dispatching can also be accomplished by organizing, forming, assigning, delegating, activating, instructing, and/or moving at least one team 1216.

In some embodiments, the at least one team 1216 can be dispatched 1312 by a signal, communication, and/or message sent by or from a command center 912. In other embodiments, the at least one team 1216 can be dispatched 1312 by a signal, communication, and/or message not by or from sent from a command center 912. In still other embodiments, the at least one team 1216 can be dispatched 1312 by a signal, communication, and/or message sent by or from a responding entity, risk officer 1210, breached entity 502, proxy entity 904, and/or service entity 602.

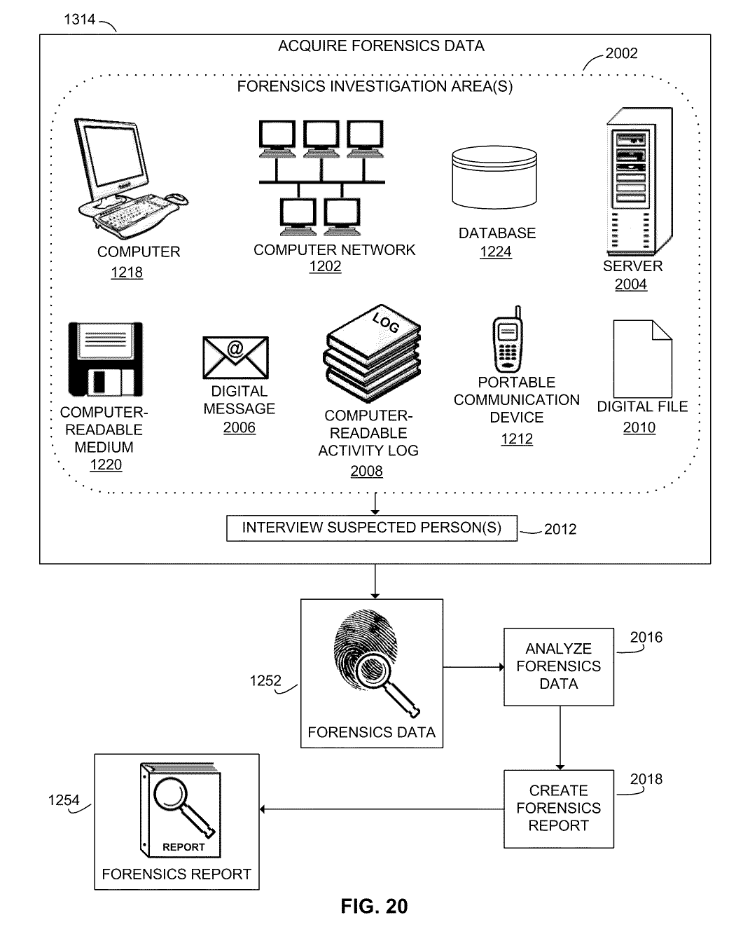

At step 1314, forensics data 1252 can be acquired. Reference is made to FIG. 20, in which a process for acquiring 1314 forensics data is described in greater detail.

At step 1316, a breached entity 502 can be advised regarding at least one compromise response decision 1274. Reference is made to FIG. 22, in which a process for advising 1316 a breached entity 502 is described in greater detail.

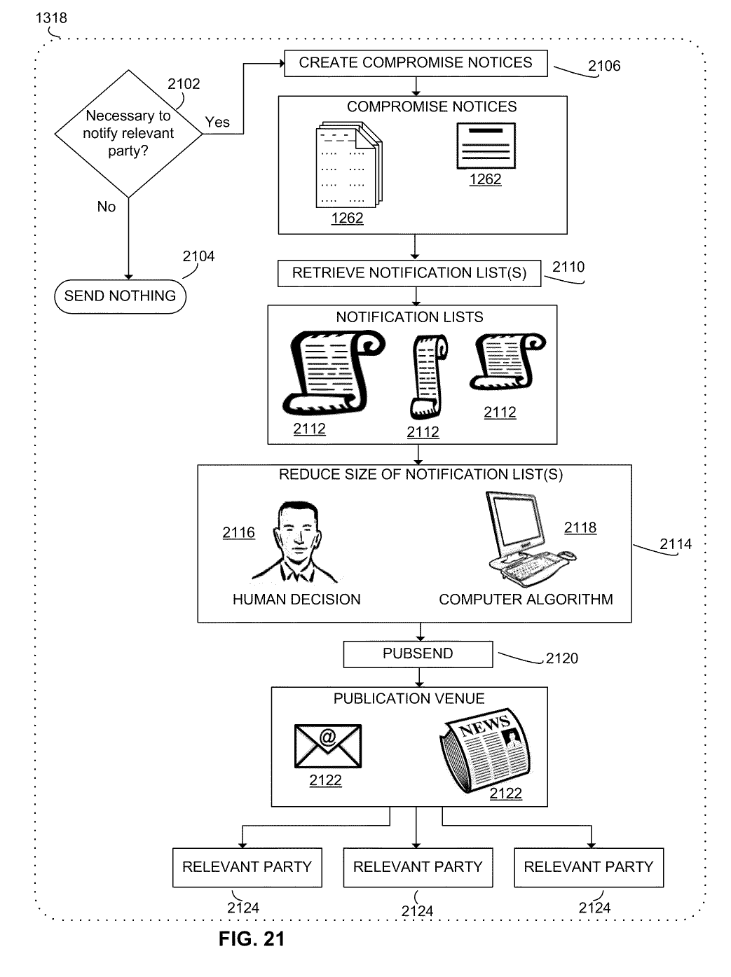

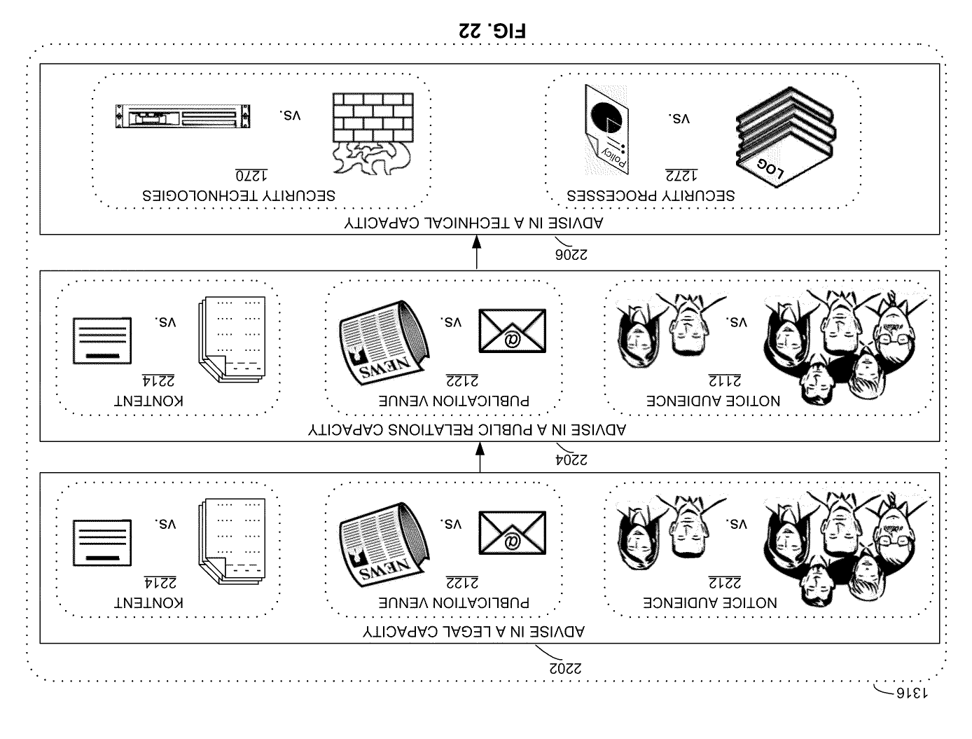

At step 1318, at least one entity can be notified about a compromise 404. Reference is made to FIG. 21, in which a process for notifying 1318 at least one entity is described in greater detail.

At step 1320, at least one insurance professional can be referred to a breached entity 502.

By way of non-limiting example, an insurance professional could be: an insurer, an insurance broker, a re-insurer, an insurance agent, an insurance adjustor, a claims specialist, an insurance specialist, a breached entity 502, a proxy entity 904, a team 1216, a sub-team, a risk officer, any combination thereof, and/or any known and/or convenient entity having the same or similar function.

One or more insurance professionals can be referred to a given breached entity 502. A given insurance professional can be referred to one or more breached entities 502. The insurance professional can be swapped, substituted, terminated, withdrew, cancelled, and/or re-assigned, at any time, for any reason.

In some embodiments, the referring 1320 can be accomplished using any communication technique 1006. In other embodiments, the referring 1320 can be accomplished using a communications network 914 and/or over a computer network 1202. In still other embodiments, the referring 1320 can be accomplished by sending at least one signal.

At step 1322, a risk officer 1210 can be assigned to a breached entity 502.

One or more risk officers 1210 can be assigned to a given breached entity 502. A given risk officer 1210 can be assigned to one or more breached entities 502. The risk officer 1210 can be swapped, substituted, terminated, withdrawn, cancelled, and/or re-assigned, at any time, for any reason.

In some embodiments, the assigning 1322 can be accomplished using any communication technique 1006. In other embodiments, the assigning 1322 can be accomplished using a communications network 914 and/or over a computer network 1202. In still other embodiments, the assigning 1322 can be accomplished by sending at least one signal.

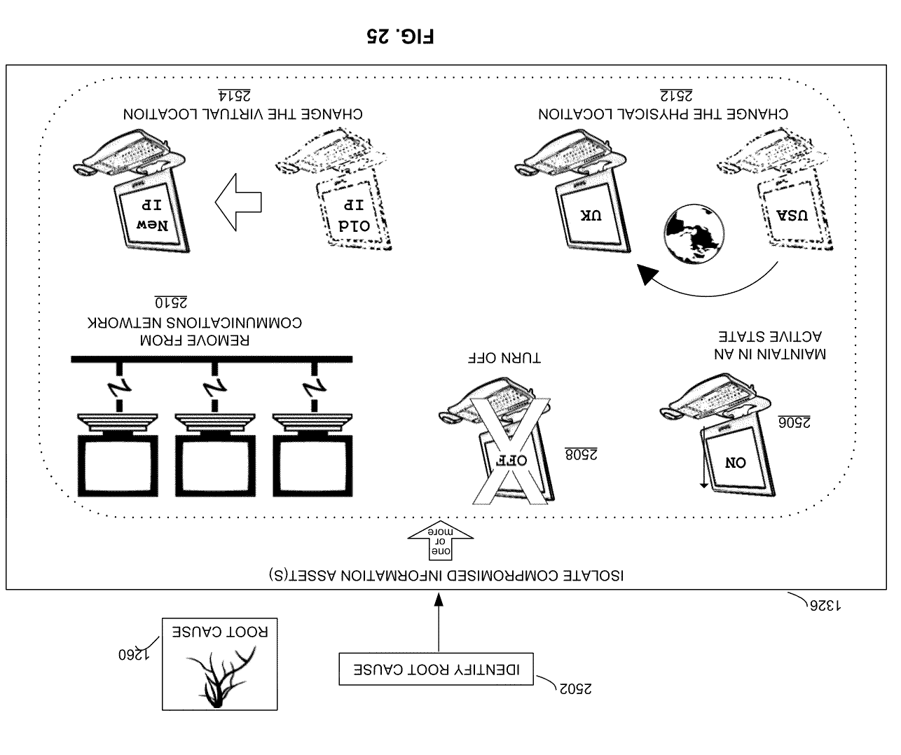

At step 1324, a training program 1266 can be implemented. Reference is made to FIGS. 24A, 24B, and 24C, in which a process for implementing 1324 a training program 1266 is described in greater detail.

At step 1326, at least one compromised information asset 508 can be isolated. Reference is made to FIG. 25, in which a process for isolating 1326 compromised information asset(s) 508 is described in greater detail.

As used herein, the term “isolate” and all of its verb forms (such as “isolating” and “isolated”) can mean to: isolate, separate, quarantine, divide, move, sequester, relocate, reassign, rearrange, rename, turn off, leave on, maintain, disconnect, and/or any other known and/or convenient action having the same or similar function.

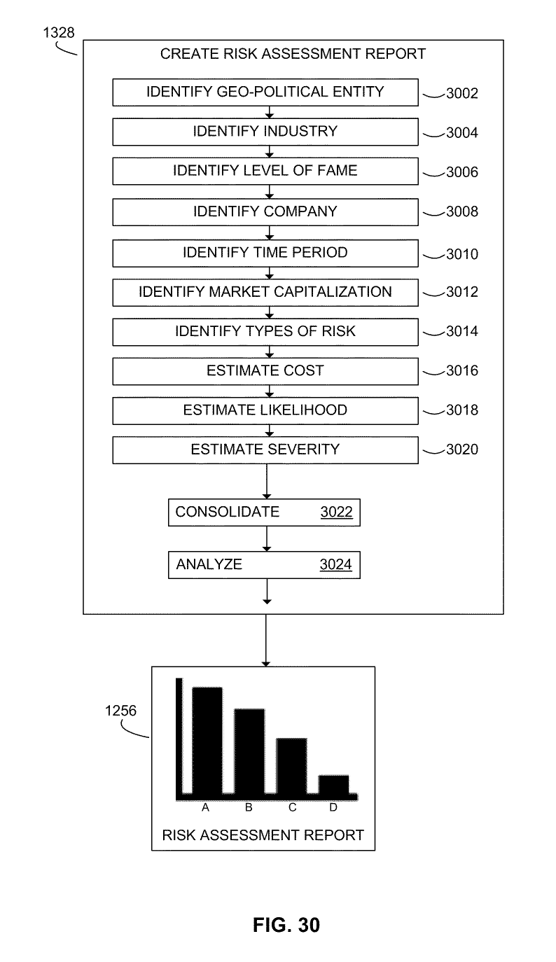

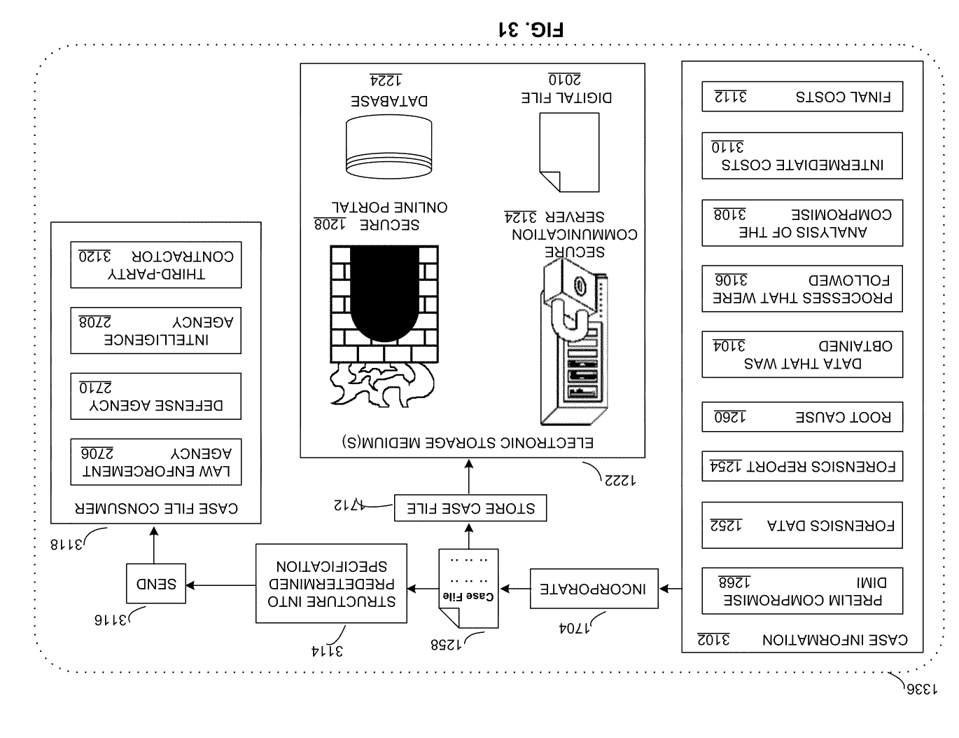

At step 1328, a risk assessment report 1256 can be created. Reference is made to FIG. 30, in which a process for creating 1328 a risk assessment report 1256 is described in greater detail.

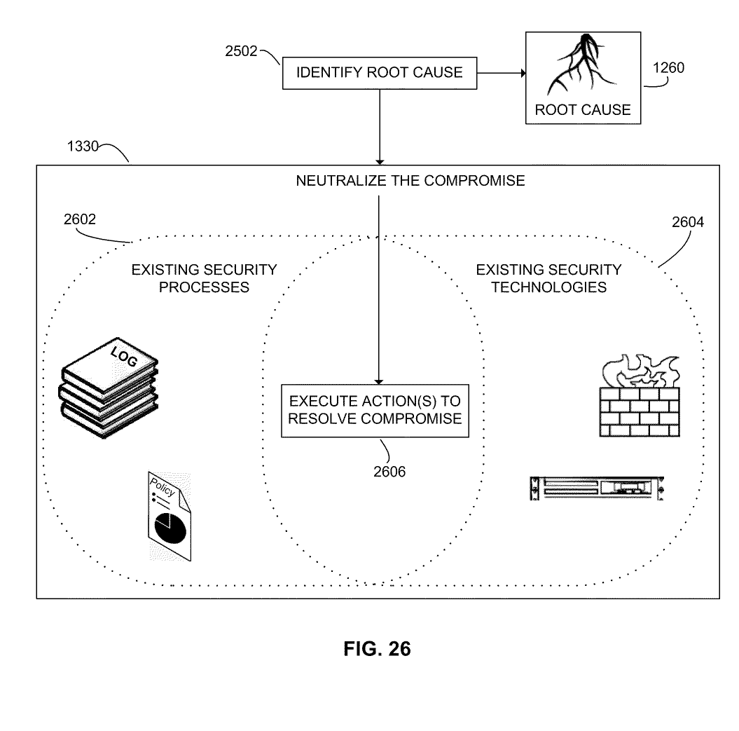

At step 1330, a compromise 404 can be neutralized. Reference is made to FIG. 26, in which a process for neutralizing 1330 a compromise 404 is described in greater detail.

As used herein, the term “neutralize” and all of its verb forms (such as “neutralizing” and “neutralized”) can mean to: neutralize, resolve, restore, fix, repair, clean, disinfect, reboot, reset, reinstall, make usable, lessen the effects of, and/or any other known and/or convenient action having the same or similar function.

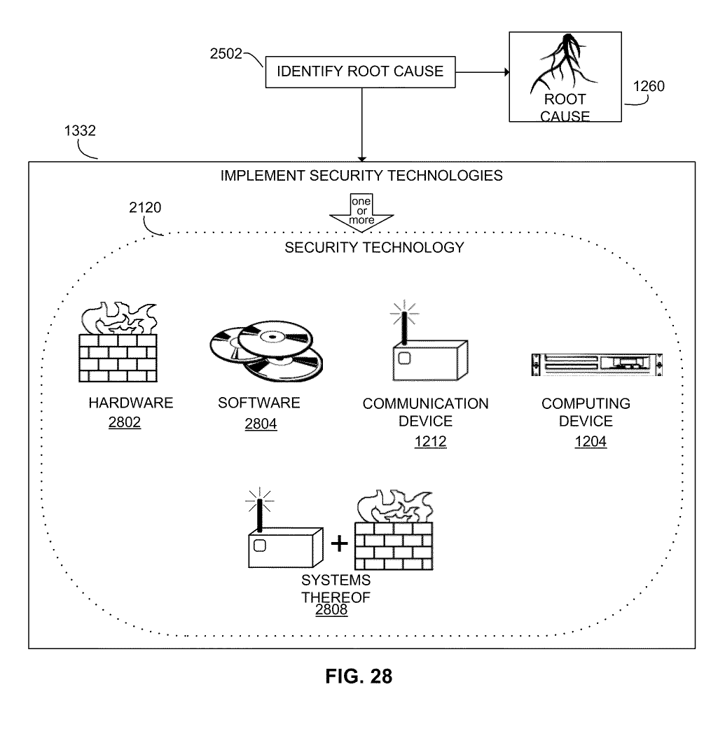

At step 1332, at least one security technology 1270 can be implemented. Reference is made to FIG. 28, in which a process for implementing 1332 security technologies 1270 is described in greater detail.

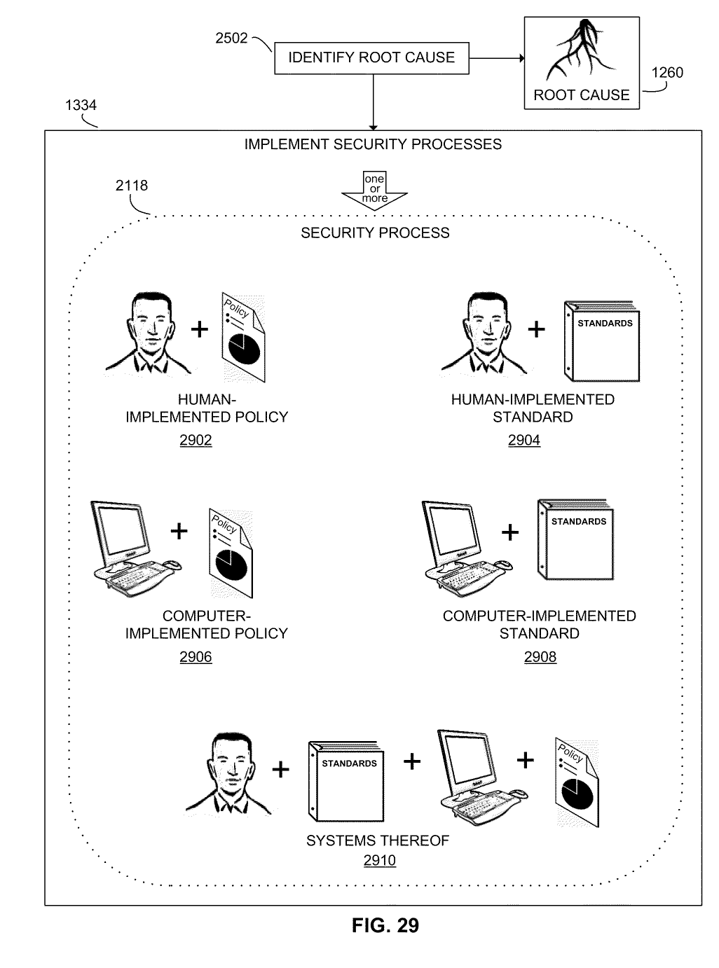

At step 1334, at least one security process 1272 can be implemented. Reference is made to FIG. 29, in which a process for implementing 1334 security processes 1272 is described in greater detail.

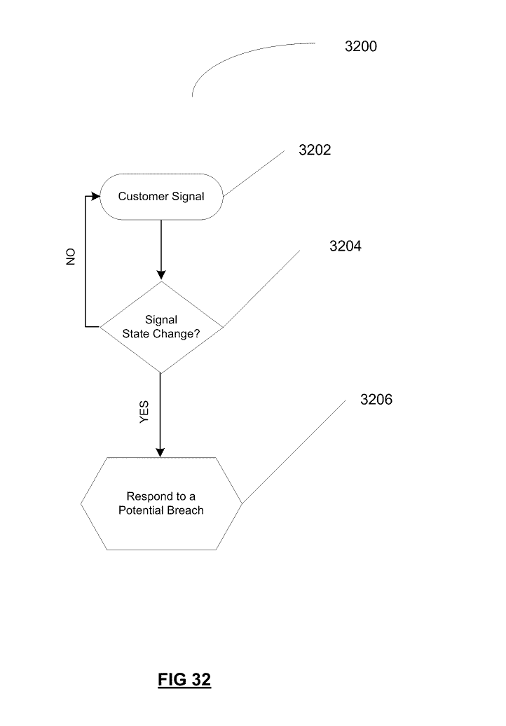

At step 1336, a case file 1258 can be updated. Reference is made to FIG. 31, in which a process for updating 1336 a case file 1258 is described in greater detail.

The steps shown in FIG. 13 can be performed in many different orders, combinations, and permutations while remaining within the scope and spirit of the response process 408.

Steps 908, 1302, 1304, 1306, 1308, 1310, 1312, 1314, 1316, 1318, 1320, 1322, 1324, 1326, 1328, 1330, 1332, 1334, and 1336 can be order-flexible in relation to each other.

Steps 908, 1302, 1304, 1306, 1308, 1310, 1312, 1314, 1316, 1318, 1320, 1322, 1324, 1326, 1328, 1330, 1332, 1334, and 1336 can be actor-flexible, duration-flexible, onset-flexible, proximity-flexible, repetition-flexible, and/or secrecy-flexible.

Steps 908, 1302, 1304, 1306, 1308, 1310, 1312, 1314, 1316, 1318, 1320, 1322, 1324, 1326, 1328, 1330, 1332, 1334, and 1336 can be optional and/or discretionary, and thus, can occur in some embodiments but not others.

In a given embodiment, only one step out of 1314, 1316, 1318, 1320, 1322, and 1324 must be performed. However, in some embodiments, some or all of those steps (1314, 1316, 1318, 1320, 1322, and 1324) can be performed.

In a given embodiment, only one step out of 1326, 1328, 1330, 1332, and 1334 must be performed. However, in some embodiments, some or all of those steps (1326, 1328, 1330, 1332, and 1334) can be performed.

FIG. 14 is a flowchart showing a process for obtaining prelim compromise dimi.

Generally although not always, at the onset of the response 408 process, a breached entity 502 and/or a proxy entity 904 could know some preliminary data and/or information pertaining to the compromise 404. For example, in a case where a proxy entity 904 is forwarding 906 an alquest 406, the proxy entity 904 might know when the compromise 404 occurred and if the compromise 404 is on-going (i.e. still in effect). In another example, a breached entity 502 might know what type of compromise it is, as well as the identity of some information asset(s) that are affected by that compromise 404. Despite the complex and evolving nature of most compromises 404, this preliminary data and/or information can be a useful starting point. It can allow the responding entity(ies) to “hit the ground running” (i.e. respond more quickly and/or effectively), thereby potentially saving money, saving time, focusing resources, allowing a preliminary response plan to be created, and/or reducing the negative effects of the compromise 404. Therefore, it can be desirable, beneficial, and/or necessary to obtain 1304 prelim compromise dimis 1268.

Prelim compromise dimi 1268 can be obtained 1304 from a breached entity 502 and/or a proxy entity 904.

As indicated by the dotted outer box, obtaining 1304 prelim compromise dimi 1268 can be more fully understood when considered as a set of possible sub-steps (1404, 1406, 1410, 1414, 1418, 1422, 1426, 1430, 1434, and 1438) as described below.

Prelim compromise dimis 1268 can comprise, but are not limited to: at least one compromise type 1428, at least one timeframe 1432, a severity component 1420, at least one virtual location identifier 1436, at least one physical location identifier 1440, a data element indicating if a compromise is cascading 1424, a data element indicating if a compromise is a threat to human life 1408, a data element indicating if a compromise is a threat to geo-political security 1412, and/or a data element indicating if a compromise is a suspected terrorist attack 1416. The various dimis listed above are only intended to represent common and/or exemplary dimis which can comprise prelim compromise dimis 1268. One skilled in the art will be able to conceive of additional and/or alternate dimis, and thus it should be understood that all such additional and/or alternate dimis are intended to fall within the scope and spirit of “prelim compromise dimi” 1268.

In some embodiments, the identifying steps of 1404, 1430, 1434, and 1438 can be subjective, variable, non-repeatable, unpredictable, and/or idiosyncratic, due to the possible necessity of interpreting a given compromise 404 at a given time, in a given place, with the currently available information. However, in some embodiments, little or no interpretation of a compromise 404 could be required, and thus, the identifying steps of 1404, 1430, 1434, and 1438 can be objective, deterministic, predictable, repeatable, and/or standardized.

In some embodiments, the determining steps of 1406, 1410, 1414, 1418, 1422, and 1426 can be subjective, variable, non-repeatable, unpredictable, and/or idiosyncratic, due to the possible necessity of interpreting a given compromise 404 at a given time, in a given place, with the currently available information. However, in some embodiments, little or no interpretation of a compromise 404 could be required, and thus, the determining steps of 1406, 1410, 1414, 1418, 1422, and 1426 can be objective, deterministic, predictable, repeatable, and/or standardized.

The identifying steps of 1404, 1430, 1434, and 1438 can be accomplished using any ACEI technique. The identifying steps of 1404, 1430, 1434, and 1438 can also be accomplished by asking, interviewing, probing, surveying, and/or polling the breached entity 502 and/or the proxy entity 904 about a given dimi. The identifying steps of 1404, 1430, 1434, and 1438 can also be accomplished by using any ACEI technique to analyze the alquest 406 for signs, symptoms, patterns, and/or indicators of a given dimi. The identifying steps of 1404, 1430, 1434, and 1438 can also be accomplished by running diagnostic and/or analytic software, hardware, algorithms, and/or processes on at least one information asset and/or compromised information asset belonging to, leased by, and/or affiliated with the breached entity 502.

The determining steps of 1406, 1410, 1414, 1418, 1422, and 1426 can be accomplished using any ACEI technique. The determining steps of 1406, 1410, 1414, 1418, 1422, and 1426 can also be accomplished by asking, interviewing, probing, surveying, and/or polling the breached entity 502 and/or the proxy entity 904 about a given dimi. The determining steps of 1406, 1410, 1414, 1418, 1422, and 1426 can also be accomplished by using any ACEI technique to analyze the alquest 406 for signs, symptoms, patterns, and/or indicators of a given dimi. The determining steps of 1406, 1410, 1414, 1418, 1422, and 1426 can also be accomplished by running diagnostic and/or analytic software, hardware, algorithms, and/or processes on at least one information asset and/or compromised information asset belonging to, leased by, and/or affiliated with the breached entity 502.

At step 1404, at least one compromised information asset 508 can be identified.

At step 1406, it can be determined if the compromise 404 is a threat to human life 1408.

In some cases, a compromise 404 has the potential to be a threat to human life 1408 (i.e. life-threatening). In such cases, one or more lives can be in danger. The person or people whose lives are in danger can be adults, children, civilians, soldiers, policemen, government agents, and/or members of any public authority, and/or any combination thereof. Furthermore, the person or people whose lives are in danger can be aware or unaware of the compromise. The life-threatening compromise 404 can be immediately life-threatening (i.e. in the present), and/or prospectively life-threatening (i.e. at some time in the future).

An exemplary list of some, but not all, compromises 404 that could be a threat to human life 1408 is given below:
A compromise 404 in which life-support systems at a hospital, hospice, and/or care facility are shut down and/or functioning incorrectly.
A compromise 404 in which an air traffic control tower is shut down and/or functioning incorrectly.
A compromise 404 in which the temperature of a room and/or building is made to be too hot or too cold, or a compromise in which the thermostat for a room and/or building is shut down and/or functioning incorrectly or inappropriately.
A compromise 404 in which utility lines (such as gas, water, natural gas, sewage, electricity) for a room and/or building are shut down and/or functioning incorrectly or inappropriately.
A compromise 404 in which traffic lights are shut down and/or functioning incorrectly.

One skilled in the art will be able to conceive of additional and/or alternate compromises which could be a threat to human life, and thus it should be understood that all such additional and/or alternate compromises are intended to fall within the scope and spirit of “threat to human life” 1408.

As used herein, the term “geo-political entity” refers to any organization of people, government(s), political parties, geographies, territories, and/or boundaries, wherein the organization spans and/or occupies at least one physical location. By way of non-limiting example, a geo-political entity could be: a nation, a planet, a state, a township, a city, a city-state, a government, a county, a town, a country, a hamlet, a village, a continent, a union of countries, a union of states, a union of planets, any combination thereof, and/or any known and/or convenient organization having the same or similar function.

At step 1410, it can be determined if the compromise 404 is a threat to geo-political security 1412.

In some cases, a compromise 404 has the potential to be a threat to geo-political security (i.e. a threat to a geo-political entity's security). In such cases, one or many geo-political entities can be threatened with economic, governmental, civil, judicial, and/or military harm, damage, and/or unrest. These threatened geo-political entities can be aware or unaware of the compromise. The compromise 404 which is a threat to geo-political security 404 can be immediately threatening (i.e. in the present), and/or prospectively threatening (i.e. at some time in the future).

An exemplary list of some, but not all, compromises 404 which could be a threat to geo-political security is given below:
A compromise 404 in which a geo-political entity's currency (i.e. money) is deflated, inflated, distorted, made unreliable, made untrustworthy, made unusable, and/or devalued.
A compromise 404 in which financial institutions are damaged, harmed, disturbed, corrupted, shut down, and/or functioning incorrectly.
A compromise 404 in which classified military or government files are stolen or accessed without appropriate authorization.
A compromise 404 in which a military is activated incorrectly, inappropriately, without authorization, at the wrong time, and/or under false pretenses.
A compromise 404 in which emergency response services (such as FEMA in the USA) are activated incorrectly, inappropriately, without authorization, at the wrong time, and/or under false pretenses.

One skilled in the art will be able to conceive of additional and/or alternate compromises which could be a threat to geo-political security, and thus it should be understood that all such additional and/or alternate compromises are intended to fall within the scope and spirit of “threat to geo-political security” 1412.

At step 1414, it can be determined if the compromise 404 is suspected terrorist attack 1416.

In some cases, a compromise 404 has the potential to be a suspected terrorist attack. The real or probable victims of the terrorism compromise typically comprise civilians, but can also comprise soldiers, policemen, emergency response personnel, government agents, and the like, and/or any combination thereof. The real or probable victims of the terrorism attack compromise can be aware or unaware of the compromise. The compromise 404 which is a suspected terrorist attack can be effective immediately (i.e. in the present), and/or effective prospectively (i.e. at some time in the future).

An exemplary list of some, but not all, compromises 404 which could be suspected terrorist attacks is given below:
A compromise 404 in which disinformation or misinformation of a political, economic, and/or military nature is spread across television, the radio, the internet, and/or any other communications network.
A compromise 404 in which infrastructure (such as bridges, roadways, telephone lines, fibre-optic lines, radio-waves, air ways, public transportation lines, and the like) is damaged, harmed, disturbed, corrupted, shut down, and/or functioning incorrectly.
A compromise 404 in which a vehicle capable of carrying many people (such as an airplane, space ship, bus, or cruise ship) is misdirected, misguided, re-routed, mis-instructed, and/or functioning incorrectly.
A compromise 404 in which a nuclear, electric, hydro-electric, coal-powered, petroleum-powered, solar-powered, water-powered, steam-powered, and/or wind-powered energy facility (i.e. power plant) is shut down, damaged, corrupted, and/or functioning incorrectly.
A compromise 404 in which the dispatch systems of a fire department or other public authority are shut down or functioning incorrectly.

One skilled in the art will be able to conceive of additional and/or alternate compromises which could be suspected terrorist attacks, and thus it should be understood that all such additional and/or alternate compromises are intended to fall within the scope and spirit of “suspected terrorist attack” 1416.

At step 1418, a severity component 1420 of the compromise 404 can be determined.

As used in regards to step 1418 and component 1420, the term “severity” 1420 refers to a value which is used to indicate the severity, importance, magnitude, priority level, degree of cost, degree of damage, and/or degree of danger of a compromise. By way of example, the severity value could be high, medium, or low. A particular compromise can only have one severity value (i.e. the values are mutually exclusive). In this disclosure, the words “high”, “medium”, and “low” are used, but it is to be understood that any set (having at least two elements) of words, symbols, colors, or numbers capable of being compared, ranked, and/or ordered, would have the same or similar meaning herein. For example, seventies could be assigned by numeric codes of 1, 2, or 3. In another example, seventies could be assigned by color codes of red, yellow, or green. or any other known and/or convenient set of color codes.

In some cases, a compromise 404 can have a severity 1420 of high (in other words, the compromise is severe in some way). In such cases, the compromise can be severe to one or more persons, companies, organizations, agencies, governments, families, systems, networks, entities, and/or any combination thereof. The potential victims of a compromise having a severity 1420 of high can be aware or unaware of the compromise. The compromise having a severity 1420 of high 404 can be immediately severe (i.e. in the present), and/or prospectively severe (i.e. at some time in the future).

An exemplary list of some, but not all, compromises 404 which could have a severity 1420 of high is given below:
A compromise 404 in which a container ship or oil tanker is made to capsize, thereby causing potentially massive environmental pollution.
A compromise 404 in which a company's quarterly financial reports are tampered with.
A compromise 404 in which family secrets are obtained without authorization or through improper use of a system.
A compromise 404 in which large, possibly criminal, financial transactions are conducted without authorization or through improper use of a system.
A compromise 404 in which the identities of covert government agents is obtained without authorization or through improper use of a system.

One skilled in the art will be able to conceive of additional and/or alternate compromises which could have a severity 1420 of high, and thus it should be understood that all such additional and/or alternate compromises are intended to fall within the scope and spirit of “severity” of high 1420.

At step 1422, it can be determined if the compromise 404 is cascading 1424.

As used herein, the term “cascading” 1424 refers to an incident, compromise 404, and/or event that can spread, propagate, increase, divide, cascade, metastasize, and/or multiply, thereby affecting at least one related, connected, upstream, and/or downstream information asset.

An exemplary list of some, but not all, compromises 404 which could be cascading 1424 is given below:
A compromise 404 in which a computer worm on one computer network spreads to several other computer networks.
A compromise 404 in which a failure at one node on a power grid spreads to other nodes and possibly to other grids, thereby causing a large blackout.
A compromise 404 in which a huge number of packets floods a computer network, overflowing one network resource and then cascading onto more and more network resources.
A compromise 404 in which a hacker gains unauthorized access to one university computer network, and from there, gains further access to affiliated universities around the world.
A compromise 404 in which the stock price of a high profile corporation is made to suddenly drop, thereby causing panic in the stock market.

One skilled in the art will be able to conceive of additional and/or alternate compromises which could be cascading 1424, and thus it should be understood that all such additional and/or alternate compromises are intended to fall within the scope and spirit of “cascading” 1424.

At step 1426, at least one compromise type 1428 can be determined.

As used herein, the term “compromise type” 1428 refers to a type, category, and/or group which can be used to categorize a compromise 404, wherein the type, category, and/or group can be logical, conceptual, relational, hierarchical and/or structural. Each compromise type 1428 can have at least one predetermined trait, attribute, quality, descriptor, pattern, behavior, and/or criterion. A given compromise 404 can be categorized into one, or more than one, compromise type 1428.

At step 1430, at least one timeframe 1432 of the compromise 404 can be identified.

As used in regards to step 1430 and component 1432, the term “timeframe” 1432 refers to one or more temporal measurements pertaining to a compromise 404, wherein the temporal measurements can include, but are not limited to: a start time, an end time, and a data element or data value which indicates if the compromise is ongoing (i.e. not yet over). Although the terms and concepts of “start time”, “end time”, and “ongoing” are used in this disclosure, many additional and/or alternate terms and concepts exist, and thus it should be understood that all such additional and/or alternate terms and concepts are intended to fall within the scope and spirit of “timeframe” 1432.

At step 1434, at least one virtual location identifier 1436 of the compromise 404 can be identified.

As used herein, the term “virtual location identifier” 1436 refers to an identifier, name, number, symbol, address, any combination thereof, any component thereof, and/or any known and/or convenient identifier, which can be used to at least in part identify, locate, distinguish, find, narrow down, or proximate a virtual location. By way of non-limiting example, a virtual location identifier could be: an Internet Protocol (IP) address, a range of IP addresses, a subnet IP address, a range of subnet IP addresses, a domain name, an FTP site address, a file sharing application, an email address, an online alias, the name of a chatroom, a telephone number, a uniform resource locator (URL), a social security number, an account number, any combination thereof, and/or any known and/or convenient identifier having the same or similar function.

At step 1438, at least one physical location identifier 1440 of the compromise 404 can be identified.

As used herein, the term “physical location identifier” 1440 refers to an identifier, name, number, symbol, field, address, any combination thereof, any component thereof, and/or any known and/or convenient identifier, which can be used to at least in part identify, locate, distinguish, find, narrow down, or proximate a physical location. By way of non-limiting example, a physical location identifier could be: a social security number, the name of an entity, a street address, a floor number, a suite number, a room number, a city block, a city, a town, a county, a postal code, a zip code, a state, a province, a region, a country, a continent, latitude and longitude coordinates, GPS coordinates, any combination thereof, and/or any known and/or convenient identifier having the same or similar function.

In some embodiments, obtaining 1304 prelim compromise dimi 1268 can be accomplished from, by, or at a command center 912.

Various embodiments can omit and/or abbreviate any or all of the steps at 1404, 1406, 1410, 1414, 1418, 1422, 1426, 1430, 1434, and 1438. These omissions and/or abbreviations can be done for any reason, stated or unstated. By way of non-limiting example, a given step could be omitted and/or abbreviated because: data is missing, data is unavailable, data is contradictory, data is unreliable, data is corrupt, data is confidential, an entity doing the reporting is untrustworthy, it is time-consuming to obtain certain data, it is expensive to obtain certain data, and the like.

Steps 1404, 1406, 1410, 1414, 1418, 1422, 1426, 1430, 1434, and 1438 can be order-flexible in relation to each other.

Steps 1304, 1404, 1406, 1410, 1414, 1418, 1422, 1426, 1430, 1434, and 1438 can be actor-flexible, duration-flexible, onset-flexible, proximity-flexible, repetition-flexible, and/or secrecy-flexible.

Steps 1304, 1404, 1406, 1410, 1414, 1418, 1422, 1426, 1430, 1434, and 1438 can be optional and/or discretionary, and thus, can occur in some embodiments but not in others.

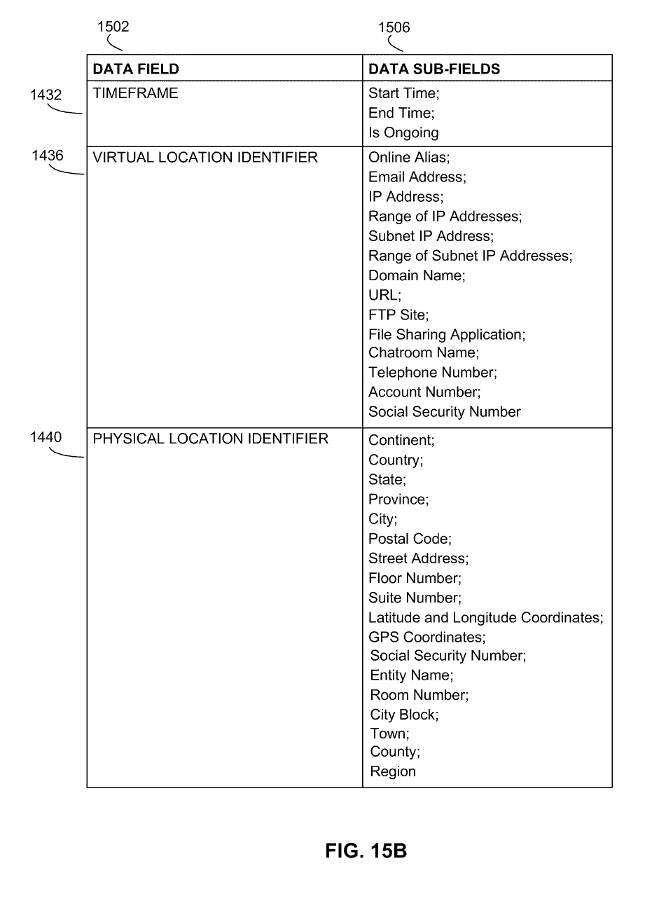

FIG. 15A is a tabular illustration providing exemplary data fields and exemplary data values that can be used to represent prelim compromise dimi. FIG. 15B is a tabular illustration providing exemplary data fields and exemplary data sub-fields that can be used to represent prelim compromise dimi.

Since human memory can be fallible and difficult to share, it can be desirable, beneficial, and/or necessary to store and/or represent prelim compromise dimis 1422 in some predetermined way. In some embodiments, prelim compromise dimis 1268 can be stored in and/or represented as data structures, data objects, data types, fields, records, rows, columns, values, and/or classes. These data structures, data objects, data types, records, rows, columns, values, and/or classes can be stored on, represented on, and/or processed by a database 1224, a computer readable medium 1220, a digital file, a flat file, a spreadsheet, RAM, ROM, flash memory, a human-writable medium, any combination thereof, and/or any known and/or convenient medium suitable for storing and/or representing dimis. Storing and/or representing prelim compromise dimis 1422 in one or more of the ways described above can have useful benefits, such as: fast and/or automated sorting, searching, and/or processing; convenient, standardized, and/or consistent representation; reliable, verifiable, and/or long-lasting storage and/or archiving.

Data fields 1502, data sub-fields 1506, and data values 1504 are well known in the art, and thus, they will not be explicitly defined in this disclosure.

The threat to human life 1408 data field 1502 can have various exemplary data values, such as “yes” and “no”, “1” and “0”, “true” and “false”, and the like.

The threat to geo-political security 1412 data field 1502 can have various exemplary data values, such as “yes” and “no”, “1” and “0”, “true” and “false”, and the like.

The suspected terrorist attack 1416 data field 1502 can have various exemplary data values, such as “yes” and “no”, “1” and “0”, “true” and “false”, and the like.

The cascading 1424 data field 1502 can have various exemplary data values, such as “yes” and “no”, “1” and “0”, “true” and “false”, and the like.

The severity 1424 data field 1502 can have various exemplary data values, such as: “high”, “medium”, and “low”; “red”, “yellow”, and “green”; “3”, “2”, and “1”, and the like.

A compromise type 1428 can have various exemplary data values 1504. Some, but not all, possible data values 1504 for a compromise type 1428 are listed and described below.
Availability. As used herein, a compromise type of “availability” 1512 refers to a compromise which could, would, or did cause, or is causing, at least one information asset to be unavailable, deleted, destroyed, renamed, corrupted, encrypted, moved, broken, turned off, reassigned, and/or disconnected. By way of non-limiting example, a compromise having a compromise type of availability could be: a crucial file server being taken down by a virus.
Integrity. As used herein, a compromise type of “integrity” 1514 refers to a compromise which could, would, or did cause, or is causing, at least one information asset to lose integrity, reliability, authority, trusted-ness, and/or truthfulness. By way of non-limiting example, a compromise having a compromise type of integrity could be: a student hacking into a university computer network in order to change his grades.
Confidentiality. As used herein, a compromise type of “confidentiality” 1516 refers to a compromise which could, would, or did cause, or is causing, at least one information asset to lose confidentiality, secrecy, privacy, and/or protection. By way of non-limiting example, a compromise having a compromise type of confidentiality could be: an employee decrypting highly sensitive files on a network and then forgetting to re-encrypt those files for many months.
Fraud. As used herein, a compromise type of “fraud” 1518 refers to a compromise which could, would, or did cause, or is causing, at least one information asset to be used in a fraudulent, illegal, deceptive, misleading, profiteering, racketeering, criminal, manipulative, and/or dangerous manner. By way of non-limiting example, a compromise having a compromise type of fraud could be: a hacker gaining access to a genuine bank email address in order to send fraudulent but official-looking “phish” emails to unsuspecting customers.
Defamation. As used herein, a compromise type of “defamation” 1520 refers to a compromise which could, would, or did cause, or is causing, at least one information asset to be used for the purpose of defaming, devaluing, damaging, bad-mouthing, slandering, smearing, tarnishing, testifying against, and/or showing in a negative light, a brand, product, and/or entity. By way of non-limiting example, a compromise having a compromise type of defamation could be: a disgruntled employee mass-mailing a confidential and potentially damaging corporate document to unauthorized viewers.
Hijack. As used herein, a compromise type of “hijack” 1522 refers to a compromise which could, would, or did cause, or is causing, at least one information asset to be used, controlled, exploited, and/or abused by an entity other than its rightful, true, stated, published, and/or generally accepted owner, and/or for a purpose other than its rightful, true, stated, published, and/or generally accepted purpose. By way of non-limiting example, a compromise having a compromise type of hijack could be: a corporation's network computer being taken over and then secretly being used as a child pornography server.
Espionage. As used herein, a compromise type of “espionage” 1524 refers to a compromise which could, would, or did cause, or is causing, at least one information asset to be used for the purposes of espionage, sabotage, theft, infiltration, invasion, intrusion, and/or spying. By way of non-limiting example, a compromise having a compromise type of espionage could be: a piece of malware on a network computer that scans all files for potential credit card numbers and then forwards any such numbers to an anonymous external email address.
Lost. As used herein, a compromise type of “lost” 1526 refers to a compromise which could, would, or did cause, or is causing, at least one information asset to be lost, misplaced, missing, miscategorized, and/or unable to be found. By way of non-limiting example, a compromise having a compromise type of lost could be: a laptop that is known to exist but can't be found during an audit.
Stolen. As used herein, a compromise type of “stolen” 1528 refers to a compromise which could, would, or did cause, or is causing, at least one information asset to be stolen, taken, and/or misappropriated. By way of non-limiting example, a compromise having a compromise type of stolen could be: a thumbdrive with confidential information getting stolen out of an employee's purse.

The nine data values for compromise types 1428 listed above are only intended to represent common and/or exemplary compromise types 1428. One skilled in the art will be able to conceive of additional and/or alternate types, and thus it should be understood that all such additional and/or alternate types are intended to fall within the scope and spirit of “compromise types” 1428.

The timeframe 1432 data field 1502 can be comprised of various exemplary sub-fields 1506, including but not limited to: start time, end time, and an indicator to indicate if the compromise is on-going (i.e. not yet over).

The virtual location identifier 1436 data field 1502 can be comprised of various exemplary sub-fields 1506, including but not limited to: online alias, email address, IP address, range of IP addresses, subnet IP address, range of subnet IP addresses, domain name, URL, FTP site name, file sharing application, chatroom name, telephone number, account number, and/or social security number

The physical location identifier 1440 data field 1502 can be comprised of various exemplary sub-fields 1506, including but not limited to: continent, country, region, state, province, county, city, town, city block, postal code, street address, floor number, suite number, social security number, entity name, room number, latitude and longitude coordinates, and/or GPS coordinates.

It should be understood the data values 1504, data fields 1502, and/or data sub-fields 1506 comprising the prelim compromise dimi 1268 represent an ideal state (i.e. “best case” or complete outcome). In practice, however, the prelim compromise dimi 1268, as stored in and/or represented by data values 1504, data fields 1502, and/or data sub-fields 1506, can be sparse, lacking, abbreviated, missing, absent, unavailable, incorrect, and/or incomplete for any number of reasons.

The data fields, data sub-fields, and data values of FIGS. 15A and 15B are provided by way of example only, and are not intended to be restrictive or limiting in any way. One skilled in the art will be able to conceive of additional and/or alternate data fields, data sub-fields, and/or data values which could be used with the same or similar results, and thus it should be understood that all such additional and/or alternate data fields, data sub-fields, and/or data values are intended to fall within the scope and spirit of FIGS. 15A and 15B.

FIG. 16 is a flowchart showing a process for determining if insurance covers a given compromise.

When a given compromise 404 occurs, a breached entity 502 may or may not be covered by insurance. Whether or not a breached entity 502 is covered by insurance can have significant effects on the compromise response decisions 1274 that are made, such as whether or not to implement 1332 security technologies, whether or not to neutralize 1330 the compromise, and various other possible decisions. And since a compromise 404 can easily cost upwards of $10 million, a breached entity 502 is generally eager to know whether those costs are covered by at least one insurance policy. Therefore, it can be desirable, beneficial, and/or necessary to determine if at least one insurance policy covers the compromise 404 in question.

By way of analogy, in an automobile accident, a driver's vehicle insurance policy often has a deductible and/or a maximum coverage amount. The driver's vehicle insurance policy might also have various exemptions, conditions, and terms which could determine if a given accident is covered. Similarly, insurance covering compromises of information asset(s) can have deductibles, maximum coverages mounts, and/or terms, exemptions, and conditions. Thus, depending on various factors, insurance which covers compromises 404 of insurance asset(s) can cover some, all, or none of the costs of a given compromise 404.

In some embodiments, a breached entity 502 without appropriate insurance coverage might not be responded 408 to any further, and the process could terminate. In other embodiments, a breached entity 502 without appropriate insurance can still be responded 408 to, however the cost can be selectively increased and/or the response time can be longer. In still other embodiments, a breached entity 502 without appropriate insurance can be responded 408 to in the same manner as would be a breached entity 502 who had appropriate insurance (i.e. no change is made to the cost and/or response time).

As indicated by the dotted outer box, determining 1306 if insurance covers a given compromise 404 can be more fully understood when considered as a set of possible sub-steps (1602, 1604, 1606, 1610, 1612, 1614, 1616, 1618, 1620) as described below.

At step 1602, it can be determined if the breached entity 502 has at least one active insurance policy which, at least in part, covers information security and/or compromises of information asset(s). For example, a breached entity 502 could have a general insurance policy (such as an Errors and Omissions policy, or a General Liability policy) which covers, at least in part, information security and/or compromise of information asset(s) claims, and therefore, step 1602 can evaluate to “YES” (i.e. positive). In another example, a breached entity 502 could have a specific insurance policy (such as Cyber-insurance policy, or a Data Privacy policy) which covers, at least in part, information security and/or compromise of information asset(s) claims, and therefore, step 1602 can evaluate to “YES” (i.e. positive). In yet another example, a breached entity 502 could have a Cyber-Insurance policy that is expired, and therefore, step 1602 can evaluate to “NO” (i.e. negative).

If the result of step 1602 is “YES” (i.e. positive), then the process can proceed to step 1604; otherwise, the process can proceed to step 1614.

At step 1604, it can be determined if the compromise 404 violates the insurance policy's terms, conditions, and/or exemptions. For example, a breached entity 502 could have a policy that covers information security claims, but only those that happen during business hours. If a compromise 404 were to occur during business hours, that would not be an exemption, and therefore step 1604 can evaluate to “NO” (i.e. negative). In another example, a breached entity's 502 Cyber-Insurance policy could have a condition that all personally-identifiable data (such as names and social security numbers) must be encrypted while in transit. If a compromise were to occur in which unencrypted personally-identifiable data was intercepted while in transit, then that would violate the insurance policy's conditions, and therefore step 1604 can evaluate to “YES” (i.e. positive).

If the result of step 1604 is “NO” (i.e. negative), then the process can proceed to step 1606; otherwise, the process can proceed to step 1614.

In some embodiments, it can be desirable, beneficial, and/or necessary to estimate 1606 the cost of the compromise 404, thereby producing an estimated cost 1608. This estimated cost 1608 can be partial, complete, precise, imprecise, verifiable, non-verifiable, correct, incorrect, and/or any combination thereof. In some embodiments, the estimated cost 1608 can include or exclude various sub-costs. For example, in one embodiment, the estimated cost 1608 could include most costs of responding 408 to a compromise 404 but exclude any costs associated with notifying 1318 relevant parties. In another example involving a cascading 1424 compromise 404, another embodiment could exclude all costs of responding 408 to a compromise 404 but include any costs associated with liability to entities that were affected by the cascading 1424 compromise 404.

The estimating 1606 can be accomplished using any ACEI technique.

The determining of steps of 1602, 1604, 1610 and/or 1612 can also be accomplished by: finding, researching, studying, reading, computing, calculating, evaluating, searching, analyzing, querying, referring to, consulting, and/or “pulling up” tables, charts, templates, rubrics, quotes, policies, figures, estimates, rules of thumb, agreements, and/or contracts stored in, stored on, and/or represented by a database 1224, a computer 1218, a spreadsheet, a flat file, a presentation, a website, the internet, a digital file, a file folder, a drawer, a file cabinet, a desk, a library, an almanac, a book, a document, a publication, a magazine, an article, an essay, and/or a tangible medium such as paper.

The estimating 1606 can be done by at least one human, at least one entity, at least one team, at least one computer algorithm, at least one hardware device, at least one artificial intelligence, any combination thereof, and/or any other known and/or convenient estimator having the same or similar function.

In some embodiments, the estimating 1606 can occur prior to and/or during steps 1610 and 1612. However, in other embodiments, the estimating 1606 can occur at any time before, during, and/or after steps 1610 and 1612.

At step 1610, it can be determined if the estimated cost of the compromise 404 exceeds the insurance policy's deductible. For example, if the insurance policy's deductible is $500,000 and the estimated cost of the compromise 404 is only $175,000, then the estimated cost does not exceed the insurance policy's deductible, and therefore step 1610 can evaluate to “NO” (i.e. negative). In another example, suppose the estimated cost of the compromise 404 is $14,000,000 and the deductible is $1,000,000. In that case, the estimated cost does exceed the deductible, and therefore step 1610 can evaluate to “YES” (i.e. positive). In some embodiments, an insurance policy has no deductible, and in such cases, step 1610 can be skipped and/or omitted.

If the result of step 1610 is “YES” (i.e. positive), then the process can proceed to step 1612; otherwise, the process can proceed to step 1614.

At step 1612, it can be determined if the estimated cost of the compromise 404 exceeds the insurance policy's maximum coverage amount. For example, if the insurance policy's maximum coverage is $12,000,000 and the estimated cost of the compromise 404 is $3,500,000, then the estimated cost does not exceed the insurance policy's maximum coverage, and therefore step 1612 can evaluate to “NO” (i.e. negative). In another example, suppose the estimated cost of the compromise 404 is $55,000,000 and the maximum coverage is $25,000,000. In that case, the estimated cost does exceed the deductible, and therefore step 1612 can evaluate to “YES” (i.e. positive). In some embodiments, an insurance policy has no maximum coverage, and in such cases, step 1612 can be skipped and/or omitted.

If the result of step 1612 is “NO” (i.e. negative), then the process can proceed to step 1618; otherwise, the process can proceed to step 1616.

The determining of steps of 1602, 1604, 1610 and/or 1612 can be accomplished using any ACEI technique.

The determining of steps of 1602, 1604, 1610 and/or 1612 can also be accomplished by: finding, researching, studying, reading, evaluating, searching, analyzing, querying, referring to, consulting, and/or “pulling up” policies, insurance policies, templates, rubrics, guidelines, rules of thumb, agreements, and/or contracts stored in, stored on, and/or represented by a database 1224, a computer 1218, a spreadsheet, a flat file, a presentation, a website, the internet, a digital file, a file folder, a drawer, a file cabinet, a desk, a library, an almanac, a book, a document, a publication, a magazine, an article, an essay, and/or a tangible medium such as paper.

The decisions made at the determining steps of 1602, 1604, 1610 and/or 1612 can be made by at least one human, at least one entity, at least one team, at least one computer algorithm, at least one hardware device, at least one artificial intelligence, any combination thereof, and/or any other known and/or convenient decision-maker having the same or similar function.

In some embodiments, the determining at steps 1602, 1604, 1610, and/or 1612 can make use of the prelim compromise dimi 1268 obtained in step 1304. For example, the prelim compromise dimi 1268 could contain facts, figures, information, numbers, data, and/or opinions that could be used to estimate the cost of responding 408 to the compromise 404. In another example, the prelim compromise dimi 1268 could contain a statement from the breached entity 502 and/or proxy entity 904, wherein the statement states that the breached entity 502 does not have insurance which covers compromises 404 of information assets, and thus, step 1602 can be skipped, simplified, and/or made easier. However, in other embodiments, the determining at steps 1602, 1604, 1610, and/or 1612 can be performed without making use of the prelim compromise dimi 1268.

In some embodiments, the decisions made at the determining steps of 1602, 1604, 1610 and/or 1612 can be subjective, variable, non-repeatable, unpredictable, and/or idiosyncratic, due to the possible necessity of interpreting an insurance policy and/or interpreting a given compromise 404. However, in some embodiments, little or no interpretation of an insurance policy and/or a given compromise 404 could be required, and thus, the decisions made at the determining steps of 1602, 1604, 1610 and/or 1612 can be objective, deterministic, predictable, repeatable, and/or standardized.

At step 1614, a determination can be made that the compromise 404 is not covered. At step 1616, a determination can be made that the compromise 404 is at least partially covered. At step 1618, a determination can be made that the compromise 404 is covered. The determination reached at steps 1614, 1616, and/or 1618 can be correct, incorrect, certain, uncertain, verifiable, unverifiable, and/or any combination thereof. Furthermore, the determination reached at steps 1614, 1616, and 1618 can be changed, re-decided, reviewed, and/or amended at any time.

At step 1620, a claims analysis 1264 can be written. As used in regards to step 1620, “written” can mean: written, typed, inputted and stored on a computer, authored, created, drafted, invented, designed, drew, drew up, described, narrated, made, generated, produced, combined, aggregated, summarized, any combination thereof, and/or any known and/or convenient action having the same or similar function. The writing 1620 can be accomplished using any ACEI technique.

The result of step 1620 is a claims analysis 1264. The claims analysis 1264 can be detailed, vague, specific, general, precise, imprecise, verifiable, non-verifiable, confidential, non-confidential, and/or any combination thereof.

In some embodiments, once the claims analysis 1264 has been written 1620, the claims analysis 1264 can be sent, delivered, transmitted, presented, made available to, and/or given, using any communication technique, to at least one insurer, insurance broker, re-insurer, insurance agent, insurance adjustor, claims specialist, insurance specialist, breached entity 502, proxy entity 904, team, sub-team, and/or risk officer.

In some embodiments, determining 1306 if insurance covers a compromise 404 can be accomplished from, by, or at a command center 912.

Steps 1602, 1604, 1606, 1610, 1612, and 1620 can be order-flexible in relation to each other.

Steps 1306, 1602, 1604, 1606, 1610, 1612, and 1620 can be actor-flexible, duration-flexible, onset-flexible, proximity-flexible, repetition-flexible, and/or secrecy-flexible.

Steps 1306, 1602, 1604, 1606, 1610, 1612, and 1620 can be optional and/or discretionary, and thus, can occur in some embodiments but not in others.

FIG. 17 is a flowchart showing a process for creating a case file from several exemplary source dimis.

In the process of responding 408 to a compromise 404, various kinds of dimis can be acquired and/or collected. Various entities (such as the breached entity 502, a proxy entity 904, a police department, the military, and numerous responding entities) can require and/or ask for access to those acquired and/or collected dimis. Therefore, it can be desirable, beneficial, and/or necessary to create 1308 a case file 1258 for the purpose of storing these dimis in one convenient location. There are many possible ways to create 1308 a case file 1258. Generally but not always, a case file 1258 contains dimis pertaining to a compromise 404. Therefore, in some embodiments, it can be desirable, beneficial, and/or necessary to create the case file 1258 from various sources of data, information, media, and/or instructions pertaining to the compromise 404 in question.

As indicated by the outer box, creating 1308 a case file 1258 can be more fully understood when considered as a set of possible sub-steps and possible source dimis (402, 406, 1268, 1264, 1706) as described below.

As used herein, “source dimi” 1710 and “source dimis” refer to dimi that can be used as a source when creating, modifying, and/or incorporating into other dimis (such as case files 1258). At step 1704, at least one source dimi 1710 is incorporated into a case file 1258. As used in regards to step 1704, “incorporate” can mean: incorporate, combine, collate, file, insert, concatenate, add together, group, classify, aggregate, copy into, append, prepend, any combination thereof, and/or any known and/or convenient action having the same or similar function. The incorporating 1704 can be accomplished using any CIFS technique.

The incorporating 1704 can also be accomplished by: inserting a record into a database; querying a database; updating (i.e. modifying) a record in a database; using a manual and/or human-based process to insert words, text, pictures, graphics, sound, video, music, and/or recordings into a digital file, analog file, and/or paper-based file; using an automated and/or computer-based process to insert words, text, pictures, graphics, sound, video, music, and/or recordings into a digital file, analog file, and/or paper-based file; using a manual and/or human-based process to modify words, text, pictures, graphics, sound, video, music, and/or recordings in a digital file, analog file, and/or paper-based file; using an automated and/or computer-based process to modify words, text, pictures, graphics, sound, video, music, and/or recordings in a digital file, analog file, and/or paper-based file.

One skilled in the art will be able to conceive of additional and/or alternate techniques to incorporate 1704 source dimis 1710 into a case file 1258, and thus it should be understood that all such additional and/or alternate techniques are intended to fall within the scope and spirit of step 1704.

As shown in FIG. 17, at least one source dimi 1710 can be incorporated 1704 into a case file 1258 for the purpose of creating that case file 1258. By way of non-limiting example, source dimis 1710 can include: at least one alquest 406, at least one prelim compromise dimi 1268, at least one contract 402, at least one claims analysis 1264, at least one similar case file 1706, any combination thereof, and/or any known and/or convenient dimi having the same or similar function.

As used herein, the term “similar case files” 1706 refers to at least one case file, wherein there exists a second case file such that the at least one case file is similar to, related to, and/or part of the second case file. Identifying similar case files can be a subjective process, and thus, subject to interpretation, change, variance, revision, and the like.

The source dimis 1710 shown in FIG. 17 and discussed above are merely intended to illustrate some common and/or exemplary source dimis 1710. In some embodiments, some, all, and/or none of those exemplary source dimis 1710 can be used. One skilled in the art will be able to conceive of additional and/or alternate source dimis, and thus it should be understood that all such additional and/or alternate source dimis are intended to fall within the scope and spirit of step 1308.

Once a case file 1258 has been created 1308 and/or incorporated 1704 with case source dimis 1710, it can be desirable, beneficial, and/or necessary to store 1712 the case file 1258. The case file 1258 can be stored for many purposes, such as but not limited to: archiving, safe-keeping, sale, comparison, sharing, transmitting, research, analysis, and the like. At step 1712, a case file 1258 can be stored on an electronic storage medium 1222. An electronic storage medium 1222 can comprise at least one database 1224, online portal, communication server, digital or electronic file, any combination thereof, and/or any known and/or convenient storage medium having the same or similar function.

Storing 1712 the case file 1258 can be accomplished by: storing, uploading, downloading, sending, receiving, posting, copying, saving, writing, moving, dictating, transmitting, encoding, any combination thereof, and/or any known and/or convenient technique having the same or similar function. Furthermore, storing 1712 can be accomplished using a mechanical process, an optical process, a digital (i.e. computer-based) process, an electrical process, a magnetic process, a chemical process, an acoustical process, a human process (such as writing or drawing), a waveform-based process (such as infrared, sub-sonic, ultra-violet, or visible-light waves), a particle-based process (utilizing particles such as atoms, molecules, and/or sub-atomic particles), any combination thereof, and/or any known and/or convenient storing process having the same or similar function.

In some embodiments, a case file 1258 can be created 1308 from, by, or at a command center 912.

The steps of incorporating 1704 the various source dimis 1710 can be order-flexible in relation to each other. Steps 1308, and all instances of 1704, can be order-flexible in relation to each other.

Steps 1308 and 1704 can be actor-flexible, duration-flexible, onset-flexible, proximity-flexible, repetition-flexible, and/or secrecy-flexible.

Steps 1308 and 1704 can be optional and/or discretionary, and thus, can occur in some embodiments but not in others.

FIG. 18 is a flowchart showing a process for determining when it is necessary to respond to a compromise in an expedited or simplified manner.

Some compromises can be a threat to human life, be a threat to geo-political security, be a suspected terrorist attack, and/or have a severity of high. Due to their dangerousness, potential cost, severity, and/or urgency, such compromises can require a response that is expedited (i.e. sped-up, faster, rushed, and/or performed at high priority) and/or simplified (i.e. abbreviated, reduced, streamlined, and/or performed with a subset of the total functionality). Such an expedited and/or simplified response might save lives, protect geo-political security, prevent a terrorist attack, and/or lessen the severity of a compromise. Furthermore, an expedited and/or simplified response might reduce the cost of a compromise, reduce the damage of a compromise, reduce exposure to a compromise, and the like. Therefore, in some embodiments, a process for determining when a compromise might require an expedited or simplified response can be desirable, beneficial, and/or necessary.

At step 908, an alquest 406 can be received. Reference is made to FIGS. 9A, 9B, 9C, and 9D, in which processes for receiving 908 an alquest 406 are described in greater detail.

At step 1304, prelim compromise dimi 1268 can be obtained. Reference is made to FIG. 14, in which a process for obtaining 1304 prelim compromise dimi 1268 is described in greater detail.

As indicated by the dotted outer box, determining 1310 if a compromise 404 requires an expedited or simplified response can be more fully understood when considered as a set of possible sub-steps (1802, 1804, 1806, 1808, 1810, 1812), as described below.

The determining steps of 1802, 1804, 1806, and 1808 can be accomplished using any ACEI technique. The determining steps of 1802, 1804, 1806, and 1808 can also be accomplished by asking, interviewing, probing, surveying, and/or polling the breached entity 502 and/or the proxy entity 904 about a given dimi. The determining steps of 1802, 1804, 1806, and 1808 can also be accomplished by using any ACEI technique to analyze the alquest 406 and/or prelim compromise dimi 1268 for signs, symptoms, patterns, and/or indicators of a given dimi. The determining steps of 1802, 1804, 1806, and 1808 can also be accomplished by running diagnostic and/or analytic software, hardware, algorithms, and/or processes on at least one information asset and/or compromised information asset belonging to, leased by, and/or affiliated with the breached entity 502.

In some embodiments, determining 1310 if a compromise 404 requires a simplified and/or expedited response can be accomplished from, at, or by a command center 912.

In some embodiments, steps 1802, 1804, 1806, and/or 1808 can make use of prelim compromise dimi 1268 which could have been already obtained, at least in part, in step 1304.

However, in other embodiments, steps 1802, 1804, 1806, and/or 1808 can make use of information and/or data which can be obtained “on-the-fly” (i.e. spontaneously or in the moment), without requiring prelim compromise dimi 1268. Therefore, for the purposes of determining 1310 if a compromise 404 requires a simplified or expedited response, step 1304 should be understood to be optional and/or discretionary.

There can be overlap between the various steps 1802, 1804, 1806, and/or 1808. A given compromise 404 could produce a “YES” (i.e. positive) result on one, two, three, or four of those steps. For example, a given compromise 404 could be both life-threatening and a threat to geo-political security. In a further example, a given compromise 404 could have a severity of high, be a threat to geo-political security, and also be a suspected terrorist attack.

In some embodiments, an evaluation of “YES” (i.e. positive) at any one of the steps at 1802, 1804, 1806, or 1808 can be sufficient to proceed to step 1810. In other embodiments, however, two of the steps at 1802, 1804, 1806, or 1808 must evaluate to “YES” (i.e. positive) before having sufficient cause to proceed to step 1810. In still other embodiments, there could be a weighting and ranking system, in which certain predetermined combinations of “YES” (i.e. positive) evaluations can be sufficient to proceed to step 1810, while other such combinations can be insufficient. In yet other embodiments, the decision-maker(s) can elect to proceed to step 1810 even if none of the steps 1802, 1804, 1806, or 1808 evaluate to “YES” (i.e. positive).

At step 1810, the compromise can be responded to in a simplified and/or expedited manner. For the purpose of explanation and not limitation, responding in a simplified or expedited manner 1810 can include: omitting steps; skipping steps; performing steps with higher-than-normal priority; abbreviating steps; performing steps in alternate orders; performing steps at a later time; repeating steps; delegating steps; sub-contracting steps; and/or any combination thereof.

For purposes of explanation but not limitation, an expedited and/or simplified response could be a subset of the steps shown in FIG. 13A. For example, FIG. 13B depicts a simplified version of FIG. 13A. Another example of a simplified and/or expedited response would be to omit steps 1320, 1324, 1314, and/or 1318. Yet another example of a simplified and/or expedited response would be to omit steps 1328, 1334, and/or 1332. Still another example of a simplified and/or expedited response would be to perform steps 1326 and 1330 prior to performing steps 1314, 1316, 1318, 1320, 1322, and/or 1324. While the examples listed in this paragraph are typical and/or exemplary, the number of examples of simplified and/or expedited responses can be vast, and it would be impractical to list them all in this disclosure. Therefore, it should be understood that all subsets and/or permutations of the steps shown in FIG. 13A are intended to fall within the scope and spirit of the response 408 process.

At step 1812, the compromise can be responded to normally. For the purpose of explanation and not limitation, responding normally 1812 can generally be understood to mean responding in a manner that is not expedited and/or simplified (this could entail performing all of the steps in FIG. 13A, and/or performing those steps in the order they are shown).

Steps 1802, 1804, 1806, and 1808 can be order-flexible in relation to each other.

Steps 908, 1304, 1310, 1802, 1804, 1806, 1808, 1810, and 1812 can be actor-flexible, duration-flexible, onset-flexible, proximity-flexible, repetition-flexible, and/or secrecy-flexible.

Steps 1304, 1310, 1802, 1804, 1806, and 1808 can be optional and/or discretionary, and thus, can occur in some embodiments but not in others.

FIG. 19A is a block diagram showing a team comprised of multiple sub-teams. FIG. 19B is a block diagram showing a team comprised of one sub-team having the same size and membership as the team itself. FIG. 19C is a block diagram showing a league comprised of a risk officer and multiple exemplary teams, wherein each team is comprised of multiple exemplary sub-teams.

In the process of responding 408 to a compromise 404, it can be desirable, beneficial, and/or necessary to organize responding entities into teams 1216 and/or sub-teams 1904. Such teams 1216 and/or sub-teams 1904 can concentrate similar, related, and/or the same skills and/or knowledge, such as legal skills and/or knowledge. Conversely, such teams 1216 and/or sub-teams 1904 can achieve “synergies” or broader functionality by combining dissimilar and/or complementary skills and/or knowledge.

As used herein, the term “sub-team” 1904 refers to a team that is a subset, delegate, component, and/or subsidiary of another team. It should be understood that a “sub-team” can be a special instance of a “team”, and as such, can inherit the properties, traits, concepts, and definitions of a “team”. In some cases, a sub-team can contain the same members as the team to which it belongs. In other cases, a sub-team can be smaller than the team to which it belongs. Furthermore, a given sub-team can belong to more than one distinct team. In yet other embodiments, a team can be comprised of one or more sub-teams.

As shown in FIG. 19A, an exemplary team 1216 can be comprised of multiple sub-teams 1904. These sub-teams 1904 are drawn with varying size boxes to indicate that, in some embodiments, any two given sub-teams 1904 can be unequal and/or dissimilar in size, membership, function, and/or importance. However, in other embodiments, any two given sub-teams can be equivalent and/or similar in size, membership, function, and/or importance. Thus, it should be understood that a team 1216 can be comprised of any number of sub-teams 1904.

As shown in FIG. 19B, an exemplary team 1216 can be comprised of one sub-team 1904. In some embodiments, both the team 1216 and the sub-team 1904 can be the same size and contain the same members. Obviously, this is one of many possible team compositions. In other embodiments, a team 1216 can be not comprised of any sub-teams 1904 (i.e. a team 1216 having zero sub-teams 1904). In such embodiments, a team 1216 can be “stand-alone”, atomic, non-decomposable, non-divisible, and the like.

As shown in FIG. 19C, an exemplary league 1902 can be comprised of a risk officer 1210, a forensics team 1912, a public relations team 1914, a legal team 1916, and/or a technical team 1918. Each of the teams shown (1912, 1914, 1916, 1918) in FIG. 19C can be comprised of at least one sub-team having a specific function and/or name. These teams and sub-teams are provided by way of example and not limitation. One skilled in the art will be able to conceive of additional and/or alternate team names, functions, and/or structures, and thus it should be understood that all such additional and/or alternate team names, functions, and/or structures are intended to fall within the scope and spirit of FIG. 19C.

As used herein, the term “league” 1902 refers to a set of zero or more teams and/or zero or more risk officers. By way of non-limiting example, some exemplary leagues could be comprised of: a forensics team and a risk officer; a public relations team, two technical teams, and two risk officers; and a legal team and a public relations team.

As used herein, the term “forensics team” 1912 refers to a team which generally can, at least in part, perform forensics functions. These forensics functions can include, but are not limited to: acquiring, obtaining, analyzing, reading, storing, searching, compiling, and/or processing forensics data, or any combination thereof, and/or any known and/or convenient action having the same or similar function. In some cases, one or more members of a forensics team can also testify or present forensics data in a court of law and/or to a public authority.

As used herein, the term “public relations team” 1914 refers to a team which generally can, at least in part, perform public relations functions. These public relations functions can include, but are not limited to: reducing the size of notification lists; choosing the publication venue for compromise notices; creating, writing, revising, or editing the content of compromise notices; choosing the audience which will receive the compromise notices; sending, publishing, distributing, or making available the compromise notices; advising or counseling on any of the aforementioned public relations functions; or any combination thereof.

As used herein, the term “legal team” 1916 refers to a team which generally can, at least in part, perform legal functions. These legal functions can include, but are not limited to: writing legal documents, reviewing legal documents, offering legal advice, reviewing relevant laws, offering written or verbal opinions on relevant laws, litigating, prosecuting a compromiser, defending a breached entity or proxy entity, testifying in a court of law, or any combination thereof.

As used herein, the term “technical team” 1918 refers to a team which generally can, at least in part, perform technical functions. These technical functions include, but are not limited to: isolating the compromised information asset(s), neutralizing the compromise, creating a risk assessment report, implementing security technologies, implementing security processes, or any combination thereof.

By way of non-limiting example, a forensics team 1912 can be comprised of one or more sub-teams 1904, such as a computer forensics team for the purpose of acquiring 1314 forensics data 1252 from computers 1218 and/or computer networks 1202, and a human forensics team for the purpose of acquiring 1314 forensics data 1912 from humans and/or physical locations 1002.

By way of non-limiting example, a public relations team 1914 can be comprised of one or more sub-teams 1904, such as a news agency team for the purpose of notifying 1318 at least one news agency, and an external customer team for the purpose of notifying 1318 at least one external customer.

By way of non-limiting example, a legal team 1916 can be comprised of one or more sub-teams 1904, such as a notification team for the purpose of advising 1316 with notification laws, and a prosecution team for the purpose of prosecuting any compromiser(s) 504 who are apprehended and/or discovered.

By way of non-limiting example, a technical team 1918 can be comprised of one or more sub-teams 1904, such as a software team for the purpose of implementing 1332 security technologies involving software, and a hardware team for the purpose of implementing 1332 security technologies involving hardware.

Although a risk officer 1210 is shown as not being part of (or belonging to) any of the four teams shown (1912, 1914, 1916, 1918), in some embodiments a risk officer 1210 can be part of (or belong to) one team 1216 and/or sub-team 1904. In other embodiments, a risk officer 1210 can be part of (or belong to) multiple teams 1216 and/or sub-teams 1904. In still other embodiments, a league 1902 can have no risk officer 1210.

FIG. 20 is a flowchart showing a forensics acquisition and analysis process, wherein the forensics data can be acquired from at least one exemplary forensics investigation area.

Forensics data 1252 can be useful for many reasons. By way of non-limiting example, forensics data 1252 can: allow a compromise to be more fully understood; aid in identifying the weakness, vulnerability, opening, and/or exploit through which the compromise occurred; aid in identifying at least one compromiser; and the like. Therefore, it can be desirable, beneficial, and/or necessary to acquire forensics data 1314 in the process of responding 408 to a compromise 404.

As used in regards to step 1314, “acquire” can mean: acquire, gather, obtain, find, discover, get, collect, any combination thereof, and/or any known and/or convenient action having the same or similar function.

The acquiring 1314 can be accomplished using any ACEI technique. The acquiring 1314 can also be accomplished by: copying, scanning, viewing, water-marking, analyzing, and/or editing at least one digital file and/or digital message; analyzing a computer and/or communications network using special purpose software and/or hardware; analyzing and/or identifying a social and/or criminal network using special purpose software and/or hardware; any combination thereof; and/or any known and/or convenient technique having the same or similar function.

As indicated by the outer box and the steps attached thereto, acquiring 1314 forensics data 1252 can be more fully understood by considering said acquiring 1314 along with a set of possible steps and/or sub-steps (2012, 2016, 2018) as described below.

At step 1314, forensics data 1252 can be acquired from at least one forensics investigation area 2002.

As used herein, the term “forensics investigation area” 2002 refers to an area at which, by which, in which, or through which forensics data can be acquired. A forensics investigation area can be categorized into a physical location, a virtual location, a subject area, a person, or any combination thereof. A forensics investigations area can include, but is not limited to: a computer; a computer network; a database; a communication device; a portable communication device; a telephone; a server; a communications network; a dimi; a digital file; a digital message; a person; an entity; a computer-readable medium; a computer-readable activity log; and/or a computing system comprising at least hardware, data, and/or software.

Forensics investigation areas 2002 can comprise, but are not limited to: a computer 1218; a computer network 1202; a database 1224; a communication device 1214; a portable communication device 1212; a telephone 1210; a server 2004; a communications network 914; a dimi; a digital file 2010; a digital message 2006; a person; an entity; a computer-readable medium 1220; an activity log; a computer-readable activity log 2008; and/or a computing device.

As used herein, the term “computer-readable activity log” 2008 refers to an activity log which can be read, at least in part, by a computer.

As used herein, the term “digital file” 2010 refers to a set of bits (i.e. 1's and 0's) capable of being read by a computer and/or computing device. The digital file can be represented using signals, pulses, charges, arrangements, and/or markers, of a magnetic, digital, electrical, chemical, optical, acoustical, radio wave, temperature-based, molecule-based, DNA-based, atom-based, and/or sub-atomic-particle-based nature.

As used herein, the term “digital message” 2006 refers to any message and/or dimi capable of being sent, represented, and/or received in a magnetic, electrical, digital, chemical, optical, acoustical, radio wave, temperature-based, molecule-based, DNA-based, atom-based, and/or sub-atomic-particle-based format. By way of non-limiting example, a digital message can be an email, an instant message, a text message, and communications that occur in a chatroom. A digital message can be sent over a computer network, a communications network, and/or by any other known and/or convenient means having the same or similar function.

The types, styles, categories, and/or families of forensics investigation areas 2002 depicted in FIG. 20 represent some common exemplary forensics investigation areas 2002. Many other possible forensics investigation areas 2002 exist. One skilled in the art will be able to conceive of additional and/or alternate areas, and thus it should be understood that all such additional and/or alternate areas are intended to fall within the scope and spirit of forensics investigation areas 2002.

At step 2012, at least one suspected person can be interviewed. As used in regards to step 2012, “interview” can mean: interview, interrogate, cross-examine, investigate, wire-tap, eavesdrop on, digitally or electronically track, spy on digitally or electronically, extract information from, bribe, coerce, conduct searches on, any combination thereof, and/or any known and/or convenient action having the same or similar function.

As used herein, the term “suspected person” refers to a person and/or entity that is suspected to be, at least in part, responsible for, knowledgeable of, and/or associated with, at least one compromise.

The interviewing 2012 can be accomplished using a: rubric; checklist; formula; algorithm; computer; computing device; communication device; database; machine; hardware; device; apparatus; recording device (such as a video camera, camera, microphone, and the like); pen-and-paper process; verbal process; negotiation process; software application; presentation maker application (such as Microsoft PowerPoint); analysis tree; decision tree; flowchart; simulation; experiment; poll; survey; interview; questionnaire; website; search engine; any combination thereof; and/or any known and/or convenient technique having the same or similar function. The interviewing 2012 can also be accomplished using an incentive which is monetary, political, career, legal and/or social in nature.

At step 2016, forensics data 1252 can be analyzed. As used in regards to step 2016, “analyze” can mean: analyze, research, study, comprehend, investigate, look up, look through, scan, sort, organize, compile, process, cross-reference, compare, discover, sample, discard, any combination thereof, and/or any known and/or convenient action having the same or similar function.

The analyzing 2016 can be accomplished using any ACEI technique. The analyzing 2016 can also be accomplished using a secure online portal 1208, a communications network 914, a cryptographic appliance 1226, a communication device 1214, a computer network, any combination thereof, and/or any known and/or convenient technique having the same or similar function.

At step 2018, at least one forensics report 1254 can be created. As used in regards to step 2018, “create” can mean: create, write, draw, build, design, describe, narrate, make, generate, compile, produce, combine, aggregate, summarize, any combination thereof, and/or any known and/or convenient action having the same or similar function. The creating 2018 can be accomplished using any ACEI technique.

In some embodiments, a forensics report 1254 can incorporate forensics data 1252. In other embodiments, a forensics report 1254 can incorporate interviews. In still other embodiments, a forensics report 1254 can incorporate both forensics data 1252 and interviews. The information and/or data contained in a forensics report 1254 can be raw, processed, condensed, compressed, uncompressed, filtered, unfiltered, aggregated, summarized, not summarized, not aggregated, packaged, unpackaged, edited, unedited, censored, uncensored, any combination thereof, and/or any known and/or convenient style having the same or similar properties.

In some embodiments, a forensics report can 1254 be created 2018 for a specific audience. Different audiences can have different needs, requirements, and/or expectations. Accordingly, a forensics report 1254 can be tailored and/or customized to meet the needs, requirements, and/or expectations of at least one audience. An exemplary list of some, but not all, audiences for a forensics report 1254 is given below:
Executives or officers, such as Chief Executive Officers (CEOs), Chief Financial Officers (CFOs), Chief Security Officers (CSOs), Chief Information Officers (CIOs), and the like.
Information Technology specialists, such as computer programmers, system analysts (SAs), business analysts (BAs), system engineers (SEs), computer engineers, data architects, program architects, system architects, database analysts (DBAs), hardware designers, network analysts, network security professionals, and the like.
Managers, such as project managers, program managers, people managers, team managers, and the like.
Leagues, teams, sub-teams, and/or risk officers employed by and/or affiliated with the service entity.
Government, city, state, and/or federal employees, such as police officers, investigators, intelligence officers, the military, and the like.

Steps 1314, 2012, 2016, and 2018 can be order-flexible in relation to each other.

Steps 1314, 2012, 2016, and 2018 can be actor-flexible, duration-flexible, onset-flexible, proximity-flexible, repetition-flexible, and/or secrecy-flexible.

Steps 1314, 2012, 2016, and 2018 can be optional and/or discretionary, and thus, can occur in some embodiments but not in others.

FIG. 21 is a flowchart showing a process for notifying at least one entity about a compromise.

A compromise 404 can possibly affect, impact, and/or be of interest to, numerous people and/or entities. For example, a compromise 404 which is a suspected terrorist attack might be of interest to a government agency such as the Central Intelligence Agency (CIA), and in that case, notifying 1318 the CIA may be necessary. In another example, a compromise 404 of a bank's credit card database could potentially affect thousands of the bank's customers, and in that case, notifying 1318 those customers may be necessary. In yet another example, a compromise 404 of a company's trade secrets could have a large impact on the company's competitiveness, and in that case, various officers of the company may need to be notified 1318. Therefore, in the process of responding 408 to a compromise 404, it can be desirable, beneficial, and/or necessary to notify at least one entity.

As used in regards to step 1318, “notify” can mean: notify, tell, inform, educate, make aware, make available, any combination thereof, and/or any known and/or convenient action having the same or similar function.

As used herein, the term “relevant party” 2124 refers to a set of at least one entity, wherein a compromise is relevant to the members of that set. The compromise can be relevant for any number of reasons. Generally, the members of a given relevant party are related in at least one way, although they can be unrelated as well. By way of non-limiting example, the members of a relevant party can be related by belonging to the same or similar: company, group, board, organization, society, club, agency, job function, job category, project, hierarchy, family, region, demographic, clientele, church, school, hospital, team, and/or any combination thereof. For example, a relevant party could be a group of customers whose credit card numbers were compromised. In another example, a relevant party could be a group of corporate officers who are employed by the breached entity. In yet another example, a relevant party could be a local police department responsible for enforcing laws that were potentially broken during the compromise. In still yet another example, a relevant party could be a group of doctors, nurses, and orderlies who work at the same hospital, wherein the hospital's personnel database was compromised. In yet a further example, a relevant party could be one or more news agencies responsible for receiving and/or publishing a compromise notice. A relevant party can be any size. A relevant party can span any geography, time, country, demographic, language, job function, political affiliation, and/or can span any known and/or convenient category having the same or similar traits.

As indicated by the dotted outer box, notifying 1318 at least one entity about a compromise 404 can be more fully understood by considering said notifying 1318 as a set of possible sub-steps (2102, 2104, 2106, 2110, 2114, 2120) as described below.

Since the process of notifying 1318 relevant parties 2124 can be expensive, damaging, onerous, and/or undesirable to a breached entity 502, it can be desirable, beneficial, and/or necessary to determine 2102 when it is actually necessary to notify 1318 relevant parties 2124.

Generally although not always, notifying 1318 only occurs when a compromise 404 did actually occur, when knowledge of a compromise 404 can't be plausibly denied, when the estimated cost of a compromise exceeds a predetermined threshold, when personally-identifiable data was compromised, when compromised information asset 508 was unencrypted, when at least one relevant party 2124 has a “need to know”, and/or when at least one relevant party 2124 is legally entitled to be notified. One skilled in the art will be able to identify and/or conceive of additional and/or alternate reasons to notify 1318 at least one relevant party 2124, and thus it should be understood that all such additional and/or alternate reasons are intended to fall within the scope and spirit of step 1318.

At step 2102, it can be determined if it is necessary to notify 1318 at least one relevant party 2124. As used in regards to step 2102, “determined” can mean: determined, found out, decided, identified, figured out, calculated, executed, weighed, considered, analyzed, any combination thereof, and/or any known and/or convenient action having the same or similar function.

The determining 2102 can be accomplished using any ACEI technique. The determining 2102 can also be accomplished by finding, researching, studying, reading, evaluating, searching, analyzing, referring to, consulting, and/or “pulling up” laws, rules, regulations, guidelines, treaties, policies, processes, agreements, and/or contracts stored in, stored on, and/or represented by a database 1224, a computer 1218, computer memory, a spreadsheet, a flat file, a presentation, a website, the internet, a digital file, a file folder, a drawer, a file cabinet, a desk, a library, an almanac, a book, a document, a publication, a magazine, an article, an essay, and/or a tangible medium such as paper.

The determining 2102 can also be accomplished by obtaining advice, recommendations, instructions, decisions, consultation, and/or opinions from a legal team 1916, a public relations team 1914, a forensics team 1912, a technical team 1918, a league 1902, a team 1216, a sub-team 1904, a risk officer 1210, a breached entity 502, a proxy entity 904, a contractor, a vendor, a consultant, an artificial intelligence, any combination thereof, and/or any other known and/or convenient entity having the same or similar function.

If step 2102 evaluates to “YES” (i.e. positive), then the process can proceed to step 2106. If step 2102 evaluates to “NO” (i.e. negative), then the process can proceed to step 2104.

At step 2104, nothing can be sent. In other words, no compromise notices 1262 can be sent.

At step 2106, at least one compromise notice 1262 can be created. As used in regards to step 2106, “create” can mean: create, write, draw, build, design, describe, narrate, make, generate, compile, produce, any combination thereof, and/or any known and/or convenient action having the same or similar function. The creating 2404 can be accomplished using any ACEI technique.

At step 2110, at least one notification list 2112 can be retrieved.

As used herein, the term “notification list” 2112 refers to a list, set, group, document, table, chart, data set, record set, and/or database which contains the name, identity, number, identifier, and/or locator of at least one entity. In some cases, a notification list can also contain one or more physical location identifiers and/or virtual location identifiers of said entity(ies). A notification list can be represented in a form that is digital, electrical, analog, physical, acoustical, or any combination thereof. By way of non-limiting example, a notification list could be represented on paper, on a LED screen, on a LCD screen, on a database, in a spreadsheet, in a digital or electronic file, on a checklist, any combination thereof, and/or any other known and/or convenient representation having the same or similar function.

As used in regards to step 2110, “retrieve” can mean: retrieve, look up, get, fetch, search, return, query, grab, pull, pull up, look at, consider, any combination thereof, and/or any known and/or convenient action having the same or similar function.

The retrieving 2110 can be accomplished by querying, pulling up, retrieving from, and/or searching a: database 1224, search engine, record set, data set, file browser, file manager, any combination thereof, and/or any known and/or convenient data repository having the same or similar function.

The retrieving 2110 can also be accomplished by reading, viewing, accessing, loading, referring to, and/or making use of a: digital file, electronic file, spreadsheet, checklist, word processor document, text document, physical document (such as paper), any combination thereof, and/or any known and/or convenient document having the same or similar function.

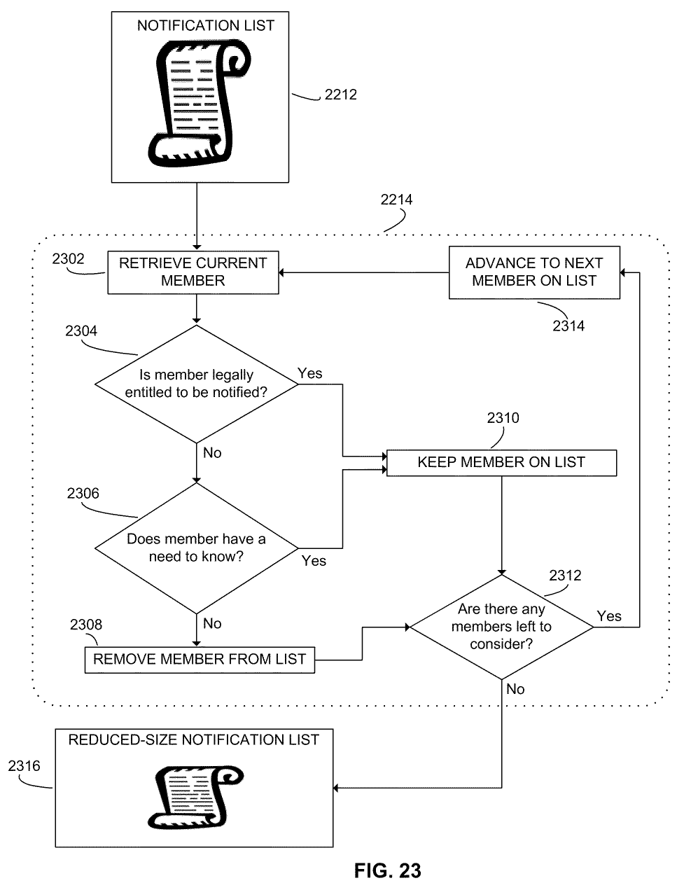

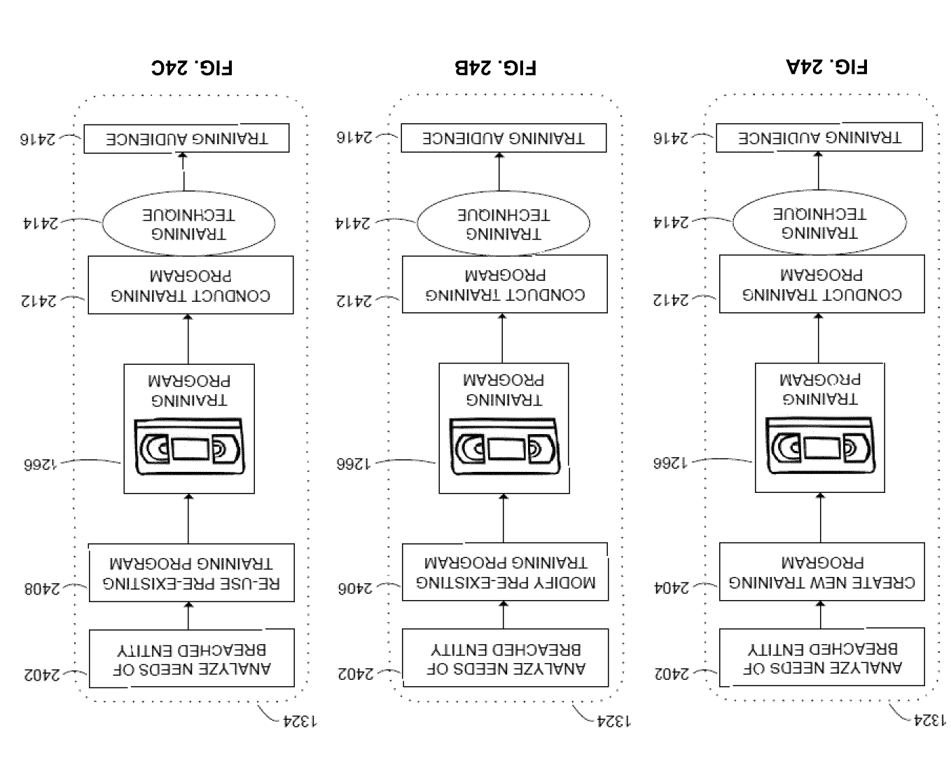

At step 2114, at least one notification list 2112 can be reduced in size. Reference is made to FIG. 23, in which the reducing in size 2114 is described in detail.

At step 2120, at least one compromise notice 1262 can be pubsent via at least one publication venue 2122, thereby notifying 1318 at least one relevant party 2124.

As used herein, the term “pubsend” 2120 is a verb which means to send, publish, deliver, transmit, distribute, disclose, present, reveal, announce, make public, and/or make available. As used herein, the term “pubsending” is the gerund (i.e. “-ing”) form of “pubsend”, and the term “pubsent” is the past-tense form of “pubsend”.

As used herein, the term “publication venue” 2122 refers to the venue, channel, method, technique, or means by which a compromise notice is pubsent. By way of non-limiting example, the publication venue can be a newspaper, a news agency, a really simple syndication (RSS) feed, an instant message, a text message, an email, postal mail, a chatroom session, a telephone call, a television broadcast, a website, an online forum, any combination thereof, and/or any known and/or convenient venue or technique having the same or similar function.

Steps 2102, 2104, 2106, 2110, 2114, and 2120 can be order-flexible in relation to each other.

Steps 1318, 2102, 2104, 2106, 2110, 2114, and 2120 can be actor-flexible, duration-flexible, onset-flexible, proximity-flexible, repetition-flexible, and/or secrecy-flexible.

Steps 1318, 2102, 2104, 2106, 2110, 2114, and 2120 can be optional and/or discretionary, and thus, can occur in some embodiments but not in others.

FIG. 22 is a flowchart showing a process for advising a breached entity with at least one compromise response decision.

Compromises 404 can be stressful, confusing, ambiguous, technical, bewildering, chaotic, important, critical, crucial, rare, high profile, high priority, and/or complex. Consequently, a breached entity 502 is often times unprepared for and/or unskilled at making compromise response decisions 1274. The wrong decision, or the right decision made at the wrong time, can have serious negative consequences for the breached entity 502. These negative consequences can include, but are not limited to: financial losses, public relations mishaps, loss of goodwill, loss of prestige, loss of brand value, exposure to further compromises 404, more expensive repair costs, increased damages from the compromise 404, further loss of confidential data, and the like. Therefore, it can be desirable, beneficial, and/or necessary to advise 1316 the breached entity 502 with at least one compromise response decision 1274.

By way of non-limiting example, a compromise response decision 1274 could be: deciding which, if any, entities to notify 1318; deciding which, if any, members should be on a given notification list 2112; deciding which, if any, publication venues 2122 should have compromise notices 1262 pubsent 2120 to them; deciding which, if any, security technologies 1270 to implement 1332, and/or when and/or in what quantity to implement the same; deciding which, if any, security processes to 1272 implement 1334, and/or when and/or in what quantity to implement the same; deciding when or in what manner to isolate 1336 the compromised information asset(s) 508; and/or deciding when or in what manner to neutralize 1330 the compromise 404.

As indicated by the dotted outer box, advising 1316 a breached entity 502 can be more fully understood by considering said advising 1316 as a set of possible sub-steps (2202, 2204, 2206) as described below.

When making a given compromise response decision 1274, it can be desirable, beneficial, and/or necessary to consider the legal aspects of that compromise response decision 1274. At step 2202, the breached entity 502 can be advised in a legal capacity. By way of non-limiting example, this legal capacity advising 2202 could pertain to: deciding which, if any, relevant parties 2124 to notify; deciding which, if any, members should be on a given notification list 2112; and/or deciding which, if any, publication venues 2122 should have compromise notices 1262 pubsent 2120 to them.

When making a given compromise response decision, 1274 it can be desirable, beneficial, and/or necessary to consider the public relations (PR) aspects of that compromise response decision 1274. At step 2204, the breached entity 502 can be advised in a public relations (PR) capacity. By way of non-limiting example, this PR capacity advising 2204 could pertain to: deciding which, if any, relevant parties 2124 to notify; deciding which, if any, members should be on a given notification list 2112; and/or deciding which, if any, publication venues 2122 should have compromise notices 1262 pubsent 2120 to them.

When making a given compromise response decision 1274, it can be desirable, beneficial, and/or necessary to consider the technical aspects of that compromise response decision 1274. At step 2206, the breached entity 502 can be advised in a technical capacity. By way of non-limiting example, this technical capacity advising 2206 could pertain to: deciding which, if any, security technologies 1270 to implement, and/or when and/or in what quantity to implement the same; deciding which, if any, security processes 1272 to implement, and/or when and/or in what quantity to implement the same; deciding when or in what manner to isolate 1326 the compromised information asset(s); and/or deciding when or in what manner to neutralize 1330 the compromise.

The advising 2202, 2204, 2206 can be accomplished using any communication technique 1006.

As used herein, the term “notice audience” 2212 refers to the intended and/or actual recipients of a compromise notice. In some cases, the intended and actual recipients are the same or mostly the same. However, in other cases, the intended recipients can differ slightly or substantially from the actual recipients. In some embodiments, the notice audience is obtained at least in part from one or more notification lists and/or reduced-size notification lists. The notice audience can be broad, narrow, singular, large, small, private, public, specific, and/or general. Generally, although not always, the notice audience is comprised of members who are also members of at least one relevant party.

At steps 2202 and/or 2204, advising on the notice audience 2212 can pertain to which relevant parties 2124 receive a compromise notice 1262. By way of non-limiting example, the advising 2202, 2204 could be to help the breached entity 502 determine which (if any) members of a given notification list 2112 are legally entitled to be notified and/or have a “need to know”. Thus, in some embodiments, the advising of steps 2202 and/or 2204 can overlap with the determining of steps 2304 and/or 2306.

At steps 2202 and/or 2204, advising on the kontent 2214 can pertain to the wording, style, length, level of detail, level of clarity, truth content, and/or information content of at least one compromise notice 1262. By way of non-limiting example, the advising 2202, 2204 could be to help the breached entity 502 decide how much information to reveal in at least one compromise notice 1262 and/or decide on the length, style, wording, and/or level of clarity of at least one compromise notice 1262. Thus, in some embodiments, the advising of steps 2202 and/or 2204 can overlap with creating 2106 the compromise notice(s) 1262.

As used herein, the term “kontent” 2214 refers to the content of a compromise notice. The content of a compromise notice can refer to a compromise notice's language, length, style, wording, arrangement, presentation, brevity, honesty, factuality, level of detail, relevance, timeliness, specificity, clarity, confidentiality, and the like. Informally, “kontent” refers to what is said and how it is said.

The types and/or styles of compromise response decisions 1274 depicted in steps 2202, 2204, and 2206 represent some common exemplary compromise response decisions 1274. One skilled in the art will be able to conceive of additional and/or alternate decisions, and thus it should be understood that all such additional and/or alternate decisions are intended to fall within the scope and spirit of step 1316.

Steps 2202, 2204, and 2206 can be order-flexible in relation to each other.

Steps 1316, 2202, 2204, and 2206 can be actor-flexible, duration-flexible, onset-flexible, proximity-flexible, repetition-flexible, and/or secrecy-flexible.

Steps 1316, 2202, 2204, and 2206 can be optional and/or discretionary, and thus, can occur in some embodiments but not in others. In any given embodiment which uses step 1316, only one step out of 2202, 2204, and 2206 must be performed, but up to all three of them can be optionally performed.

FIG. 23 is a flowchart detailing a process for reducing the number of members on a given notification list.

When a compromise 404 has occurred, it is generally, although not always, preferable to notify 1318 as few people and/or entities as possible. This is because a breached entity's 502 brand name, brand loyalty, goodwill, reputation, share price, profile, safety, security, comfort, wealth, profitability, and the like, can be adversely affected by revealing that a compromise 404 has occurred. Furthermore, there is often a substantial unit cost (between $50 and $300) to notify 1318 each person and/or entity. A large compromise 404 in which 50,000 people are notified 1318 could cost $10 million or more, merely to send notifications. By minimizing the number of people and/or entities which are notified 1318, financial and/or other losses can also be minimized. For these and other reasons, it can be desirable, beneficial, and/or necessary to reduce the size 2114 of at least one notification list 2112.

There are many examples and cases in which a notification list 2112 can be reduced 2114 in size. In some cases, a notification list 2112 can contain at least one entity that does not need to be notified about a compromise 404. For example, if the state of Minnesota (in the United States) does not have breach notification laws which cover a given compromise 404, then it can be unnecessary to notify 1318 residents of Minnesota about the compromise 404. In another example, if a corporation does not have policies which require corporate officers to be notified when a compromise 404 occurs, then it can be unnecessary to notify 1318 some or all corporate officers. In some instances, however, a member of a notification list may be a person whose personal health information was compromised and/or accessed, and it may be necessary by law, regulation, or policy to notify such a person, and therefore such person may not be removed from a notification list 2212.

As indicated by the dotted outer box, reducing the size 2114 of a given notification list 2112 can be more fully understood by considering said reducing 2114 as a set of possible sub-steps (2302, 2304, 2306, 2308, 2310, 2312, 2314) as described below.

As used herein, the term “reduced-size notification list” 2316 refers to a second notification list which is a subset of a first notification list. Because it is a subset, the second notification list can contain all, some, or none of the items or members on the first notification list.

At step 2302, a current member can be retrieved from the notification list 2112. As used in regards to step 2302, “retrieve” can mean: retrieve, look up, get, fetch, return, search, query, grab, pull, pull up, look at, consider, any combination thereof, and/or any known and/or convenient action having the same or similar function.

As used in regards to FIG. 23, a “current member” can mean: a current member, an entry, a record, a line, a line-item, an element, an item, a column, a row, a checkbox, an entity, a person, a customer, any combination thereof, and/or any known and/or convenient member having the same or similar function.

A current member can be identified and/or referred to by social security number, tax ID number, first name, last name, middle name, family name, company name, organization name, team name, corporation name, brand name, case number, file number, date of birth, account ID, database record ID, customer ID, unique ID, random ID, any combination thereof, and/or any known and/or convenient identifier having the same or similar function.

The retrieving 2302 can be accomplished by querying, pulling up, retrieving from, and/or searching a: database 1224, search engine, record set, data set, file browser, file manager, any combination thereof, and/or any known and/or convenient data repository having the same or similar function.

The retrieving 2302 can also be accomplished by reading, viewing, accessing, loading, referring to, and/or making use of a: digital file, electronic file, spreadsheet, checklist, word processor document, text document, physical document (such as paper), any combination thereof, and/or any known and/or convenient document having the same or similar function.

As used in regards to step 2304, 2306, and 2312, “determined” can mean: determined, found out, decided, identified, figured out, calculated, executed, weighed, considered, analyzed, any combination thereof, and/or any known and/or convenient action having the same or similar function.

Generally although not always, a member can be left on a notification list 2112 only when that member has a “need to know”, and/or when that member is legally entitled to be notified 1318. At step 2304, it can be determined if the current member is legally entitled to be notified 1318. At step 2306, it can be determined if the current member has a “need to know”.

A member on a notification 2112 can be legally entitled to be notified 1318, and/or have a “need to know”, for many reasons, including but not limited to: a written rule; an unwritten rule; a mandate; state laws, treaties, and/or regulations; federal laws, treaties, and/or regulations; national laws, treaties, and/or regulations; international laws, treaties, and/or regulations; city laws, treaties, and/or regulations; county laws, treaties, and/or regulations; industry laws, treaties, and/or regulations; a pre-established agreement; a pre-established contract; a pre-established policy; business laws, treaties, and/or regulations; common law; common sense; ethics; gut feelings; “doing the right thing”; any combination thereof, and/or any known and/or convenient reason having the same or similar function.

The determining 2304, 2306 can be accomplished using any ACEI technique. The determining 2304, 2306 can also be accomplished by finding, researching, studying, reading, evaluating, searching, analyzing, referring to, consulting, and/or “pulling up” laws, rules, regulations, guidelines, treaties, policies, processes, agreements, and/or contracts stored in, stored on, and/or represented by a database 1224, a computer 1218, a spreadsheet, a flat file, a presentation, a website, the internet, a digital file, a file folder, a drawer, a file cabinet, a desk, a library, an almanac, a book, a document, a publication, a magazine, an article, an essay, and/or a tangible medium such as paper.

The determining 2304, 2306 can also be accomplished by obtaining advice, recommendations, instructions, decisions, consultation, and/or opinions from a legal team 1916, a public relations team 1914, a forensics team 1912, a technical team 1918, a league 1902, a team 1216, a sub-team 1904, a risk officer 1210, a breached entity 502, a proxy entity 904, a contractor, a vendor, a consultant, an artificial intelligence, any combination thereof, and/or any other known and/or convenient entity having the same or similar function.

In some embodiments, the determining 2304, 2306 can be accomplished by at least one human decision 2116 (such as the decisions, opinions, recommendations, counsel, and/or instructions of a legal team 1916, risk officer 1210, and/or contractor). In other embodiments, the determining 2304, 2306 can be accomplished by at least one computer algorithm 2118 (such as the decisions, opinions, recommendations, counsel, and/or instructions of an artificial intelligence, computer 1218, computing device 1204, algorithm, computer formula, and/or software application). In still other embodiments, the determining 2304, 2306 can be accomplished by at least one human decision 2116 and by at least one computer algorithm 2118.

In some embodiments, a “YES” (i.e. positive) answer at either step 2304 or step 2306 can be sufficient to proceed to step 2310. However, in other embodiments, a “YES” (i.e. positive) answer at both steps 2304 and 2306 can be sufficient to proceed to step 2310. In still other embodiments, the process can proceed to step 2310 even when both steps 2304 and 2306 evaluate to “NO” (i.e. negative).

In some embodiments, a “NO” (i.e. negative) answer at either step 2304 or step 2306 can be sufficient to proceed to step 2308. However, in other embodiments, a “NO” (i.e. negative) answer at both step 2304 and 2306 can be sufficient to proceed to step 2308. In still other embodiments, the process can proceed to step 2308 even when both steps 2304 and 2306 evaluate to “YES” (i.e. positive).

The questions and/or criteria posed at steps 2304 and 2306 are not intended to be exhaustive or comprehensive. Instead, they merely represent two exemplary and common questions and/or criteria that can be used to determine if a current member should be removed 2308 from a notification list 2112. One skilled in the art will be able to conceive of other additional and/or alternate questions and/or criteria that could also be used to determine if a current member should be removed 2308 from a notification list 2112. Thus, it should be understood that all such additional and/or alternate questions and/or criteria are intended to fall within the scope and spirit of steps 2304 and 2306.

At step 2308, the current member can be removed from the notification list 2112. As used in regards to step 2308, “remove” can mean: remove, delete, strike out, blot out, erase, cut, skip over, ignore, drop, discard, check, uncheck, render unusable, flag as unusable, any combination thereof, and/or any known and/or convenient action having the same or similar function.

The removing 2308 can be accomplished by removing an entry, record, item, element, line-item, list-item, member, any combination thereof, and/or any known and/or convenient item having the same or similar function, from a notification list 2112, database 1224, record set, data set, spreadsheet, flat file, file folder, directory, word processor document, electronic or digital file, any combination thereof, and/or any known and/or convenient representation having the same or similar function.

At step 2310, the current member can be kept on the notification list 2112. As used in regards to step 2310, “kept on” can mean: kept on, left on, maintained, used, untouched, considered, looked at, referred to, processed, not discarded, not erased, not deleted, not removed, not ignored, not struck out, not skipped over, not dropped, any combination thereof, and/or any known and/or convenient action having the same or similar function.

The keeping on 2310 can be accomplished by allowing and/or causing an entry, record, item, element, line-item, list-item, member, any combination thereof, and/or any known and/or convenient item having the same or similar function, to be kept on 2310 a notification list 2112, database 1224, record set, data set, spreadsheet, flat file, file folder, directory, word processor document, electronic or digital file, any combination thereof, and/or any known and/or convenient representation having the same or similar function.

At step 2312, it can be determined if there are any un-considered members left on the notification list 2112. A considered member is one who has been considered at, evaluated at, and/or processed by steps 2304, 2306, 2308, and/or 2310. Conversely, an un-considered member is one who has not yet been considered at, evaluated at, and/or processed by steps 2304, 2306, 2308, and/or 2310. Generally but not always, the determining 2312 can evaluate to “YES” (i.e. positive) when there is at least one un-considered member left on the notification list 2112, and can evaluate to “NO” (i.e. negative) when there are zero un-considered members left on the notification list 2112.

If the result of step 2312 evaluates to “YES” (i.e. positive), then the process can proceed to step 2314. Otherwise, if the result of step 2312 evaluates to “NO” (i.e. negative), then the process can terminate, and the reduced-size notification list 2316 can be produced by copying and/or using the members from the notification list 2112 who were not removed 2308.

The determining 2312 can be accomplished in many ways. An exemplary list of some but not all ways to determine 2312 is given below:
Running a query on a database, record set, data set, and the like.
Counting the size of the original notification list; counting the number of members who have been considered; and then comparing the two numbers to see if they match; wherein the counting can be performed by a computer, a computing device, a database, a software application, a calculator, a machine, a manual process, a mental process, a verbal process, a pen and paper process, any combination thereof, and/or any known and/or convenient counting technique having the same or similar function.
Use an indicator (such as a checkbox, flag, boolean value, pointer, marker, circle, X mark, hash mark, tick mark, and the like) to indicate that the current member has been considered; and then scan to see if there are any members which do not have the appropriate indicator.
Iterate over the notification list (or record set) using a file pointer, memory pointer, record pointer, cursor, iterator, and/or any known and/or convenient pointer having the same or similar function; stopping when the end of the list has been reached.

One skilled in the art will be able to conceive of additional and/or alternate ways to determine 2312 if a notification list 2112 has any un-considered members left on it, and thus it should be understood that all such additional and/or alternate ways are intended to fall within the scope and spirit of step 2312.

At step 2314, the process can advance to the next member on the notification list 2112. As used in regards to step 2314, “advance to” can mean: advance to, increment to, proceed to, continue on to, go to, skip to, jump to, look to, cut to, look up, any combination thereof, and/or any known and/or convenient action having the same or similar function.

The advancing to 2314 can be accomplished by allowing and/or causing a database 1224, record set, data set, spreadsheet, file pointer, line pointer, memory pointer, flat file, file folder, directory, word processor document, electronic or digital file, any combination thereof, and/or any known and/or convenient representation having the same or similar function, to advance to 2314 the next entry, record, item, element, line-item, list-item, value, member, any combination thereof, and/or any known and/or convenient item having the same or similar function, on the notification list 2112.

In some embodiments, the advancing to 2314 can proceed in a linear, sequential, incremental, and/or logical fashion, such as alphabetically, numerically, regionally, geographically, temporally, function-wise, group-wise, any combination thereof, and/or any known and/or convenient fashion having the same or similar function.

However, in other embodiments, the advancing to 2314 can proceed in a non-linear, non-sequential, non-incremental, chaotic, unpredictable, complex, and/or illogical fashion, such as randomly, arbitrarily, “first come first served”, piecemeal, in a manner that depends on computational resources, in a manner that depends on time or timestamps, in a manner that depends on parallel or distributed processes, in a redundant or duplicate manner, any combination thereof, and/or any known and/or convenient fashion having the same or similar function.

Although FIG. 23 and the discussion thereof illustrates the reducing 2114 process by considering “one member at a time”, there can be alternate ways to achieve the same or similar result. For example, many databases 1224 work on record sets (i.e. data sets). In such an example, it can be possible to evaluate the record set (and thus the members) simultaneously, automatically, in bulk, all at once, “in a batch”, “in-one-go”, and the like.

In another example, a notification list 2112 could be reduced 2114 by using a parallel, distributed, and/or multi-threaded process. In such an example, the notification list 2112 could be partitioned into clusters, groups, sets, subsets, batches, regions, zones, bands, and the like, and thus, members could be evaluated out-of-order, out-of-sequence, in parallel, in various geographies, on various computing devices, asynchronously, at varying times, two-at-a-time, many-at-a-time, and the like.

In yet another example, it can be possible to discard (or skip) an entire notification list 2112 at once. For example, if all members of a given notification list 2112 are residents of the state of Minnesota, and Minnesota has no breach notification laws, then it might be unnecessary to notify 1318 any entity on that notification list 2112, and thus, that notification list 2112 can be discarded (or skipped).

One skilled in the art will be able to conceive of additional and/or alternate processes in which a notification list 2112 can be reduced 2114 by using a process that is not strictly “one member at a time”. Thus, it should be understood that all such additional and/or alternate processes are intended to fall within the scope and spirit of step 2114.

Steps 2302, 2304, 2306, 2308, 2310, 2312, and 2314 can be order-flexible in relation to each other.

Steps 2114, 2302, 2304, 2306, 2308, 2310, 2312, and 2314 can be actor-flexible, duration-flexible, onset-flexible, proximity-flexible, repetition-flexible, and/or secrecy-flexible.

Steps 2114, 2302, 2304, 2306, 2308, 2310, 2312, and 2314 can be optional and/or discretionary, and thus, can occur in some embodiments but not in others.

FIGS. 24A, 24B, and 24C are flowcharts showing a process for implementing a training program.

The number of potential risks and/or compromises to which an entity may be susceptible can be vast, obscure, confusing, technical, and/or intimidating. The number of solutions capable of preventing and/or lessening the effects of those risks and/or compromises can also be vast, obscure, confusing, technical, and/or intimidating. Therefore, it can be desirable, beneficial, and/or necessary to implement a training program.

As used herein, the term “training audience” 2416 refers to the audience of a training program. Generally although not always, a training audience has some affiliation to a breached entity and/or proxy entity. By way of non-limiting example, a training audience could be comprised of: a proxy entity, a breached entity, employees, contractors, vendors, interns, executives, officers, managers, information technology (IT) specialists, the general public, any combination thereof, and/or any other known and/or convenient audience having the same or similar function.

A training program 1266 can have at least one purpose. An exemplary list of some, but not all, such purposes is given below:
To educate the training audience 2416 about risks and/or compromises to which the entity may be susceptible.
To train the training audience 2416 in skills, knowledge, practices, policies, and the like, which can prevent and/or lessen the effects of a compromise.
To reduce and/or identify vulnerabilities to which the entity may be susceptible.
To educate about security technologies which can prevent and/or lessen the effects of a compromise.
To educate about security processes which can prevent and/or lessen the effects of a compromise.

Different training audiences 2416 can have different needs. Accordingly, a training program 1266 can be tailored and/or customized to meet the needs of at least one training audience 2416. An exemplary list of some, but not all, training audiences 2416 is given below:
Executives or officers, such as Chief Executive Officers (CEOs), Chief Financial Officers (CFOs), Chief Security Officers (CSOs), Chief Information Officers (CIOs), and the like.
Information Technology specialists, such as computer programmers, system analysts (SAs), business analysts (BAs), system engineers (SEs), computer engineers, data architects, program architects, system architects, database analysts (DBAs), hardware designers, network analysts, network security professionals, and the like.
Managers, such as project managers, program managers, people managers, team managers, and the like.

As indicated by the dotted outer box, implementing 1324 a training program 1266 can be more fully understood by considering said implementing 1324 as a set of possible sub-steps (2402, 2404, 2406, 2408, 2412) as described below.

Before creating 2404, modifying 2406, and/or re-using 2408 a training program 1266, it can be desirable, beneficial, and/or necessary to know and/or understand the needs of the training audience. When these needs are taken into account, the training program 1266 can be more useful, specific, relevant, tailored, and the like.

At step 2402, the needs of a training audience 2416 can be analyzed. As used in regards to step 2402, the “needs” of a training audience can refer to: training needs, education needs, research needs, security needs, privacy needs, compliance (with industry and/or government regulations) needs, legal needs, technical needs, information needs, data needs, notification needs, any combination thereof, and/or any other known and/or convenient needs having the same or similar function.

As used in regards to step 2402, “analyze” can mean: analyze, research, study, interview, investigate, survey, poll, look up, discover, sample, any combination thereof, and/or any known and/or convenient action having the same or similar function. The analyzing 2402 can be accomplished using any ACEI technique.

In some embodiments, the needs of a training audience 2416 can require and/or suggest that a training program 1266 be created 2404 “from scratch” (i.e. mostly or entirely created to meet the needs of a particular training audience 2416). For example, the training audience 2416 might require that the training program 1266 be confidential or copyrighted. In another example, the training audience 2416 might have specific and/or novel needs, and thus, a suitable training program 1266 does not already exist.

At step 2404, a new training program 1266 can be created. As used in regards to step 2404, “create” can mean: create, write, draw, build, design, describe, narrate, make, generate, compile, produce, any combination thereof, and/or any known and/or convenient action having the same or similar function. The creating 2404 can be accomplished using any ACEI technique.

In some embodiments, the needs of a training audience 2416 can require and/or suggest that a pre-existing training program 1266 be modified 2406. For example, the training audience 2416 might require that the training program 1266 bear the logo or brand of the breached entity 502, and thus, the logo or brand can be inserted into a pre-existing training program 1266. In another example, the training audience 2416 might have needs that are only somewhat specific and/or novel, and thus, a pre-existing training program 1266 can be adapted to those meet those needs.

At step 2406, a pre-existing training program 1266 can be modified. As used in regards to step 2406, “modify” can mean: modify, alter, change, tweak, adapt, update, simplify, expand, filter, reduce, rehash, revise, any combination thereof, and/or any known and/or convenient action having the same or similar function. The modifying 2406 can be accomplished using any ACEI technique.

In some embodiments, the needs of a training audience 2416 can require and/or suggest that a pre-existing training program 1266 be re-used 2408. For example, the training audience 2416 might not specify any branding, copyright, or confidentiality requirements, thereby allowing a pre-existing training program 1266 to be completely re-used 2408. In another example, the training audience 2416 might have needs that are not specific and/or novel, and thus, a pre-existing training program 1266 can be easily re-used 2408.

At step 2408, a pre-existing training program 1266 can be re-used. As used in regards to step 2408, “re-use” can mean: re-use, copy, purchase and use, recycle, adopt, rehash, any combination thereof, and/or any known and/or convenient action having the same or similar function. The re-using 2408 can be accomplished using any ACEI technique.

The training program 1266 can be created 2404, modified 2406, and/or re-used 2408 by any trainer-author, including but not limited to: an entity, a league, a team, a sub-team, a risk officer, a third-party contractor, a third-party vendor, a customer, a client, any combination thereof, and/or any known and/or convenient trainer-author having the same or similar function.

At step 2412, a training program 1266 can be conducted. As used in regards to step 2412, “conduct” can mean: conduct, administer, manage, teach, deliver, present, educate, speak, train, lecture, send, oversee, any combination thereof, and/or any known and/or convenient action having the same or similar function.

As used herein, the term “training technique” 2414 refers to a technique, channel, venue, process, technology, and/or method for transmitting, sending, broadcasting, giving, handing off, dispatching, making available, and/or delivering at least one training program between two or more communicators. A training technique can be unidirectional (such as a radio broadcast), bidirectional (such as a telephone call), or multi-directional (such as a chatroom with more than two entities communicating therein). Furthermore, any other known and/or convenient technique having the same or similar function is meant to be included in the definition of “transmission technique”. By way of non-limiting example, a transmission technique could be: email, instant message, text message, telephone, computer, chatroom, uploading to a website, entering into a website, downloading from a website, sound recording, video recording, FTP site, HTTP transmission, portable communication device, face-to-face conversation, teleconference, web conference, face-to-face presentation, face-to-face delivery, radio signal, online presentation, paper, electronic or digital document, paper or analog document, or any combination thereof.

The training program 1266 can be conducted 2412 using any training technique 2414. The training program 1266 can be conducted 2412 by any conductor, including but not limited to: an entity, a league, a team, a sub-team, a risk officer, a third-party contractor, a third-party vendor, a customer, a client, any combination thereof, and/or any known and/or convenient conductor having the same or similar function.

The training program 1266 can be conducted 2412 over any length of time. By way of non-limiting example, conducting 2412 the training program 1266 could take: one hour, half a day, one day, two days, three days, one week, two weeks, one month, any combination thereof, and/or any other suitable length of time.

Steps 2402, 2404, 2406, 2408, and 2412 can be order-flexible in relation to each other.

Steps 1324, 2402, 2404, 2406, 2408, and 2412 can be actor-flexible, duration-flexible, onset-flexible, proximity-flexible, repetition-flexible, and/or secrecy-flexible.

Steps 1324, 2402, 2404, 2406, 2408, and 2412 can be optional and/or discretionary, and thus, can occur in some embodiments but not in others. In any given embodiment which uses step 1324, only one step out of 2404, 2406, and 2408 must be performed, but up to all three of them can be optionally performed.

FIG. 25 is a flowchart showing a process for isolating compromised information asset(s) by taking at least one exemplary action.

In the process of responding 408 to a compromise 404, it can be desirable, beneficial, and/or necessary to isolate 1326 at least one compromised information asset 508. The reasons for, and results of, isolating 1326 a compromised information asset 508 can be numerous, and can vary depending on the particular compromise 404. For example, if a compromise 404 is ongoing, isolating 1326 the compromised information asset 508 can, in some cases, reduce or eliminate the negative effects of the compromise 404. In another example, if a compromise 404 is cascading 1424, isolating 1326 the compromised information asset 508 can, in some cases, prevent the compromise 404 from cascading any further, thereby reducing the total number of downstream systems which could be affected. In still yet another example, isolating 1326 a compromised information asset 508 by moving it can prevent similar compromises 404 from occurring in the future.

At step 2502, a root cause 1260 of a compromise 404 can be identified. In order to accurately, efficiently, and/or safely isolate 1326 the compromised information asset(s) 508, in some embodiments a root cause 1260 can be identified 2502 prior to steps 2506, 2508, 2510, 2512, and/or 2514. In other embodiments, however, it can be sufficient to have a guess, estimate, heuristic, hunch, and/or approximation of a root cause 1260, and therefore step 2502 can be optional, discretionary, and/or abbreviated. In still other embodiments, step 2502 can be optional, discretionary, and/or abbreviated because identifying 1402 the compromised information asset(s) 508 can be sufficient to isolate 1326 them, and therefore identifying 2502 a root cause 1260 can be unnecessary.

There are many possible ways to identify 2502 a root cause 1260. An exemplary list of some, but not all, ways to identify 2502 a root cause 1260 is given below. One skilled in the art will be able to conceive of additional and/or alternate ways to identify 2502 a root cause 1260, and thus it should be understood that all such additional and/or alternate ways are intended to fall within the scope and spirit of step 2502.
Acquire forensics data 1314 from at least one compromised information asset.
Perform a forensics analysis 2016 on at least one compromised information asset 508.
If a proxy entity 904 forwarded an alquest 406, ask the proxy entity 904 what the root cause 1260 is, or is thought to be.
Ask the breached entity 502 what the root cause 1260 is, or is thought to be.
Run diagnostic and/or analytic software, routines, and/or algorithms on at least one compromised information asset 508.

Run diagnostic and/or analytic software, routines, and/or algorithms on at least one computer 1218, computing device 1204, computer network 1202, dimi, and/or communication device 1214 affected by the compromise 404.
Run diagnostic and/or analytic software, routines, and/or algorithms on at least one computer 1218, computing device 1204, computer network 1202, dimi, and/or communication device 1214 through which, by which, or because of which the compromise 404 is known to, or thought to, have occurred.
Identifying at least one point of failure, such as an out-of-date patch or incorrectly configured software, in at least one of the breached entity's 502 compromised information asset(s) 508.

Some, but not all, of the actions that can comprise isolating 1326 a compromised information asset 508 are described below. One skilled in the art will be able to conceive of additional and/or alternate actions which can also be used for isolating 1326 a compromised information asset 508, and thus it should be understood that all such additional and/or alternate actions are intended to fall within the scope and spirit of step 1326.

As indicated by the outer box, isolating 1326 compromised information asset(s) 508 can be more fully understood when considered as a set of possible sub-steps (2506, 2508, 2510, 2512, 2514), as described below.

At step 2506, at least one compromised information asset 508 can be maintained in an active state. By way of non-limiting example, maintaining in an active state 2506 can include: leaving on, leaving connected, ignoring, leaving alone, allowing to function as normal, allowing to function seemingly as normal while covertly logging activity information, and/or any other known and/or convenient action having the same or similar function.

At step 2508, at least one compromised information asset 508 can be turned off. By way of non-limiting example, turning off 2508 can include: powering down, shutting down, rebooting, disconnecting, encrypting, terminating, deleting, unplugging, resetting, destroying, logging off of, signing out of, hibernating, closing, and/or any other known and/or convenient action having the same or similar function.

At step 2510, at least one compromised information asset 508 can be removed from a communications network. By way of non-limiting example, removing 2510 from a communications network can include: disconnecting from said network, unplugging or turning off a communication device or computer previously connected to said network, signing out of or logging off of said network, giving the appearance of signing out of or logging off of said network while covertly logging activity information, and/or any other known and/or convenient action having the same or similar function.

At step 2512, the physical location 1002 of at least one compromised information asset 508 can be changed. By way of non-limiting example, changing 2512 the physical location 1002 can include: moving the compromised information asset(s) 508 to another room, cubicle, office, floor, suite, building, state, province, town, city, postal code, continent, country, and/or any other known and/or convenient action having the same or similar function.

At step 2514, the virtual location 1004 of at least one compromised information asset 508 can be changed. By way of non-limiting example, changing 2514 the virtual location 1004 can include: moving the compromised information asset(s) to another channel, frequency, band, port number, IP address, alias, network, subnet, domain, subdomain, email address, chatroom, and/or any other known and/or convenient action having the same or similar function.

In some embodiments, isolating 1326 a compromised information asset 508 and neutralizing 1330 a compromise 404 can have overlapping techniques, processes, reasons, purposes, and/or results. For example, in some cases, isolating 1326 a compromised information asset 508 can also have the effect of, at least in part, neutralizing 1330 a compromise 404. In another example, neutralizing 1330 a compromise 404 can require isolating 1326 at least one compromised information asset 508. However, in other embodiments, isolating 1326 and neutralizing 1330 can have little or no overlap.

Steps 1326 and 2502 can be order-flexible in relation to each other.

Steps 2502, 2506, 2508, 2510, 2512, and 2514 can be order-flexible in relation to each other.

Steps 1326, 2502, 2506, 2508, 2510, 2512, and 2514 can be actor-flexible, duration-flexible, onset-flexible, proximity-flexible, repetition-flexible, and/or secrecy-flexible.

Steps 1326, 2502, 2506, 2508, 2510, 2512, and 2514 can be optional and/or discretionary, and thus, can occur in some embodiments but not in others. In any given embodiment which uses step 1326, only one step out of 2506, 2508, 2510, 2512, and 2514 must be performed, but up to all five of them can be optionally performed.

FIG. 26 is a flowchart showing a process for neutralizing a compromise of information asset(s) while working within the exemplary constraints of a breached entity's existing security processes and security technologies.

In the process of responding 408 to a compromise 404, it can be desirable, beneficial, and/or necessary to neutralize 1330 the compromise 404. The reasons for, and results of, neutralizing 1330 a compromise 404 can be numerous, and can vary depending on the particular compromise 404. For example, if a compromise 404 is ongoing, neutralizing 1330 the compromise 404 can, in some cases, reduce or eliminate the negative effects of the compromise 404. In another example, if a compromise 404 is cascading 1424, neutralizing 1330 the compromise 404 can, in some cases, prevent the compromise 404 from cascading any further, thereby reducing the total number of downstream systems which could be affected. In still yet another example, neutralizing 1330 a compromise 404 by resolving it can prevent similar compromises 404 from occurring in the future.

At step 2502, a root cause 1260 of a compromise 404 can be identified. In order to accurately, efficiently, and/or safely neutralize 1330 the compromise 404, in some embodiments a root cause 1260 can be identified 2502 prior to step 2606. In other embodiments, however, it can be sufficient to have a guess, estimate, heuristic, hunch, and/or approximation of a root cause 1260, and therefore step 2502 can be optional, discretionary, and/or abbreviated. In still other embodiments, step 2502 can be optional, discretionary, and/or abbreviated because identifying 1402 the compromised information asset(s) 508 can be sufficient to neutralize 1330 the compromise, and therefore identifying 2502 a root cause 1260 can be unnecessary.

There are many possible ways to identify 2502 a root cause 1260. An exemplary list of some, but not all, ways to identify 2502 a root cause 1260 is given below. One skilled in the art will be able to conceive of additional and/or alternate ways to identify 2502 a root cause 1260, and thus it should be understood that all such additional and/or alternate ways are intended to fall within the scope and spirit of step 2502.
Acquire forensics data 1314 from at least one compromised information asset.
Perform a forensics analysis 2016 on at least one compromised information asset 508.
If a proxy entity 904 forwarded an alquest 406, ask the proxy entity 904 what the root cause 1260 is, or is thought to be.
Ask the breached entity 502 what the root cause 1260 is, or is thought to be.
Run diagnostic and/or analytic software, routines, and/or algorithms on at least one compromised information asset 508.
Run diagnostic and/or analytic software, routines, and/or algorithms on at least one computer 1218, computing device 1204, computer network 1202, dimi, and/or communication device 1214 affected by the compromise 404.
Run diagnostic and/or analytic software, routines, and/or algorithms on at least one computer 1218, computing device 1204, computer network 1202, dimi, and/or communication device 1214 through which, by which, or because of which the compromise 404 is known to, or thought to, have occurred.
Identifying at least one point of failure, such as an out-of-date patch or incorrectly configured software, in at least one of the breached entity's 502 compromised information asset(s) 508.

As indicated by the outer box, neutralizing 1330 a compromise 404 can be more fully understood when considered as a set of possible sub-step(s) (2606), as described below.

At step 2606, at least one action can be executed for the purpose of resolving the compromise 404, thereby reducing, mitigating, and/or eliminating at least some of the negative or undesired effects of the compromise 404. Typically, said action(s) can utilize a breached entity's 502 existing security technologies 2604 and/or existing security processes 2602. In other words, the action(s) can generally work within the constraints of the breached entity's existing security processes 2602 and existing security technologies 2604. (Note that in some embodiments, new security technologies and/or new security processes may also be implemented 1332, 1334. Reference is made to FIGS. 28 and 29.)

As used herein, the term “existing security processes” 2602 refers to security processes which a given entity already at least in part owns, rents, pays for, runs, has, operates, uses, and/or employs. By way of non-limiting example, these security processes can include: processes, policies, standards, guidelines, practices, requirements, rules, recommendations, suggestions, and/or any other known and/or convenient policy or process having the same or similar function.

As used herein, the term “existing security technologies” 2604 refers to security technologies which a given entity already at least in part owns, rents, pays for, runs, has, operates, uses, and/or employs. By way of non-limiting example, these security technologies can include: hardware, software, data, dimi, devices, apparatuses, algorithms, programs, machines, and/or any other known and/or convenient technology having the same or similar function.

Some, but not all, of the actions 2606 that can comprise neutralizing 1330 a compromise 404 are described below. One skilled in the art will be able to conceive of additional and/or alternate actions 2606 which can also be used for neutralizing 1330 a compromise 404, and thus it should be understood that all such additional and/or alternate actions 2606 are intended to fall within the scope and spirit of steps 1330 and 2606.
Changing the password for at least one account, alias, user, and/or login.
Renaming, reassigning, and/or moving at least one account, alias, user, and/or login.
Re-configuring, altering, improving, augmenting, and/or editing at least one switch, router, firewall, hub, server, computer, communication device, and/or any other known and/or convenient security technology having the same or similar function.
Turning off and/or resetting at least one switch, router, firewall, hub, server, computer, communication device, and/or any other known and/or convenient security technology having the same or similar function.
Re-configuring, re-mapping, and/or re-architecting at least one computer network and/or communications network.
Ensuring that at least one existing security process is in fact used, employed, and/or enforced.
Revising, editing, and/or amending at least one existing security process.
Encrypting at least one digital file, database, electronic storage medium, computer-readable medium, spreadsheet, flat file, and/or any known and/or convenient arrangement of information having the same or similar function.
Generating a cryptographic hash of at least one digital file, database, electronic storage medium, computer-readable medium, spreadsheet, flat file, and/or any known and/or convenient arrangement of information having the same or similar function.

In some embodiments, isolating 1326 a compromised information asset 508 and neutralizing 1330 a compromise 404 can have overlapping techniques, processes, reasons, purposes, and/or results. For example, in some cases, isolating 1326 a compromised information asset 508 can also have the effect of, at least in part, neutralizing 1330 a compromise 404. In another example, neutralizing 1330 a compromise 404 can require isolating 1326 at least one compromised information asset 508. However, in other embodiments, isolating 1326 and neutralizing 1330 can have little or no overlap.

Steps 2502 and 1330 can be order-flexible in relation to each other.

Steps 1330, 2502, and 2606 can be actor-flexible, duration-flexible, onset-flexible, proximity-flexible, repetition-flexible, and/or secrecy-flexible.

Steps 1330, 2502, and 2606 can be optional and/or discretionary, and thus, can occur in some embodiments but not in others. For example, if the compromise 404 is already over (i.e. not on-going) when the response 408 begins, then the compromise 404 can sometimes not require neutralizing 1330.

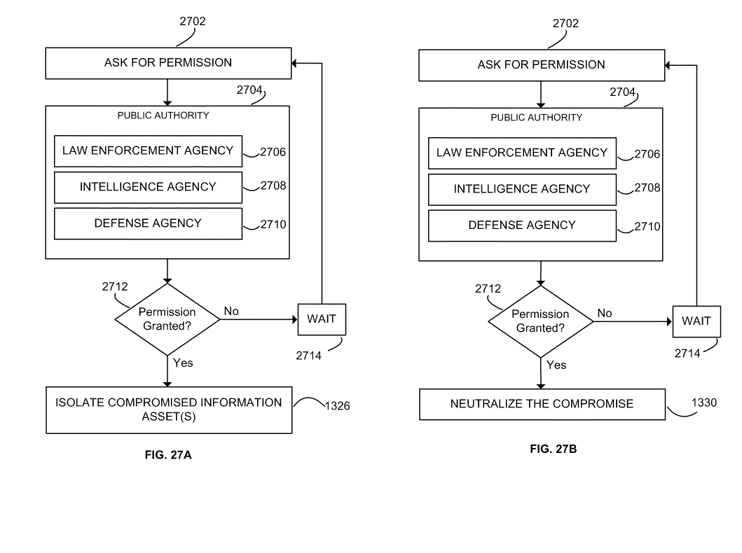

FIG. 27A is a flowchart detailing a process for obtaining permission prior to isolating at least one compromised information asset. FIG. 27B is a flowchart detailing a process for obtaining permission prior to neutralizing a compromise.

In the process of responding 408 to a compromise 404, it can be desirable, beneficial, and/or necessary to seek permission prior to isolating 1326 and/or neutralizing 1330. In such cases, isolating 1326 and/or neutralizing 1330 can be delayed, stalled, put on hold, and/or not completed until permission has been granted, thereby allowing the compromise 404 to continue and/or allowing the compromised information asset(s) 508 to remain un-isolated for some length of time.

For example, in the United States, the Federal Bureau of Investigations (FBI) sometimes may not intervene until a fraud case has exceeded $500,000 in quantifiable losses. In this example, it can be desirable to allow the compromise 404 to continue until the $500,000 is exceeded in order to obtain the FBI's help.

In another example involving a criminal hacker, a law enforcement agency 2706 might suggest or require that a compromise 404 be allowed to continue. By doing so, the law enforcement agency 2706 might be able to track the criminal hacker's activity in order to identify various partners and/or colleagues, thereby reconstructing an entire network of criminal hackers.

In yet another example, a compromise 404 will sometimes leave useful forensics data 1252 in the short-term or volatile memory (such as RAM or cache) of a computer 1218 or computing device 1204. Prematurely isolating 1326 the compromised information asset(s) 508 could potentially wipe out, erase, and/or destroy some or all information stored in the short-term or volatile memory, thereby forever losing useful forensics data 1252.

As will be apparent to one skilled in the art, there are numerous other situations and/or examples in which it can be desirable, beneficial, and/or necessary to seek permission prior to isolating 1326 and/or neutralizing 1330.

At step 2702, permission can be asked for from at least one public authority 2704. By way of non-limiting example, a public authority can comprise at least one law enforcement agency, defense agency, and/or intelligence agency. If permission is granted 2712, then the process can proceed to step 1326 and/or step 1330. But if permission is not granted 2712, then the process can proceed to step 2714.

As used herein, the term “public authority” 2704 refers to an agency and/or organization that is, at least in part, directly or indirectly, funded by a local, municipal, state, federal, national and/or international government, and wherein the agency and/or organization generally has at least some authoritative powers. These authoritative powers can generally be similar to those of a law enforcement agency, defense agency, and/or intelligence agency. By way of non-limiting example, a public authority could be a local police department, the CIA, the air force, the FBI, the navy, the NSA, the highway patrol, the DOD, a private defense contractor, the coast guard, and the like.

As used herein, the term “law enforcement agency” 2706 is meant to include, but not limited to, any: local, municipal, state, federal, national, and/or international agency and/or organization which, at least in part, can enforce, execute, or interpret laws.

As used herein, the term “intelligence agency” 2708 is meant to include, but not limited to, any: local, municipal, state, federal, national, and/or international agency and/or organization which, at least in part, can engage in the activities of: spying, eavesdropping, sabotaging, interrogating, wire-tapping, digitally tracking, digitally spying, committing espionage, making cryptographic codes, breaking cryptographic codes, covertly interfering with political affairs, and/or any combination thereof.

As used herein, the term “defense agency” 2710 is meant to include, but not limited to, any: local, municipal, state, federal, national, and/or international agency and/or organization which can engage in warfare and/or defend a local, state, federal, national, and/or international government body.

Permission can be asked 2702 using any communication technique 1006. Permission can be granted using any communication technique 1006.

Sometimes it can be desirable, beneficial, and/or necessary for permission to be asked 2702 from and/or granted by at least one entity other than a public authority 2704. For example, a compromise 404 of highly sensitive family secrets may not fall within the jurisdiction or interest of a public authority 2704, and in such cases, it can be desirable, beneficial, and/or necessary to ask permission 2702 from the family itself (i.e. the breached entity 502). In another example involving a complex and technical compromise 404, a public authority 2704 may not have sufficient skill or knowledge to comprehend the ramifications of isolating 1326 and/or neutralizing 1330, and in such cases, it can be desirable, beneficial, and/or necessary to ask permission 2702 from a risk officer 1210 and/or a team 1216.

In some embodiments, permission can be asked 2702 from and/or granted by: a breached entity 502, a proxy entity 904, a league 1902, a risk officer 1210, a team 1216, a sub-team 1904, any combination thereof, and/or any other known and/or convenient permission-grantor having the same or similar function.

At step 2714, the process can wait. In some embodiments, the waiting 2714 can be for a predetermined length of time, such as fifteen minutes or two hours. In other embodiments, the waiting 2714 can be for a length of time specified by at least one public authority 2704. In still other embodiments, the waiting 2714 can be for a length of time specified by at least one permission-grantor (such as a breached entity 502 or risk officer 1210). Once the length of time has elapsed, the process can proceed back to step 2702.

In some embodiments, it is not necessary, beneficial, appropriate, and/or desirable to ask for permission 2702 prior to isolating 1326 and/or neutralizing 1330, and in such embodiments, steps 2702, 2712, and/or 2714 can be skipped, abbreviated, and/or omitted.

Steps 1326, 2702, 2712, and 2714 can be order-flexible in relation to each other. Steps 1330, 2702, 2712, and 2714 can be order-flexible in relation to each other.

Steps 1326, 1330, 2702, 2704, 2712, and 2714 can be actor-flexible, duration-flexible, onset-flexible, proximity-flexible, repetition-flexible, and/or secrecy-flexible.

Steps 1326, 1330, 2702, 2704, 2712, and 2714 can be optional and/or discretionary, and thus, can occur in some embodiments but not in others.

FIG. 28 is a flowchart showing a process for implementing at least one security technology.

In the process of responding 408 to a compromise 404, it can be desirable, beneficial, and/or necessary to implement 1332 at least one security technology 1270. In some embodiments, implementing 1332 security technology 1270 can have the potential to prevent and/or reduce the likelihood of future compromises 404. In other embodiments, implementing 1332 security technology 1270 can have the potential to fix, stop, and/or lessen the effects of the compromise 404 which is being responded to 408. In still other embodiments, implementing 1332 security technology 1270 can do both.

At step 2502, a root cause 1260 of a compromise 404 can be identified. In order to accurately, efficiently, and/or safely implement 1332 security technologies 1270, in some embodiments a root cause 1260 can be identified 2502 prior to step 1332. In other embodiments, however, it can be sufficient to have a guess, estimate, heuristic, hunch, and/or approximation of a root cause 1260, and therefore step 2502 can be optional, discretionary, and/or abbreviated. In still other embodiments, step 2502 can be optional, discretionary, and/or abbreviated because identifying 1402 the compromised information asset(s) 508 can be sufficient to implement 1332 security technology, and therefore identifying 2502 a root cause 1260 can be unnecessary.

There are many possible ways to identify 2502 a root cause 1260. An exemplary list of some, but not all, ways to identify 2502 a root cause 1260 is given below. One skilled in the art will be able to conceive of additional and/or alternate ways to identify 2502 a root cause 1260, and thus it should be understood that all such additional and/or alternate ways are intended to fall within the scope and spirit of step 2502.
Acquire forensics data 1314 from at least one compromised information asset.
Perform a forensics analysis 2016 on at least one compromised information asset 508.
If a proxy entity 904 forwarded an alquest 406, ask the proxy entity 904 what the root cause 1260 is, or is thought to be.
Ask the breached entity 502 what the root cause 1260 is, or is thought to be.
Run diagnostic and/or analytic software, routines, and/or algorithms on at least one compromised information asset 508.
Run diagnostic and/or analytic software, routines, and/or algorithms on at least one computer 1218, computing device 1204, computer network 1202, dimi, and/or communication device 1214 affected by the compromise 404.
Run diagnostic and/or analytic software, routines, and/or algorithms on at least one computer 1218, computing device 1204, computer network 1202, dimi, and/or communication device 1214 through which, by which, or because of which the compromise 404 is known to, or thought to, have occurred.
Identifying at least one point of failure, such as an out-of-date patch or incorrectly configured software, in at least one of the breached entity's 502 compromised information asset(s) 508.

At step 1332, at least one security technology 1270 can be implemented. As used in regards to step 1332, the term “implement” can mean: implement, deploy, release, install, setup, configure, distribute, set, execute, run, create, write, build, adopt, purchase, order, arrange for purchase, any combination thereof, and/or any known and/or convenient action having the same or similar function. Security technology 1270 can include, but is not limited to: hardware 2802, software 2804, communication devices 1212, computing devices 1204, and/or systems thereof 2808.

Generally, although not always, hardware 2802 can imply hardware having at least one security function. By way of non-limiting example, hardware 2802 can include: a firewall, a switch, a router, a hub, a server, a cryptographic appliance 1226, a microchip, a sensor, a transponder, a transmitter, a receiver, a circuit, a circuit board, a device, an apparatus, a communication device 1212, a computing device 1204, any combination thereof, and/or any other known and/or convenient technology having the same or similar function.

Generally, although not always, software 2804 can imply software having at least one security function. By way of non-limiting example, software 2804 can include: anti-virus software, anti-hacking software, encryption software, cryptographic hash software, user authentication software, password generation software, random number generation software, network analysis software, activity logging software, diagnostic software, virtual private network (VPN) software, virtual desktop software, virtual machine (VM) software, a security patch, a strengthened version of an application or service, any combination thereof, and/or any known and/or convenient technology having the same or similar function.

Types of, and uses for, hardware 2802 and software 2804 are well known in the art, and one skilled in the art will be able to conceive of many other types of and uses for hardware 2802 and/or software 2804 which, though not explicitly mentioned herein, are intended to fall within the spirit and scope of step 1332.

Communication devices 1212 and computing devices 1204 are described in greater detail in the definitions section of this disclosure.

In some embodiments, it can be desirable, beneficial, and/or necessary to implement not just a single type of security technology, but instead, to implement “systems thereof”. As indicated in FIG. 28, “systems thereof” 2808 refers to systems, combinations, groupings, arrangements, sets, and/or configurations, of two or more security technologies 1270. By way of non-limiting example, systems thereof could be: one hardware and one computing device; one hardware and three software; five communication devices and two hardware; one software, two thousand computing devices, and five hundred communication devices; and so forth. Clearly it would be infeasible to list all possible combinations and quantities which could comprise “systems thereof” 2808. Furthermore, the systems thereof 2808 can be combinations and/or systems which would be known, obvious, and/or intuitive to one skilled in the art; and conversely, systems thereof 2808 can be combinations and/or systems which would be novel, non-obvious, and/or counter-intuitive to one skilled in the art.

Steps 1332 and 2502 can be order-flexible in relation to each other.

Steps 1332 and 2502 can be actor-flexible, duration-flexible, onset-flexible, proximity-flexible, repetition-flexible, and/or secrecy-flexible.

Steps 1332 and 2502 can be optional and/or discretionary, and thus, can occur in some embodiments but not in others.

FIG. 29 is a flowchart showing a process for implementing at least one security process.

In the process of responding 408 to a compromise 404, it can be desirable, beneficial, and/or necessary to implement 1334 at least one security process 1272. In some embodiments, implementing 1334 a security process 1272 can have the potential to prevent and/or reduce the likelihood of future compromises 404. In other embodiments, implementing 1334 a security process 1272 can have the potential to fix, stop, and/or lessen the effects of the compromise 404 which is being responded to 408. In still other embodiments, implementing 1334 a security process 1272 can do both.

At step 2502, a root cause 1260 of a compromise 404 can be identified. In order to accurately, efficiently, and/or safely implement 1334 a security process 1272, in some embodiments a root cause 1260 can be identified 2502 prior to step 1334. In other embodiments, however, it can be sufficient to have a guess, estimate, heuristic, hunch, and/or approximation of a root cause 1260, and therefore step 2502 can be optional, discretionary, and/or abbreviated. In still other embodiments, step 2502 can be optional, discretionary, and/or abbreviated because identifying 1402 the compromised information asset(s) 508 can be sufficient to implement 1334 a security process, and therefore identifying 2502 a root cause 1260 can be unnecessary.

There are many possible ways to identify 2502 a root cause 1260. An exemplary list of some, but not all, ways to identify 2502 a root cause 1260 is given below. One skilled in the art will be able to conceive of additional and/or alternate ways to identify 2502 a root cause 1260, and thus it should be understood that all such additional and/or alternate ways are intended to fall within the scope and spirit of step 2502.
Acquire forensics data 1314 from at least one compromised information asset.
Perform a forensics analysis 2016 on at least one compromised information asset 508.
If a proxy entity 904 forwarded an alquest 406, ask the proxy entity 904 what the root cause 1260 is, or is thought to be.
Ask the breached entity 502 what the root cause 1260 is, or is thought to be.
Run diagnostic and/or analytic software, routines, and/or algorithms on at least one compromised information asset 508.
Run diagnostic and/or analytic software, routines, and/or algorithms on at least one computer 1218, computing device 1204, computer network 1202, dimi, and/or communication device 1214 affected by the compromise 404.
Run diagnostic and/or analytic software, routines, and/or algorithms on at least one computer 1218, computing device 1204, computer network 1202, dimi, and/or communication device 1214 through which, by which, or because of which the compromise 404 is known to, or thought to, have occurred.
Identifying at least one point of failure, such as an out-of-date patch or incorrectly configured software, in at least one of the breached entity's 502 compromised information asset(s) 508.

At step 1334, at least one security process 1272 can be implemented. As used in regards to step 1334, the term “implement” can mean: implement, deploy, release, install, setup, configure, distribute, set, execute, run, create, write, build, adopt, purchase, order, arrange for purchase, any combination thereof, and/or any known and/or convenient action having the same or similar function. Security processes 1272 can include, but are not limited to: human-implemented policies 2902, human-implemented standards 2904, computer-implemented policies 2906, computer-implemented standards 2906, and/or systems thereof 2910.

As used herein, the term “human-implemented policy” 2902 refers to a policy, recommendation, rule, and/or guideline that is, at least in part, implemented on or by at least one human, and wherein the policy pertains, at least in part, to information security.

As used herein, the term “human-implemented standard” 2904 refers to a standard, procedure, process, and/or algorithm that is, at least in part, implemented on or by at least one human, and wherein the standard pertains, at least in part, to information security.

As used herein, the term “computer-implemented policy” 2906 refers to a policy, recommendation, rule, and/or guideline that is, at least in part, implemented on or by a computer, and wherein the policy pertains, at least in part, to information security.

As used herein, the term “computer-implemented standard” 2908 refers to a standard, procedure, process, and/or algorithm that is, at least in part, implemented on or by a computer, and wherein the standard pertains, at least in part, to information security.

Types of, and uses for, human-implemented policies 2902, human-implemented standards 2904, computer-implemented policies 2906, and computer-implemented standards 2908 are well known in the art, and one skilled in the art will be able to conceive of many other types of and uses for human-implemented policies 2902, human-implemented standards 2904, computer-implemented policies 2906, and/or computer-implemented standards 2908 which, though not explicitly mentioned herein, are intended to fall within the spirit and scope of step 1334.

In some embodiments, it can be desirable, beneficial, and/or necessary to implement not just a single type of security process, but instead, to implement “systems thereof”. As indicated in FIG. 29, “systems thereof” 2910 refers to systems, combinations, groupings, arrangements, sets, and/or configurations, of two or more security processes 1272. By way of non-limiting example, systems thereof could be: one computer-implemented standard and one human-implemented policy; one computer-implemented policy and three computer-implemented standards; five computer-implemented policies and two human-implemented standards; one human-implemented policy, eighteen human-implemented standards, and thirty computer-implemented policies; and so forth. Clearly it would be infeasible to list all possible combinations and quantities which could comprise “systems thereof” 2910. Furthermore, the systems thereof 2910 can be combinations and/or systems which would be known, obvious, and/or intuitive to one skilled in the art; and conversely, systems thereof 2910 can be combinations and/or systems which would be novel, non-obvious, and/or counter-intuitive to one skilled in the art.

Steps 1334 and 2502 can be order-flexible in relation to each other.

Steps 1334 and 2502 can be actor-flexible, duration-flexible, onset-flexible, proximity-flexible, repetition-flexible, and/or secrecy-flexible.

Steps 1334 and 2502 can be optional and/or discretionary, and thus, can occur in some embodiments but not in others.

FIG. 30 is a flowchart showing a process for creating a risk assessment report.

In the process of responding 408 to a compromise 404, it can be desirable, beneficial, and/or necessary to create 1328 at least one risk assessment report 1256. A breached entity 502 can be vulnerable to many risks of varying types, likelihoods, severities, and costs. The types, likelihoods, severities, and costs of these risks can, and often do, depend upon a given time period, as well as the breached entity's 502 geo-political entity, industry, market capitalization, level of fame, and company. Accordingly, the risk-related information pertaining to a given breached entity 502 can be vast, technical, confusing, and/or overwhelming. One purpose of the risk assessment report 1256 can be to make this risk-related information less vast, technical, confusing, and/or overwhelming. By doing so, the risk assessment report enables a decision-maker and/or action-taker make decisions and/or take actions with greater ease and/or greater confidence.

In some embodiments, a risk assessment report 1256 can help at least one decision-maker (such as an executive, director, and/or manager) affiliated with a breached entity 502 to understand the risks which the breached entity 502 can, could be, or could have been likely to be exposed to. In other embodiments, a risk assessment report 1256 can help at least one decision-maker (such as an executive, director, and/or manager) affiliated with a breached entity 502 to prioritize and/or decide between which security processes 1272 and/or security technologies 1270 to implement 1332,1334. In still other embodiments, a risk assessment report 1256 can help at least one decision-maker (such as an executive, director, and/or manager) affiliated with a breached entity 502 to decide when and/or how to neutralize 1330 a compromise or isolate 1326 a compromised information asset. In yet other embodiments, a risk assessment report 1256 can help a league 1902, team 1216, sub-team 1904, and/or risk officer 1210 to decide when and/or how to neutralize 1330 or isolate 1326, and/or prioritize and/or decide between which security processes 1272 and/or security technologies 1270 to implement 1332,1334.

As used in regards to steps 3002, 3004, 3006, 3008, 3010, 3012, and 3014, “identify” can mean: identify, name, determine, classify, categorize, point out, break out, break down, look up, assign, any combination thereof, and/or any known and/or convenient action having the same or similar function. The identifying of steps 3002, 3004, 3006, 3008, 3010, 3012, and 3014 can be accomplished using any ACEI technique.

A given geo-political entity (such as a country, city, or continent) can have its own characteristic risks and/or risk profile. At step 3002, at least one geo-political entity can be identified. Generally, although not always, the breached entity 502: operates in, is located in, pays taxes in, gains revenue from, stores inventory in, and/or has dimis stored in the at least one geo-political entity. Due to this association with the at least one geo-political entity, the breached entity 502 can be exposed to or vulnerable to risks originating in, endemic to, characteristic of, inherent to, and/or passing through the at least one geo-political entity. Therefore, in some embodiments, it can be desirable, beneficial, and/or necessary to identify 3002 the at least one geo-political entity.

A given industry (i.e. an economic sector, such as healthcare or telecoms) can have its own characteristic risks and/or risk profile. At step 3004, at least one industry can be identified. Generally, although not always, the breached entity 502: belongs to, operates in, is dependent on, gains revenue from, and/or is categorized as the at least one industry. Due to this association with the at least one industry, the breached entity 502 can be exposed to or vulnerable to risks originating in, endemic to, characteristic of, inherent to, and/or passing through the at least one industry. Therefore, in some embodiments, it can be desirable, beneficial, and/or necessary to identify 3004 the at least one industry.

A given level of fame (such as low-profile, medium-profile, high-profile, and superstar-profile) can have its own characteristic risks and/or risk profile. At step 3006, at least one level of fame can be identified. Generally, although not always, the breached entity 502: belongs to, gains revenue from, operates in, is dependent on, is recognized as, and/or is categorized as the at least one level of fame. Due to this association with the at least one level of fame, the breached entity 502 can be exposed to or vulnerable to risks originating in, endemic to, characteristic of, inherent to, and/or passing through the at least one level of fame. Therefore, in some embodiments, it can be desirable, beneficial, and/or necessary to identify 3006 the at least one level of fame.

A given company (such as a business, corporation, partnership, organization, or agency) can have its own characteristic risks and/or risk profile. At step 3008, at least one company can be identified. Generally, although not always, the breached entity 502: owns, belongs to, is the same as, is affiliated with, is dependent on, is exposed to, shares revenue with, shares dimis with, and/or gains revenue from the at least one company. Due to this association with the at least one company, the breached entity 502 can be exposed to or vulnerable to risks originating in, endemic to, characteristic of, inherent to, and/or passing through the at least one company. Therefore, in some embodiments, it can be desirable, beneficial, and/or necessary to identify 3008 the at least one company.

A given time period (such as a week, a month, a quarter, or a year) can have its own characteristic risks and/or risk profile. At step 3010, at least one time period can be identified. Generally, although not always, the breached entity 502: operates in, operated in, will operate in, is dependent on, gains revenue from, and/or is exposed to the at least one time period. Due to this association with the at least one time period, the breached entity 502 can be exposed to or vulnerable to risks originating in, endemic to, characteristic of, inherent to, and/or passing through the at least one time period. Therefore, in some embodiments, it can be desirable, beneficial, and/or necessary to identify 3010 at least one time period.

A given market capitalization (such as a “small-cap”, “mid-cap”, and “large-cap”) can have its own characteristic risks and/or risk profile. At step 3012, at least one market capitalization can be identified. Generally, although not always, the breached entity 502: operates in, is classified as, is recognized as, belongs to, is dependent on, and/or is exposed to the at least one market capitalization. Due to this association with the at least one market capitalization, the breached entity 502 can be exposed to or vulnerable to risks originating in, endemic to, characteristic of, inherent to, and/or passing through the at least one market capitalization. Therefore, in some embodiments, it can be desirable, beneficial, and/or necessary to identify 3012 at least one market capitalization.

A given breached entity 502 can be vulnerable to or exposed to a large number of possible risks. Each risk can have its own type, name, likelihood, severity, cost, and/or other traits. In order to create, understand, and then make decisions based upon, a breached entity's risk profile, it can be desirable, beneficial, and/or necessary to identify 3014 at least one type of risk. The type of risk is a family, class, group, set, arrangement, and/or any other logical and/or convenient grouping used to identify risks that are related in some predetermined manner.

Generally, although not always, a breached entity's particular traits (such as country, industry, level of fame, company, time period, and/or market capitalization) can at least in part determine the risks to which the breached entity is exposed or vulnerable. Therefore, in some embodiments, identifying 3014 types of risks can overlap with, be comprised of, be dependent on, incorporate, and/or make use of, steps 3002, 3004, 3006, 3008, 3010, and/or 3012. However, in other embodiments, the identifying of step 3014 can “stand-alone” (i.e. be independent of steps 3002, 3004, 3006, 3008, 3010, and/or 3012).

As used in regards to step 3016, 3018, and 3020, “estimate” can mean: estimate, assess, calculate, guess, assume, approximate, derive, sum, divide, average, look up, query, obtain, use a heuristic, any combination thereof, and/or any known and/or convenient action having the same or similar function. In some embodiments, such as when available risk information is limited and/or unreliable, estimating 3016, 3018, 3020 can also entail some amount of research, study, discovery, experimentation, surveying, sampling, and/or investigation. The estimating 3016, 3018, 3020 can be accomplished by using any ACEI technique.

At step 3016, the cost of at least one risk can be estimated. The cost of the risk reflects how costly, expensive, time-consuming, and/or resource-consuming a given risk might be if it were to occur

At step 3018, the likelihood of at least one risk can be estimated. The likelihood of the risk reflects how likely and/or probable a given risk is to occur. Generally, although not always, this likelihood relates to a predetermined time period, such as one year.

At step 3020, the severity of at least one risk can be estimated. The severity of the risk reflects how severe, extreme, disruptive, disturbing, and/or damaging a given risk might be if it were to occur.

In some embodiments, the risk assessment report 1256 can be created 1328 to be generic in some way(s), meaning that it may not pertain to a specific industry, company, country, level of fame, time period, and/or market capitalization. Alternatively, in other embodiments, the risk assessment report 1256 can be created 1328 to be specific to a particular industry, company, country, level of fame, time period, and/or market capitalization, or any combination thereof.

At step 3022, the information and/or data gathered in steps 3002 through 3020 can be consolidated. As used in regards to step 3022, “consolidated” can mean: consolidated, compiled, combined, grouped, put together, categorized, rolled-up, aggregated, sorted, summed, added, any combination thereof, and/or any known and/or convenient action having the same or similar function.

At step 3024, the information and/or data gathered in steps 3002 through 3020 can be analyzed by a human and/or a computer. As used in regards to step 3024, “analyzed” can mean: analyzed, filtered, simplified, reduced, interpreted, studied, ranked, sorted, derived, calculated, narrated, summarized, any combination thereof, and/or any known and/or convenient action having the same or similar function.

The consolidating 3022 and analyzing 3024 can be accomplished using any ACEI technique.

In some embodiments, a risk assessment report 1256 can be created 1328 without consolidating 3022 or analyzing 3024. In other embodiments, a risk assessment report 1256 can be created 1328 after consolidating 3022 but without analyzing 3024. In still other embodiments, a risk assessment report 1256 can be created 1328 after analyzing 3024 but without consolidating 3022. In yet other embodiments, a risk assessment report 1256 can be created 1328 after both consolidating 3022 and analyzing 3024.

Once the risk assessment report 1256 has been created 1328, it can be presented, given, sent, and/or delivered to at least one breached entity 502, proxy entity 904, public authority 2704, relevant party 2124, league 1902, team 1216, sub-team 1904, risk officer 1210, any combination thereof, and/or any other known and/or convenient recipient having the same or similar function. The risk assessment report 1256 can be given, sent, and/or delivered using any communication technique and/or transmission technique. However, in some embodiments, it can be unnecessary to present, give, send, and/or deliver the risk assessment report 1256, and thus in such cases, the risk assessment report 1256 can be not presented, not given, not sent, and/or not delivered.

Steps 3002, 3004, 3006, 3008, 3010, 3012, 3014, 3016, 3018, and 3020 can be order-flexible in relation to each other. Steps 3022 and 3024 can be order-flexible in relation to each other.

Steps 1328, 3002, 3004, 3006, 3008, 3010, 3012, 3014, 3016, 3018, 3020, 3022, and 3024 can be actor-flexible, duration-flexible, onset-flexible, proximity-flexible, repetition-flexible, and/or secrecy-flexible.

Steps 1328, 3002, 3004, 3006, 3008, 3010, 3012, 3014, 3016, 3018, 3020, 3022, and 3024 can be optional and/or discretionary, and thus, can occur in some embodiments but not in others.

FIG. 31 is a process diagram detailing a process for updating a case file and then storing and/or sending the same.

In the process of responding 408 to a compromise 404, various kinds of dimis can be acquired, gathered, and/or obtained. When some or all of these dimis are, at least in part, relevant and/or pertinent to a case file 1258, it can be desirable, beneficial, and/or necessary to update 1336 a case file 1258 with all, some, or none of these dimis. By doing so, a case file 1258 can become more complete, more useful, more reliable, more valuable, more accurate, more up-to-date, and/or more comprehensive.

At step 1704, case information 3102 which was gathered, obtained, and/or acquired while responding to the compromise can be incorporated into the case file 1258. As used in regards to step 1704, “incorporate” can mean: incorporate, combine, collate, file, insert, concatenate, add together, group, classify, aggregate, copy into, append, prepend, any combination thereof, and/or any known and/or convenient action having the same or similar function. The incorporating 1704 can be accomplished using any CIFS technique.

As used in regards to FIG. 31, the term “case information” 3102 refers to a set of dimis pertaining to a particular case file 1258. Case information can be comprised of, but is not limited to: prelim compromise dimi 1268, forensics data 1252, forensics report 1254, similar case files 1706, data that was obtained 3104 while responding to a compromise, process(es) that were followed 3106 while responding to a compromise, at least one analysis of the compromise 3108, at least one root cause 1260 of the compromise, intermediate cost(s) 3110 of responding to the compromise, and/or final cost(s) 3112 of responding to the compromise. One skilled in the art will be able to conceive of additional and/or alternate dimis that could comprise case information 1268, and thus it should be understood that all such additional and/or alternate dimis are intended to fall within the scope and spirit of case information 3102.

During the updating 1336 and/or incorporating 1704, the case information 3102 can be complete, incomplete, reliable, unreliable, known, unknown, verified, unverified, misleading, contradictory, approximate, exact, correct, incorrect, thorough, vague, precise, detailed, brief, concise, and/or any combination thereof. Furthermore, any and/or all types of case information 3102 (e.g. forensics data 1252, final costs 3112, root case 1260) can be missing, omitted, or unknown for any reason.

The case file 1258 can be updated 1336 and/or incorporated 1704 by at least one user and/or entity. In some embodiments, access to the case file 1258 can be unrestricted. In other embodiments, access to the case file 1258 can be, at least in part, restricted. In still other embodiments, access to the case file 1258 can be restricted so that only users and/or entities with predetermined access rights can be able to read, view, modify, execute, copy, and/or transmit the case file 1258. Such access rights can be assigned to an individual and/or to a group. Activity relating to a case file 1258 can be logged into a log file. Preferably, any time the case file 1258 is modified, such activity can be logged into the log file. The log file can allow various earlier versions of the case file 1258 to be restored or analyzed when desired and/or necessary. For example, in the event that the case file 1258 is lost, corrupted, contains mistakes, and/or is suspected of being tampered with, it can be desirable, beneficial, and/or necessary to refer to earlier versions of the case file 1258. Preferably, any time the case file 1258 is read, viewed, accessed, copied, modified, executed, or transmitted, such activity can be logged into the log file, thereby creating an access history. This can be useful, for example, in the event that improper conduct is suspected, when it can be desirable to analyze the access history of a given case file or a given user.

Once a case file 1258 has been created 1308 and/or incorporated 1704 with case information 3102, it can be desirable, beneficial, and/or necessary to store 1712 the case file 1258. The case file 1258 can be stored for many purposes, such as but not limited to: archiving, safe-keeping, sale, comparison, sending 3116, research, analysis, and the like. At step 1712, a case file can be stored on an electronic storage medium 1222. The electronic storage medium 1222 can comprise at least one database 1224, secure online portal 1208, secure communication server 3124, digital file 2010, any combination thereof, and/or any known and/or convenient storage medium having the same or similar function.

As used herein, the term “secure communication server” 3124 refers to a server operating at least in part on a communications network and at least part in a secure manner, wherein the server can send, receive, and/or process dimis. The secure manner includes, but is not limited to, encryption, rights management, password protection, activity logging, and/or role-based access.

Storing 1712 the case file 1258 can be accomplished by: storing, uploading, downloading, sending, receiving, posting, copying, saving, writing, moving, dictating, transmitting, encoding, any combination thereof, and/or any known and/or convenient technique having the same or similar function. Furthermore, storing 1712 can be accomplished using a mechanical process, an optical process, a digital (i.e. computer-based) process, an electrical process, a magnetic process, a chemical process, an acoustical process, a human process (such as writing or drawing), a waveform-based process (such as infrared, sub-sonic, ultra-violet, or visible-light waves), a particle-based process (utilizing particles such as atoms, molecules, and/or sub-atomic particles), any combination thereof, and/or any known and/or convenient storing process having the same or similar function.

At step 3114, a case file 1258 can be structured into at least one predetermined specification. As used in regards to step 3114, “structured” can mean: structured, packaged, formatted, translated, represented, scanned, recontextualized, interpreted, resampled, compressed, encrypted, filtered, reduced, organized, any combination thereof, and/or any known and/or convenient action having the same or similar function. In some embodiments, such a predetermined specification can be suitable for efficient storing, comparing, sorting, searching, analyzing, processing, sending, receiving, and/or transmitting. In other embodiments, such a predetermined specification can be inefficient, or not especially efficient, for at least one given purpose (such as storing, comparing, sorting, searching, analyzing, processing, sending, receiving, and/or transmitting). The structuring 3114 can be accomplished using any CIFS technique.

The predetermined specification can be represented and/or expressed in: extensible markup language (XML); hypertext markup language (HTML); a database record, column, table, and/or file (such as Oracle or SQL Server); binary large object (BLOB); a flat file; a portable document file (PDF); a spreadsheet; a presentation; an email; any markup language; any compressed file format (such as .ZIP, .RAR, .GZIP, .TAR, .CAB, and the like); any scripting language; a proprietary file format; a text-based file format; a binary file format; any combination thereof; and/or any known and/or convenient specification having the same or similar function.

In some embodiments, the structuring 3114 can entail compressing, discarding, sifting, filtering, reducing, deleting, aggregating, combining, extracting, any combination thereof, and/or any known and/or convenient technique having the same or similar function. By doing so, the result of step 3114 (i.e. a case file which has been structured into a predetermined specification) can be smaller, simpler, more relevant, more convincing, more manageable, and/or easier to understand.

As used herein, the term “case file consumer” 3118 refers to any entity which, at least in part, consumes, receives, stores, archives, analyzes, processes, reads, or makes use of a case file. By way of non-limiting example, a case file consumer could be: a law enforcement agency, an intelligence agency, a defense agency, a third-party contractor, and the like. A case file consumer may or may not pay money for a case file.

As used herein, the term “third-party contractor” 3120 refers to a second entity employed by and/or associated with a first entity, wherein the second entity is at least partially independent of, separate from, or subsidiary to, the first entity, and wherein the first entity is a service entity, receiving entity, and/or responding entity. By way of non-limiting example, a third-party contractor could be a forensics company which does contract work for another company. A third-party contractor can also refer to a sub-contractor.

In some embodiments, a case file consumer 3118 can require, ask for, pay for, and/or make use of a case file 1258. For example, a law enforcement agency 2706 could ask for a case file 1258 in order to arrest and/or prosecute a compromiser 504. At step 3116, a case file 1258 can be sent to at least one case file consumer 3118. The sending 3116 can be accomplished using any transmission technique 606. A case file consumer 3118 can be comprised of at least one of the following: a law enforcement agency 2706, a defense agency 2710, an intelligence agency 2708, a third-party contractor 3120, and/or any other known and/or convenient recipient of a case file having the same or similar function.

In some embodiments, a case file 1258 can be sent 3116 to the case file consumer(s) 3118. In other embodiments, the result of step 3114 (i.e. a case file which has been structured into a predetermined specification) can be sent 3116 to the case file consumer(s) 3118. In still other embodiments, a case file 1258 and/or the result of step 3114 can be sent to the case file consumer(s) 3118.

In some embodiments, a case file 1258 can be updated 1336 from, by, or at a command center 912.

Steps 1704, 3114, 3116, and 1712 can be order-flexible in relation to each other.

Steps 1336, 1704, 3114, 3116, and 1712 can be actor-flexible, duration-flexible, onset-flexible, proximity-flexible, repetition-flexible, and/or secrecy-flexible.

Steps 1336, 1704, 3114, 3116, and 1712 can be optional and/or discretionary, and thus, can occur in some embodiments but not in others.

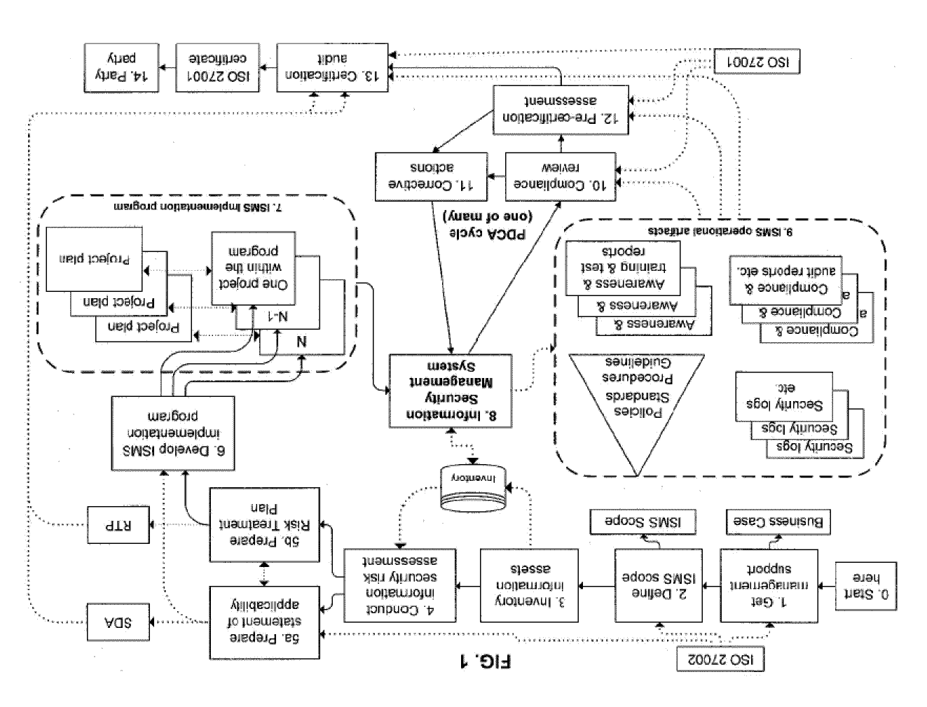

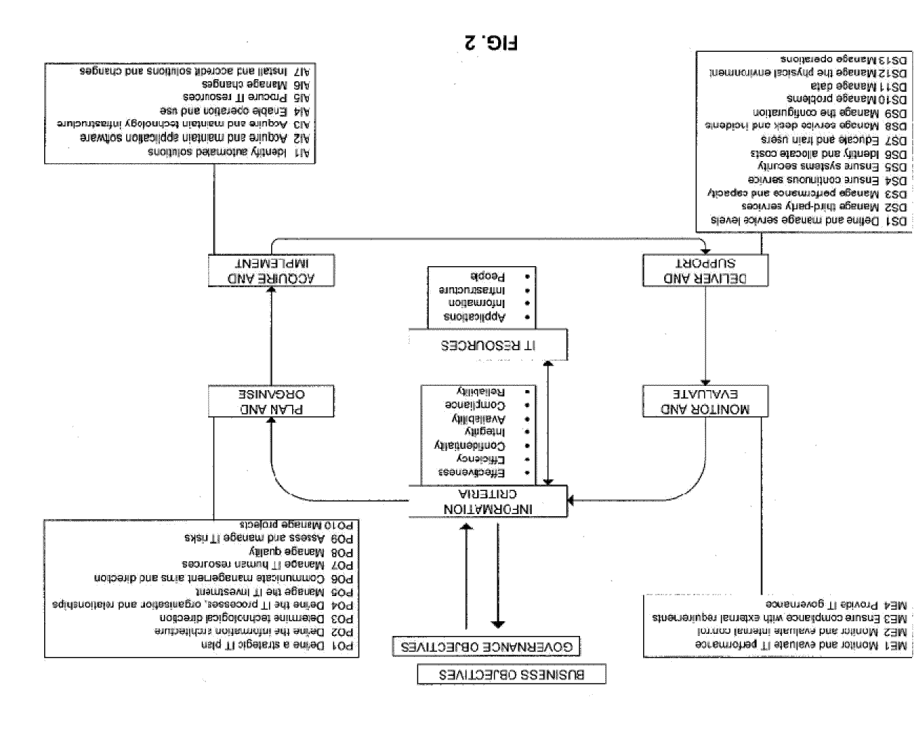

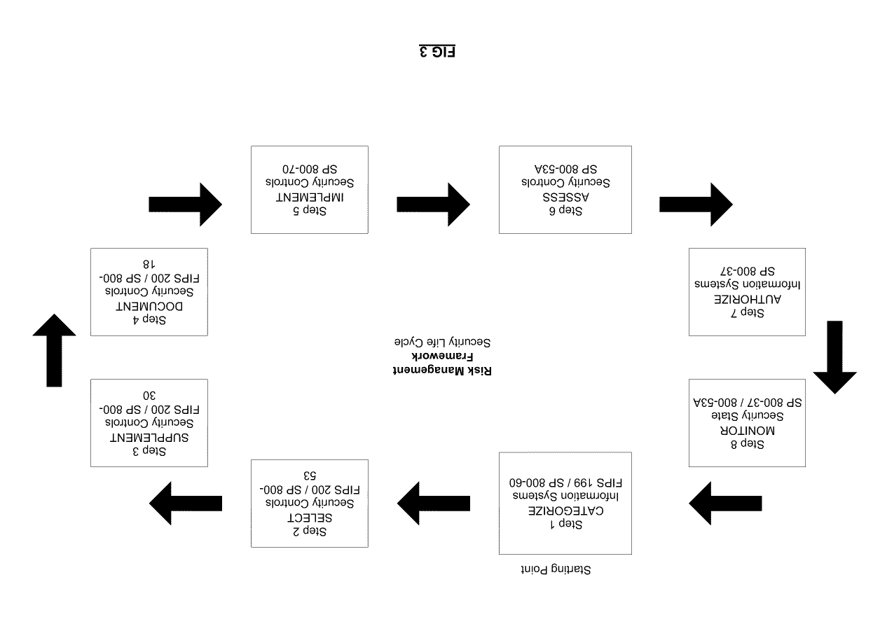

FIG. 32 depicts an embodiment of a process diagram 3200 in which a signal change can trigger the processes described in FIGS. 1-31. In the embodiment depicted in FIG. 32, a customer signal can be generated and transmitted 3202. At step 3204, a change in the customer signal state can be detected and in response thereto a response 3406 can be triggered. In alternate embodiments, a customer signal can have a null value in a first state and can include a value in a second state. In alternate embodiments, a potential breach can be detected based upon a failure to receive a prescribed signal from a customer source at a prescribed time and/or with a prescribed time window.

What is claimed is:

1. A method comprising:
receiving a first signal originating from a breached entity, said first signal comprising a request;
obtaining prelim compromise info and converting said prelim compromise info into a form capable of being stored on a computer-readable medium;
dispatching a second signal for the purpose of activating at least one responder; and
responding to a compromise using at least one step chosen from the group of steps consisting of:
(i) advising a breached entity with at least one compromise response decision;
(ii) notifying at least one relevant party about said compromise; and
(iii) acquiring forensics data from at least one forensics investigation area;
(iv) assigning a risk officer to said breached entity;
(v) implementing a training program for said breached entity; and
(vi) referring an insurance professional to said breached entity for the purpose of assisting with an insurance claim.
